(19) United States
(12) Patent Application Publication
(10) Pub. No.: US 2025/0219796 A1
(43) Pub. Date: Jul. 3, 2025

(54) Positioning Sounding Reference Signal Transmission and Reception in Non-terrestrial Networks

(71) Applicant: Ofinno, LLC, Reston, VA (US)

(72) Inventors: Mohammad Ghadir Khoshkholgh Dashtaki, Reston, VA (US); Ali Cagatay Cirik, Chantilly, VA (US); Esmael Hejazi Dinan, McLean, VA (US)

(73) Assignee: Ofinno, LLC, Reston, VA (US)

(21) Appl. No.: 19/086,871

(22) Filed: Mar. 21, 2025

Related U.S. Application Data
(63) Continuation of application No. PCT/US2023/033504, filed on Sep. 22, 2023.
(60) Provisional application No. 63/408,895, filed on Sep. 22, 2022.

(51) Int. Cl. H04L 5/00; H04W 76/27

(52) U.S. Cl. CPC H04L 5/0053; H04W 76/27

(57) ABSTRACT

A method can include receiving, by a wireless device, one or more radio resource control (RRC) messages. The messages can include one or more non-terrestrial network (NTN) configuration parameters indicating a validity timer. The validity timer can indicate a maximum time duration for which the one or more NTN configuration parameters are valid. The messages can also include one or more positioning sounding reference signal (SRS) configuration parameters indicating at least one positioning SRS resource for SRS positioning in an RRC inactive state of the wireless device. The method can also include starting the validity timer in response to the receiving the one or more NTN configuration parameters. The method can further include, based on the validity timer running in the RRC inactive state, transmitting, in the RRC inactive state, a positioning SRS via the at least one positioning SRS resource.

### CROSS REFERENCE TO RELATED APPLICATIONS

This application is a continuation of International Application No. PCT/US2023/033504, filed Sep. 22, 2023, which claims the benefit of U.S. Provisional Application No. 63/408,895, filed Sep. 22, 2022, all of which are hereby incorporated by reference in their entireties.

### BRIEF DESCRIPTION OF THE DRAWINGS

Examples of several of the various embodiments of the present disclosure are described herein with reference to the drawings.

FIGS. 1A and 1B illustrate example mobile communication networks in which embodiments of the present disclosure may be implemented.

FIGS. 2A and 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIGS. 5A and 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIGS. 12A and 12B respectively illustrate examples of three downlink and uplink beam management procedures.

FIGS. 13A, 13B, and 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIGS. 16A, 16B, 16C, and 16D illustrate example structures for uplink and downlink transmission.

FIG. 17 shows several DCI formats.

FIG. 18A shows an example of a non-terrestrial network.

FIG. 18B is an example figure of different types of NTN platforms.

FIG. 19A shows an example of an NTN with a transparent NTN platform.

FIG. 19B shows examples of propagation delay corresponding to NTNs of different altitudes.

FIG. 20 shows an example embodiment of a procedure for uplink/downlink transmission in wireless communications systems per an aspect of the present disclosure.

FIG. 21 shows an example embodiment of an SRS procedure for positioning procedure in wireless communications systems per an aspect of the present disclosure.

FIG. 22 shows an example embodiment of an SRS procedure for positioning procedure in wireless communications systems per an aspect of the present disclosure.

FIG. 23 shows an example embodiment of an SRS procedure for positioning procedure in wireless communications systems per an aspect of the present disclosure.

FIG. 24 shows an example embodiment of an SRS procedure for positioning procedure in wireless communications systems per an aspect of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability (ies) depending on wireless device category and/or capability (ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that affect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

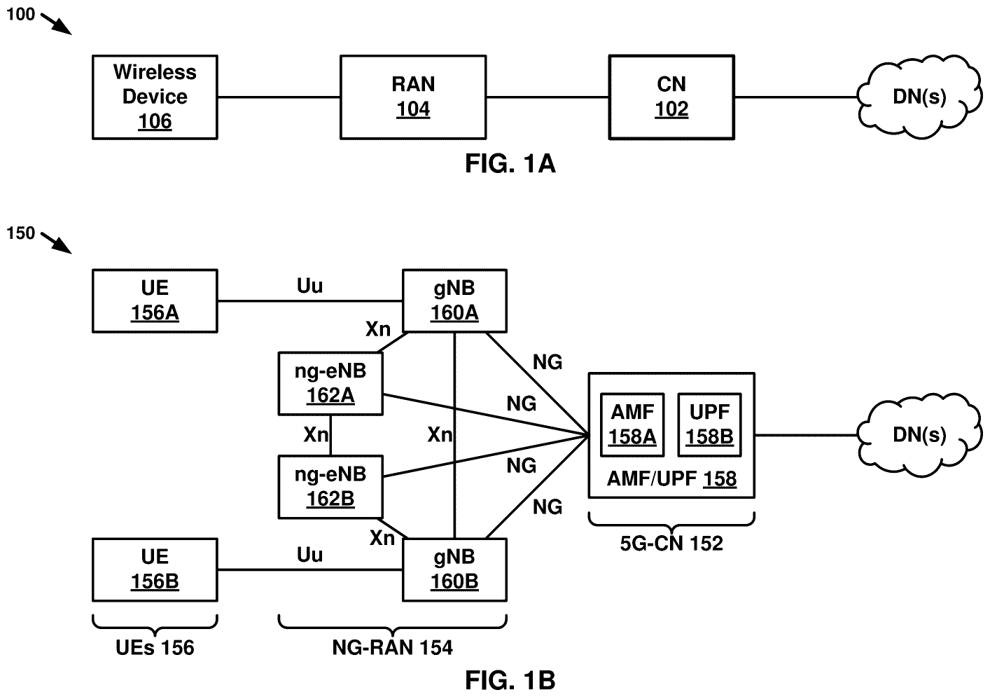

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNS (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, Wi-Fi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNS (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNS, quality of service (QOS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

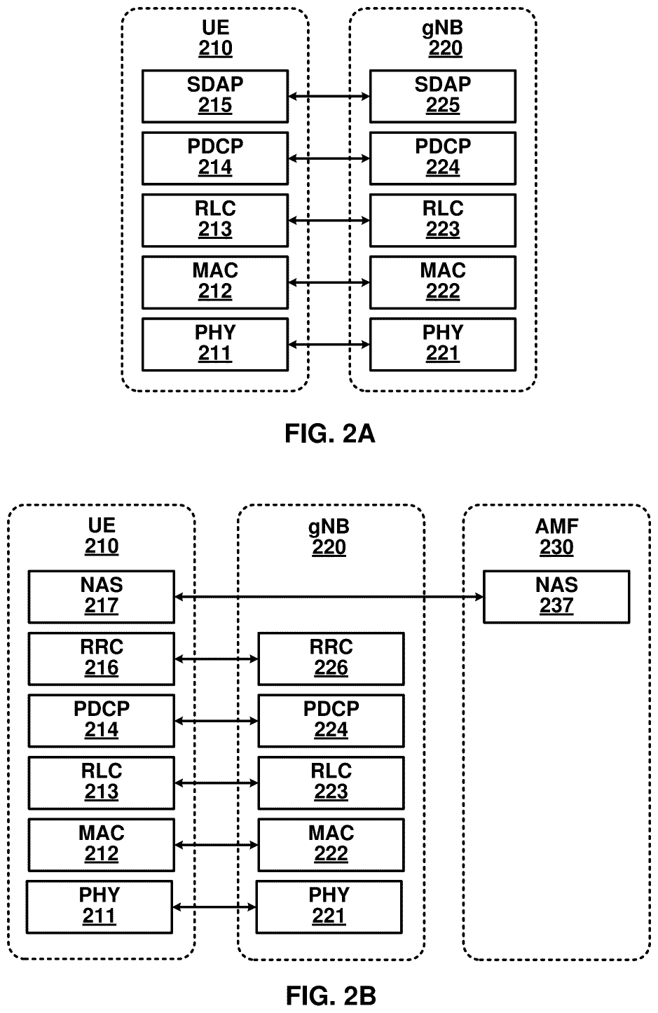

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

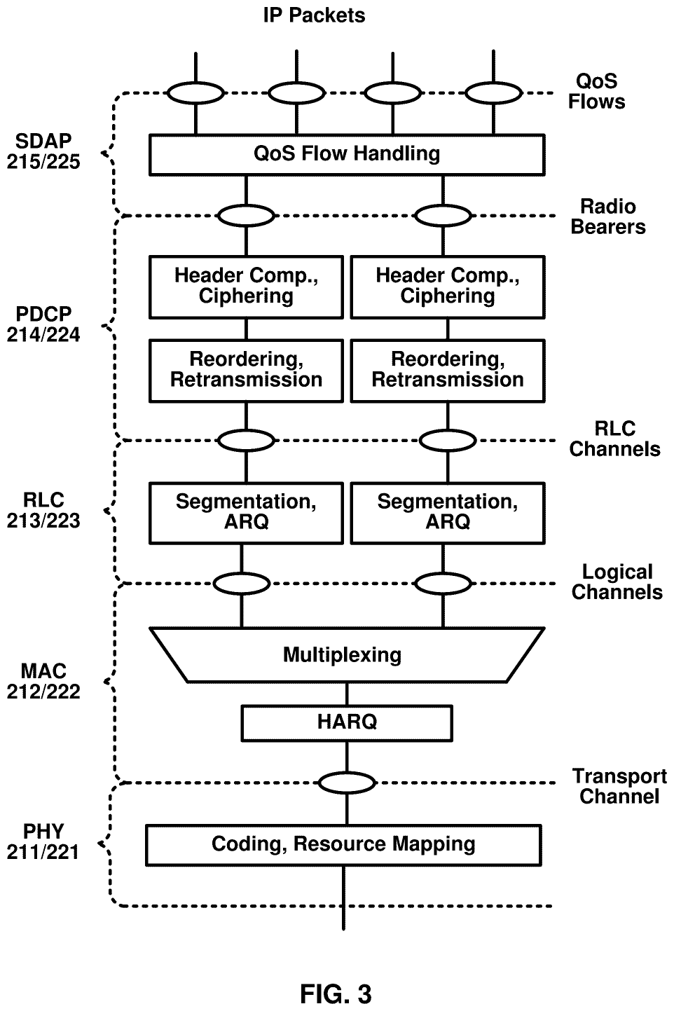

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

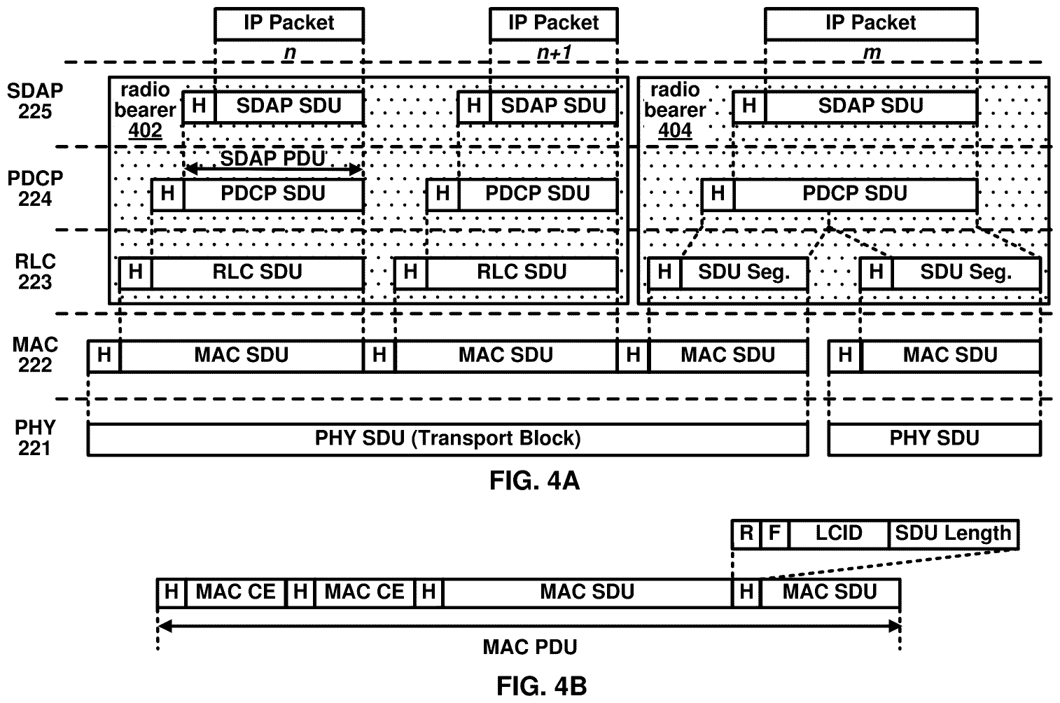

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

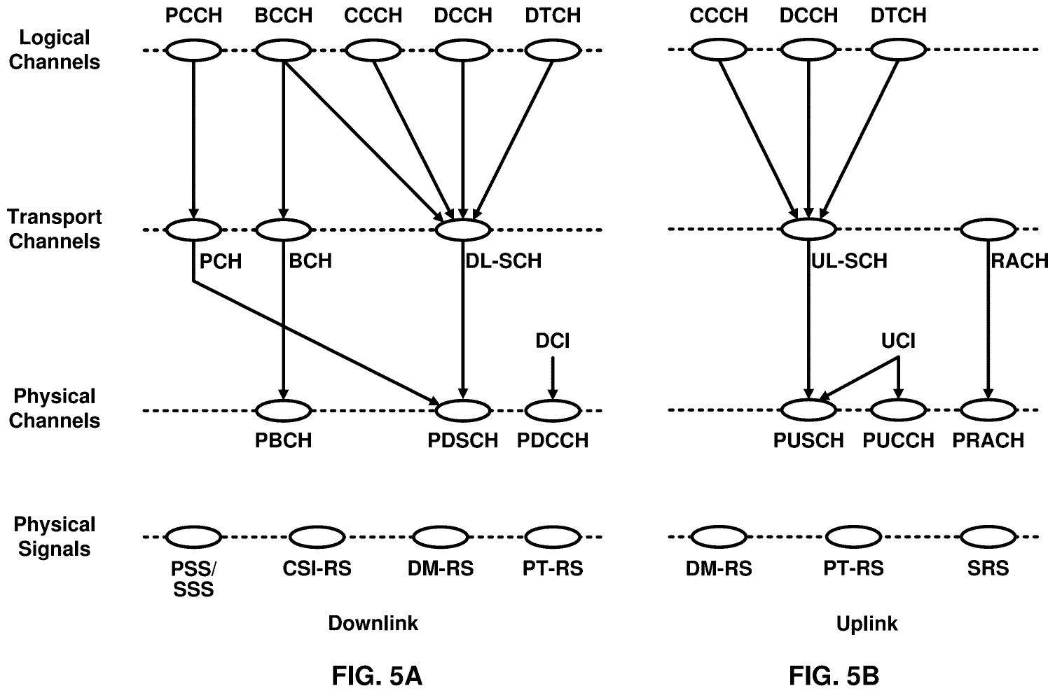

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not-known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR includes, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR);
and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

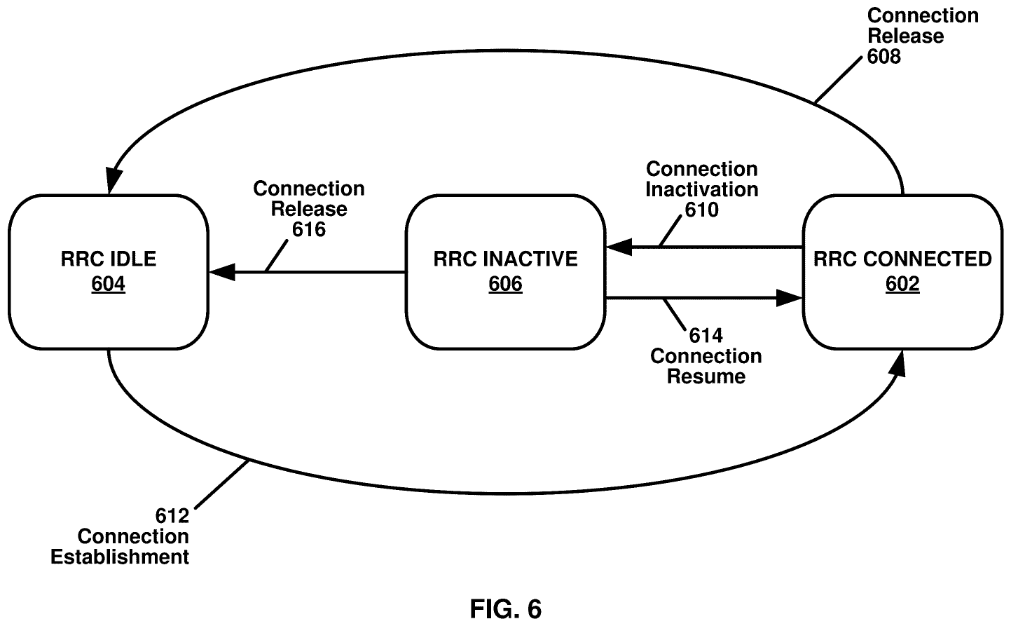

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAls, or a list of TAls. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split in two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

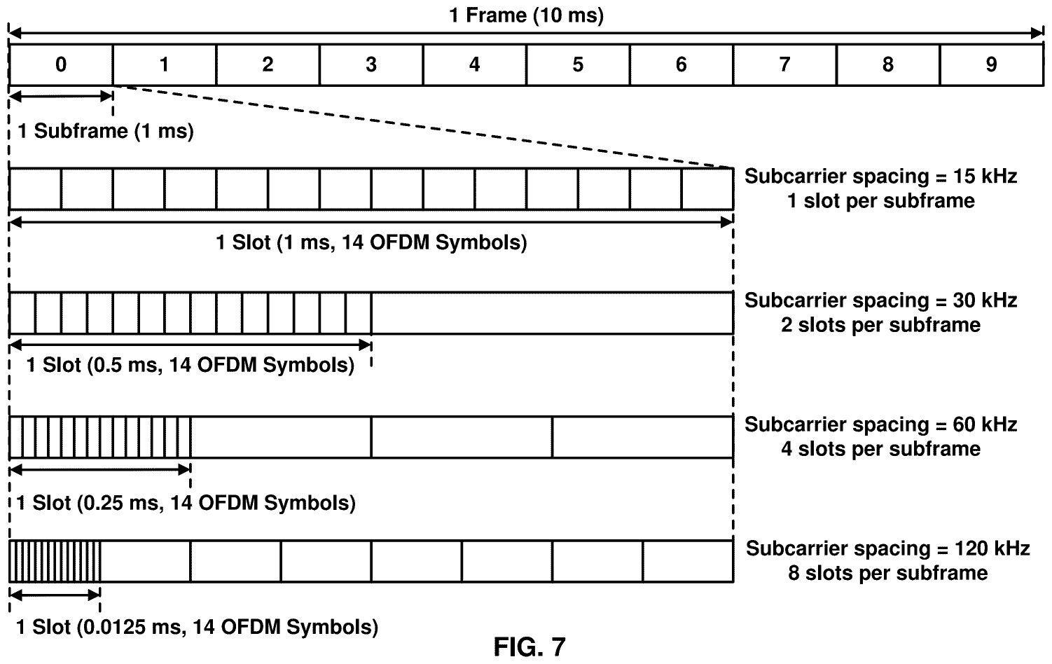

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 KHz/2.3 μs; 60 KHz/1.2 μs; 120 KHz/0.59 μs; and 240 KHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 KHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

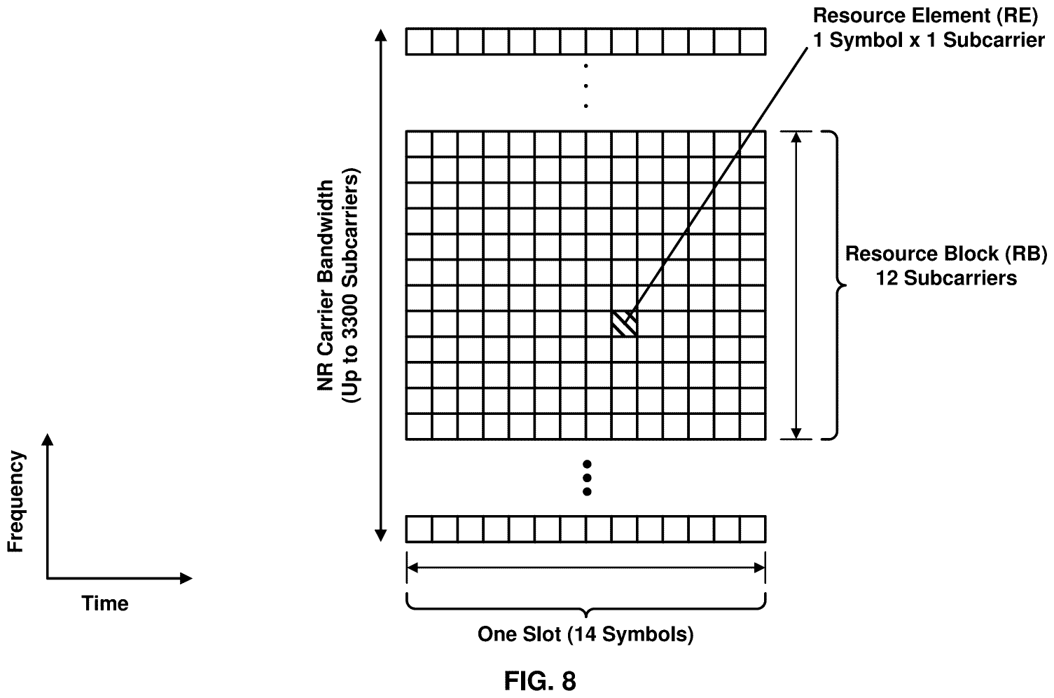

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHZ bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

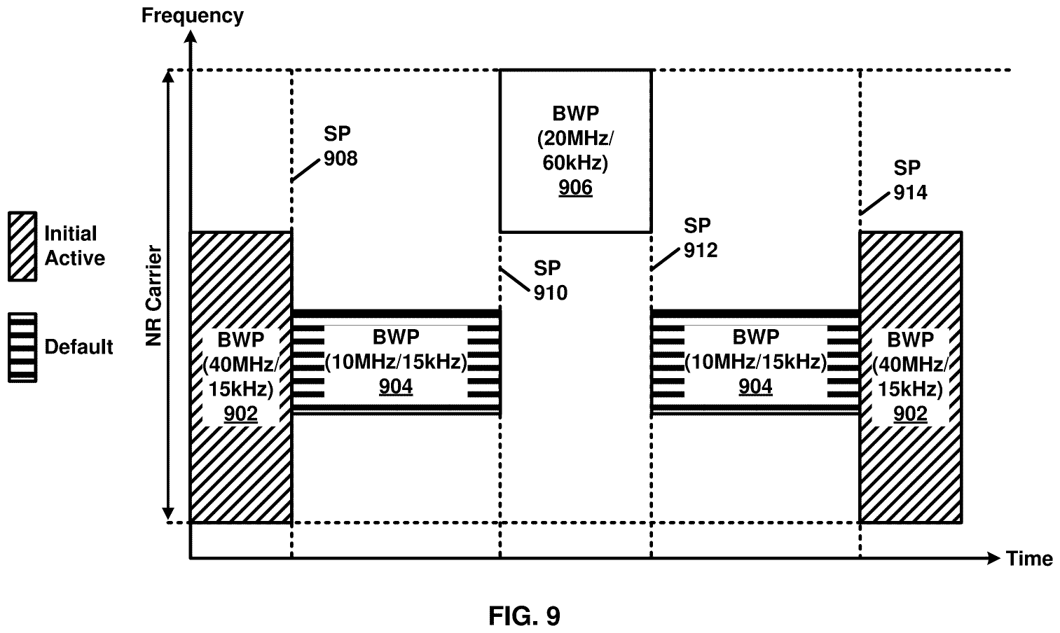

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 KHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response to receiving a DCI indicating BWP 906 as the active BWP. The UE may switch at a switching point 912 from active BWP 906 to BWP 904 in response to an expiry of a BWP inactivity timer and/or in response receiving a DCI indicating BWP 904 as the active BWP. The UE may switch at a switching point 914 from active BWP 904 to BWP 902 in response to receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

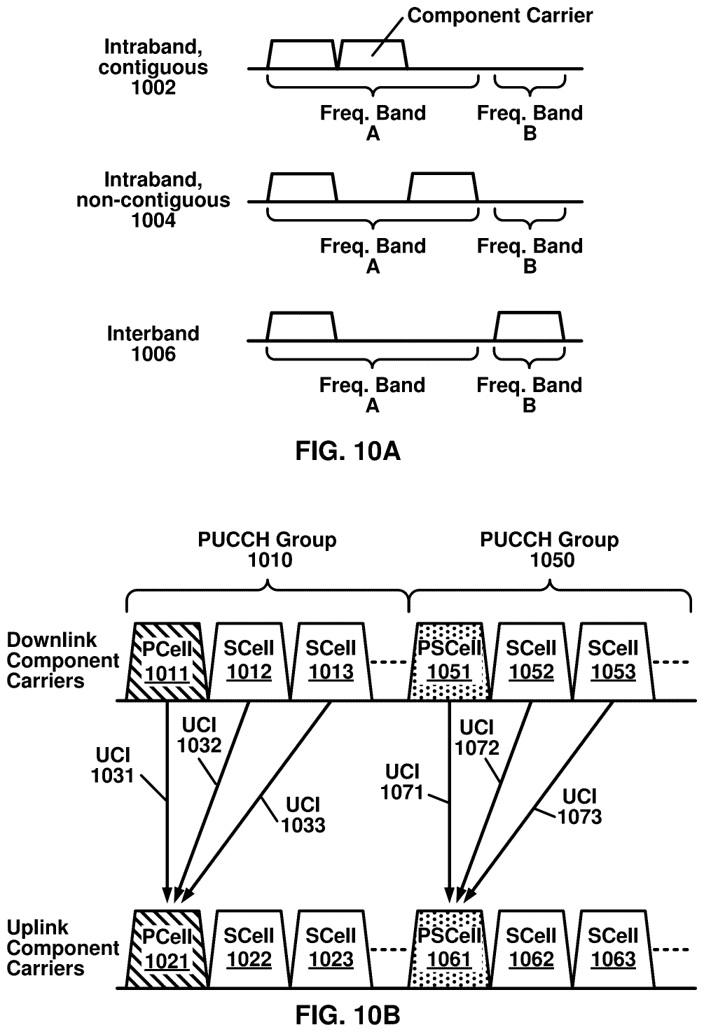

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary Scell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

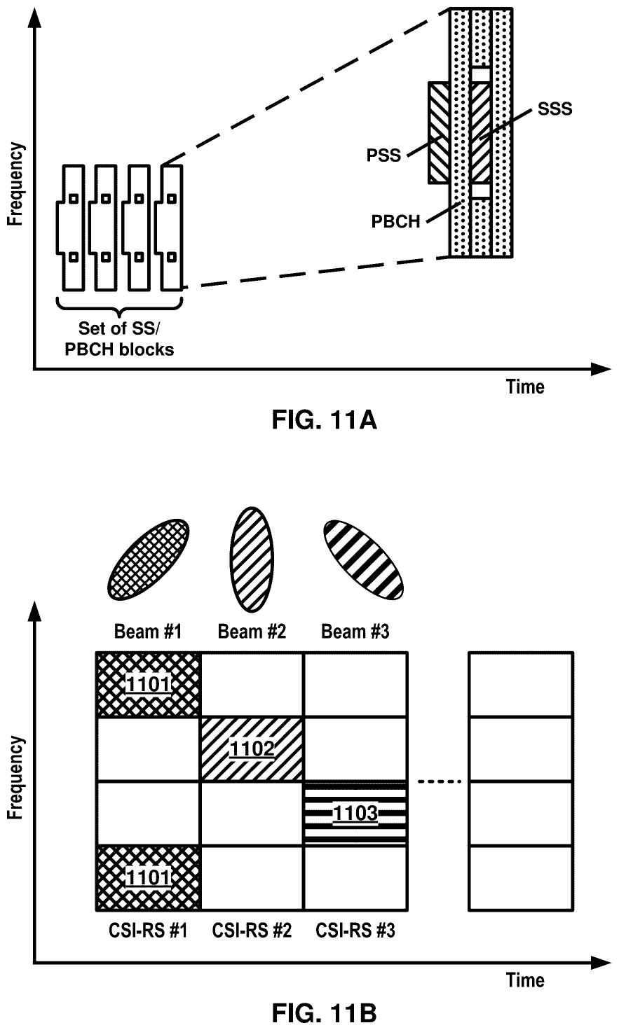

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation.

Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM)) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in an SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

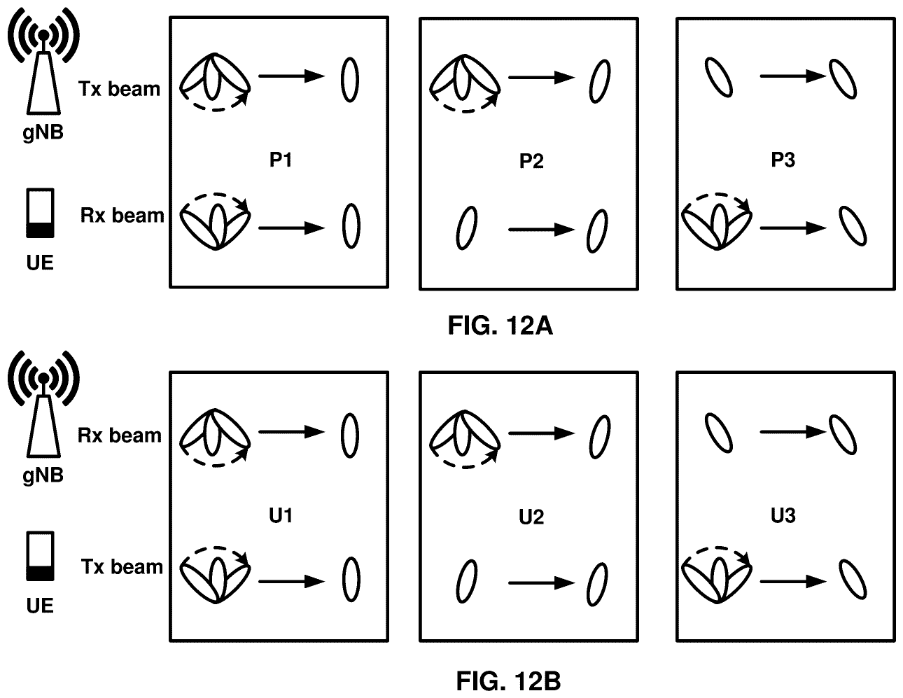

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counterclockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counterclockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counterclockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement. The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiation of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

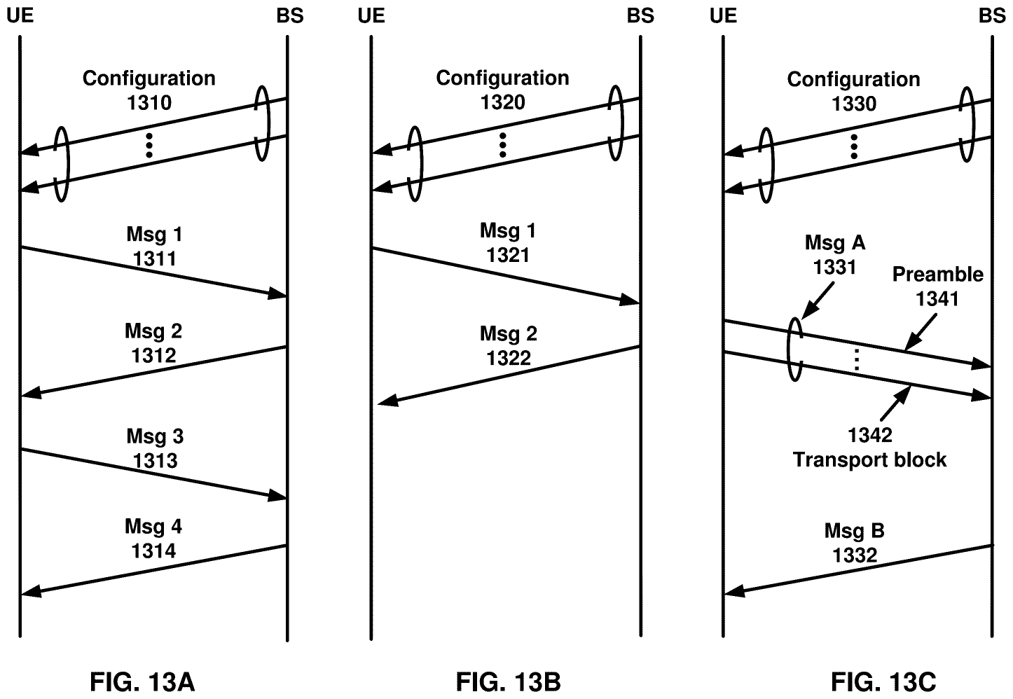

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preamble TransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

$$RA - RNTI = 1 + s\_id + 14 \times t\_id + 14 \times 80 \times f\_id + 14 \times 80 \times 8 \times ul\_carrier \_id$$

where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

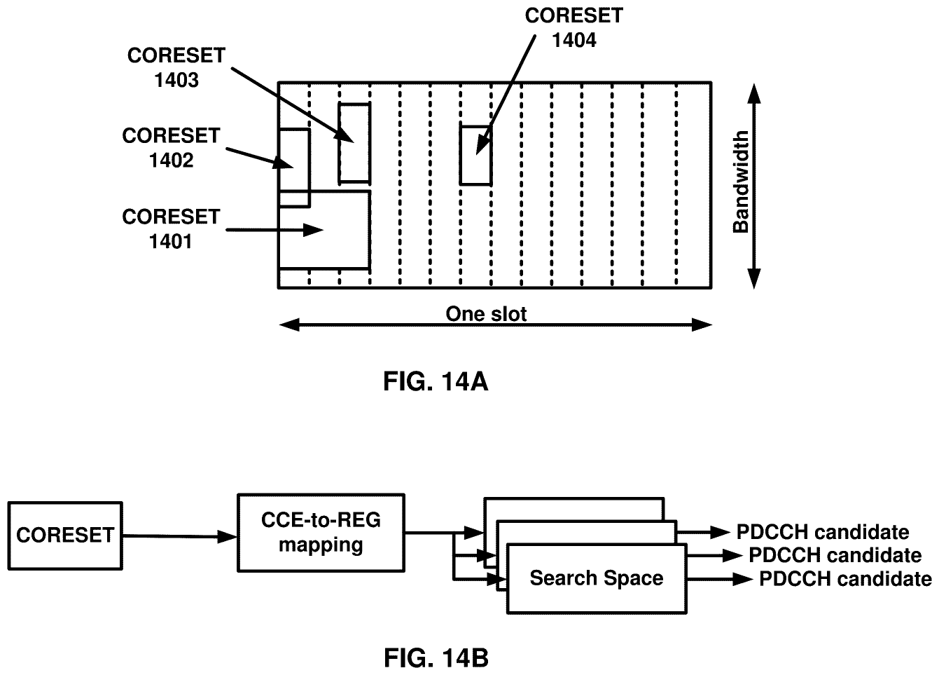

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

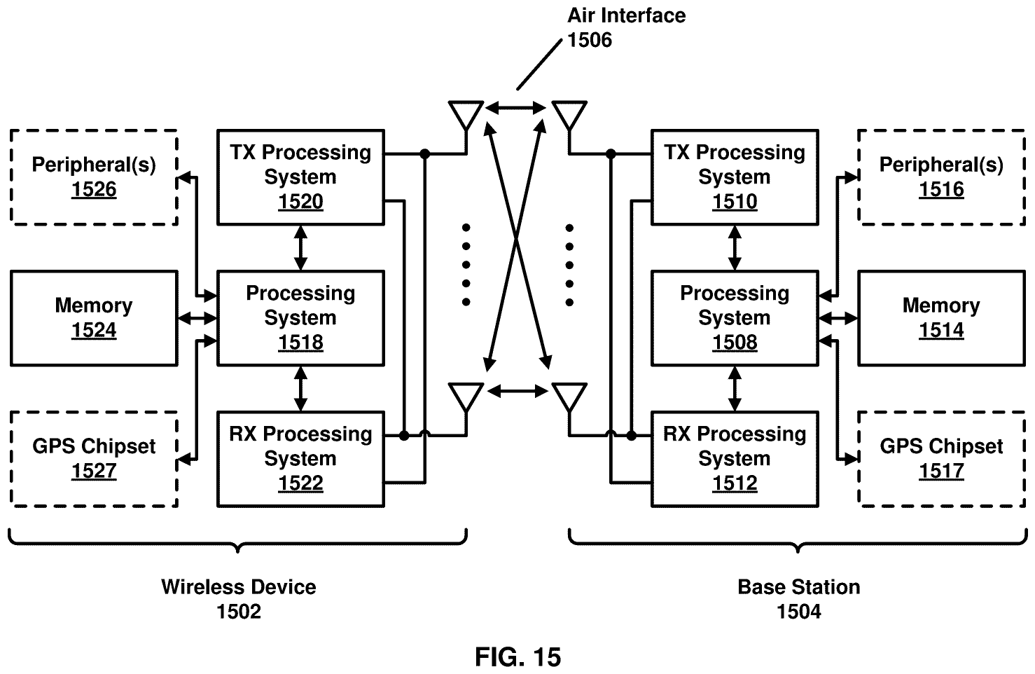

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

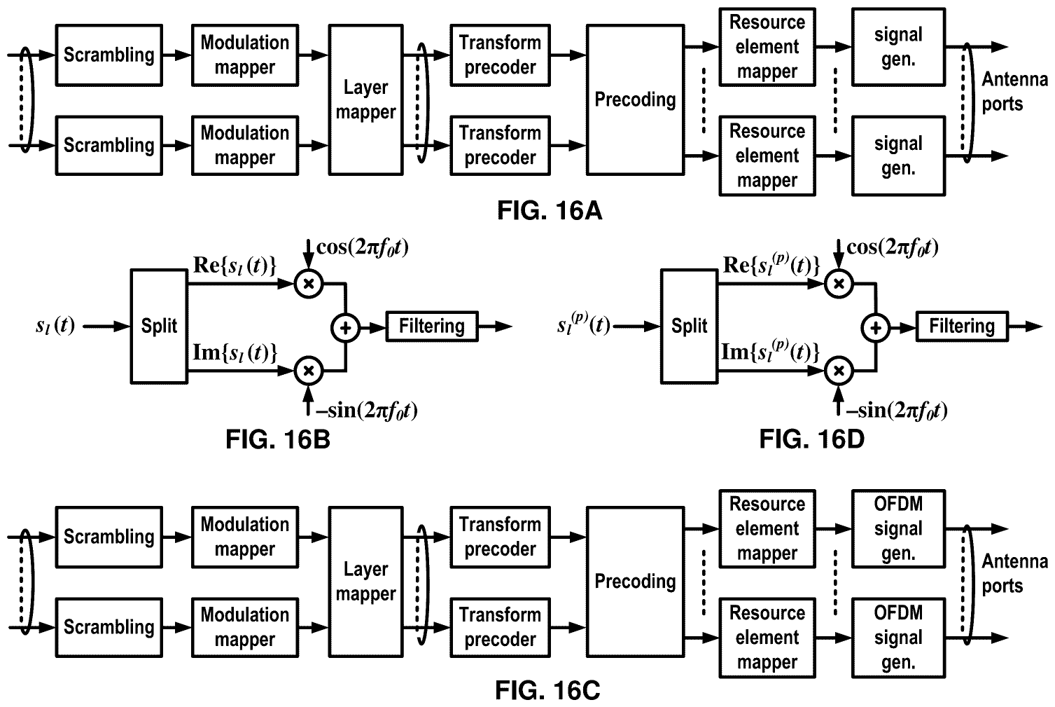

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, a CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual connectivity) via the plurality of cells. The one or more messages (e.g. as a part of the configuration parameters) may comprise parameters of physical, MAC, RLC, PCDP, SDAP, and RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

A base station may transmit one or more MAC PDUs to a wireless device. In an example, a MAC PDU may be a bit string that is byte aligned (e.g., aligned to a multiple of eight bits) in length. In an example, bit strings may be represented by tables in which the most significant bit is the leftmost bit of the first line of the table, and the least significant bit is the rightmost bit on the last line of the table. More generally, the bit string may be read from left to right and then in the reading order of the lines. In an example, the bit order of a parameter field within a MAC PDU is represented with the first and most significant bit in the leftmost bit and the last and least significant bit in the rightmost bit.

In an example, a MAC SDU may be a bit string that is byte aligned (e.g., aligned to a multiple of eight bits) in length. In an example, a MAC SDU may be included in a MAC PDU from the first bit onward. A MAC CE may be a bit string that is byte aligned (e.g., aligned to a multiple of eight bits) in length. A MAC subheader may be a bit string that is byte aligned (e.g., aligned to a multiple of eight bits) in length. In an example, a MAC subheader may be placed immediately in front of a corresponding MAC SDU, MAC CE, or padding. A MAC entity may ignore a value of reserved bits in a DL MAC PDU.

In an example, a MAC PDU may comprise one or more MAC subPDUs. A MAC subPDU of the one or more MAC subPDUs may comprise: a MAC subheader only (including padding); a MAC subheader and a MAC SDU; a MAC subheader and a MAC CE; a MAC subheader and padding, or a combination thereof. The MAC SDU may be of variable size. A MAC subheader may correspond to a MAC SDU, a MAC CE, or padding.

In an example, when a MAC subheader corresponds to a MAC SDU, a variable-sized MAC CE, or padding, the MAC subheader may comprise: a Reserve field (R field) with a one bit length; an Format field (F field) with a one-bit length; a Logical Channel Identifier (LCID) field with a multi-bit length; a Length field (L field) with a multi-bit length, indicating the length of the corresponding MAC SDU or variable-size MAC CE in bytes, or a combination thereof. In an example, F field may indicate the size of the L field.

In an example, a MAC entity of the base station may transmit one or more MAC CEs (e.g., MAC CE commands) to a MAC entity of a wireless device. The one or more MAC CEs may comprise at least one of: a SP ZP CSI-RS Resource Set Activation/Deactivation MAC CE, a PUCCH spatial relation Activation/Deactivation MAC CE, a SP SRS Activation/Deactivation MAC CE, a SP CSI reporting on PUCCH Activation/Deactivation MAC CE, a TCI State Indication for UE-specific PDCCH MAC CE, a TCI State Indication for UE-specific PDSCH MAC CE, an Aperiodic CSI Trigger State Subselection MAC CE, a SP CSI-RS/CSI-IM Resource Set Activation/Deactivation MAC CE, a UE contention resolution identity MAC CE, a timing advance command MAC CE, a DRX command MAC CE, a Long DRX command MAC CE, an SCell activation/deactivation MAC CE (1 Octet), an SCell activation/deactivation MAC CE (4 Octet), and/or a duplication activation/deactivation MAC CE. In an example, a MAC CE, such as a MAC CE transmitted by a MAC entity of the base station to a MAC entity of the wireless device, may have an LCID in the MAC subheader corresponding to the MAC CE. In an example, a first MAC CE may has a first LCID in the MAC subheader that may be different than the second LCID in the MAC subheader of a second MAC CE. For example, an LCID given by 111011 in a MAC subheader may indicate that the MAC CE associated with the MAC subheader is a Long DRX command MAC CE.

In an example, the MAC entity of the wireless device may transmit to the MAC entity of the base station one or more MAC CEs. The one or more MAC CEs may comprise at least one of: a short buffer status report (BSR) MAC CE, a long BSR MAC CE, a C-RNTI MAC CE, a configured grant confirmation MAC CE, a single entry PHR MAC CE, a multiple entry PHR MAC CE, a Short truncated BSR, and/or a Long truncated BSR. In an example, a MAC CE may have an LCID in the MAC subheader corresponding to the MAC CE. In an example, a first MAC CE may has a first LCID in the MAC subheader that may be different than the second LCID in the MAC subheader of a second MAC CE. For example, an LCID given by 111011 in a MAC subheader may indicate that a MAC CE associated with the MAC subheader is a short-truncated command MAC CE.

In carrier aggregation (CA), two or more component carriers (CCs) may be aggregated. The wireless device may, using the technique of CA, simultaneously receive or transmit on one or more CCs, depending on capabilities of the wireless device. In an example, the wireless device may support CA for contiguous CCs and/or for non-contiguous CCs. CCs may be organized into cells. For example, CCs may be organized into one primary cell (PCell) and one or more secondary cells (SCells).

When configured with CA, the wireless device may have one RRC connection with a network. During an RRC connection establishment/re-establishment/handover, a cell providing NAS mobility information may be a serving cell. During an RRC connection re-establishment/handover procedure, a cell providing a security input may be the serving cell. In an example, the serving cell may be a PCell.

In an example, the base station may transmit, to the wireless device, one or more messages (e.g., one or more downlink signals). The one or more messages may comprise one or more RRC messages, e.g., one or more RRC configuration/reconfiguration messages. For example, the one or more RRC messages may comprise one or more configuration parameters (e.g., one or more RRC configuration parameters).

In an example, the one or mor configuration parameters may comprise configuration parameters of a plurality of one or more SCells, depending on capabilities of the wireless device. When configured with CA, the base station and/or the wireless device may employ an activation/deactivation mechanism of an SCell to improve battery or power consumption of the wireless device. When the wireless device is configured with one or more SCells, the base station may activate or deactivate at least one of the one or more SCells. Upon configuration of an SCell, the SCell may be deactivated unless the SCell state associated with the SCell is set to “activated” or “dormant.” The wireless device may activate/deactivate the SCell in response to receiving an SCell Activation/Deactivation MAC CE.

For example, the base station may configure (e.g., via the one or more RRC messages/parameters) the wireless device with uplink (UL) bandwidth parts (BWPs) and downlink (DL) BWPs to enable bandwidth adaptation (BA) on a PCell. If carrier aggregation (CA) is configured, the base station may further configure the wireless device with at least one DL BWP (e.g., there may be no UL BWP in the UL) to enable BA on an SCell. For the PCell, an initial active BWP may be a first BWP used for initial access. In paired spectrum (e.g., FDD), the base station and/or the wireless device may independently switch a DL BWP and an UL BWP. In unpaired spectrum (e.g., TDD), the base station and/or the wireless device may simultaneously switch the DL BWP and the UL BWP.

In an example, the base station and/or the wireless device may switch a BWP between configured BWPs by means of a DCI or a BWP invalidity timer. When the BWP invalidity timer is configured for the serving cell, the base station and/or the wireless device may switch the active BWP to a default BWP in response to the expiry of the BWP invalidity timer associated with the serving cell. The default BWP may be configured by the network. In an example, for FDD systems, when configured with BA, one UL BWP for each uplink carrier and one DL BWP may be active at a time in the active serving cell. In an example, for TDD systems, one DL/UL BWP pair may be active at a time in the active serving cell. Operating on one UL BWP and one DL BWP (or one DL/UL pair) may improve the wireless device battery consumption. One or more BWPs other than the active UL BWP and the active DL BWP, which the wireless device may work on, may be deactivated. On the deactivated one or more BWPs, the wireless device may: not monitor PDCCH; and/or not transmit on PUCCH, PRACH, and UL-SCH. In an example, the MAC entity of the wireless device may apply normal operations on the active BWP for an activated serving cell configured with a BWP comprising: transmitting on UL-SCH; transmitting on RACH; monitoring a PDCCH; transmitting PUCCH; receiving DL-SCH; and/or (re-) initializing any suspended configured uplink grants of configured grant Type 1 according to a stored configuration, if any. In an example, on the inactive/idle BWP for each activated serving cell configured with a BWP, the MAC entity of the wireless device may: not transmit on UL-SCH; not transmit on RACH; not monitor a PDCCH; not transmit PUCCH; not transmit SRS, not receive DL-SCH; clear any configured downlink assignment and configured uplink grant of configured grant Type 2; and/or suspend any configured uplink grant of configured Type 1.

In an example, a DCI addressed to an RNTI may comprise a CRC of the DCI being scrambled with the RNTI. The wireless device may monitor PDCCH addressed to (or for) the RNTI for detecting the DCI. For example, the PDCCH may carry (or be with) the DCI. In an example, the PDCCH may not carry the DCI.

In an example, a set of PDCCH candidates for the wireless device to monitor is defined in terms of one or more search space sets. A search space set may comprise a common search space (CSS) set or a UE-specific search space (USS) set. The wireless device may monitor one or more PDCCH candidates in one or more of the following search space sets (e.g., one or more search space sets): a Type0-PDCCH CSS set configured by pdcch-ConfigSIB1 in MIB or by searchSpaceSIB1 in PDCCH-ConfigCommon or by searchSpace Zero in PDCCH-ConfigCommon for a DCI format with CRC scrambled by a SI-RNTI on the primary cell of the MCG, a Type0A-PDCCH CSS set configured by search SpaceOtherSystemInformation in PDCCH-ConfigCommon for a DCI format with CRC scrambled by the SI-RNTI on the primary cell of the MCG, a Type1-PDCCH CSS set configured by ra-SearchSpace in PDCCH-ConfigCommon for a DCI format with CRC scrambled by a RA-RNTI, a MSGB-RNTI, or a TC-RNTI on the primary cell, a Type2-PDCCH CSS set configured by pagingSearchSpace in PDCCH-ConfigCommon for a DCI format with CRC scrambled by a P-RNTI on the primary cell of the MCG, a Type3-PDCCH CSS set configured by SearchSpace in PDCCH-Config with search Space Type=common for DCI formats with CRC scrambled by a INT-RNTI, a SFI-RNTI, a TPC-PUSCH-RNTI, a TPC-PUCCH-RNTI, a TPC-SRS-RNTI, a CI-RNTI, or a power saving RNTI (PS-RNTI) and, only for the primary cell, a C-RNTI, a MCS-C-RNTI, or a CS-RNTI(s), and the USS set configured by SearchSpace in PDCCH-Config with searchSpace Type=ue-Specific for DCI formats with CRC scrambled by the C-RNTI, the MCS-C-RNTI, a SP-CSI-RNTI, the CS-RNTI(s), a SL-RNTI, a SL-CS-RNTI, or a SL-L-CS-RNTI.

In an example, the wireless device may monitor the one or more PDCCH candidates according to one or more configuration parameters of the search space set. For example, the search space set may comprise a plurality of search spaces (SSs). The wireless device may monitor the one or more PDCCH candidates in one or more CORESETs for detecting one or more DCIs. Monitoring the one or more PDCCH candidates may comprise decoding at least one PDCCH candidate of the one or more PDCCH candidates according to the monitored DCI formats. For example, monitoring the one or more PDCCH candidates may comprise decoding (e.g., blind decoding) a DCI content of the at least one PDCCH candidate via possible (or configured) PDCCH location(s), possible (or configured) PDCCH format(s), e.g., number of CCEs, number of PDCCH candidates in CSS set(s), and/or number of PDCCH candidates in the USS(s), and/or possible (or configured) DCI format(s).

In an example, the wireless device may receive the C-RNTI (e.g., via one or mor previous transmissions) from the base station. For example, the one or more previous transmissions may comprise a Msg2 13 12, Msg4 1314, or a MsgB 1332. If the wireless device is not provided the Type3-PDCCH CSS set or the USS set and if provided the Type1-PDCCH CSS set, the wireless device may monitor the one or more PDCCH candidates for DCI format 0_0 and DCI format 1_0 with CRC scrambled by the C-RNTI in the Type1-PDCCH CSS set.

For example, the one or more search space sets may correspond to one or more of searchSpaceZero, searchSpaceSIB1, searchSpaceOtherSystemInformation, pagingSearchSpace, ra-SearchSpace, and the C-RNTI, the MCS-C-RNTI, or the CS-RNTI. The wireless device may monitor the one or more PDCCH candidates for the DCI format 0_0 and the DCI format 1_0 with CRC scrambled by the C-RNTI, the MCS-C-RNTI, or the CS-RNTI in the one or more search space sets in a slot where the wireless device monitors the one or more PDCCH candidates for at least the DCI format 0_0 or the DCI format 1_0 with CRC scrambled by the SI-RNTI, the RA-RNTI, the MSGB-RNTI, or the P-RNTI.

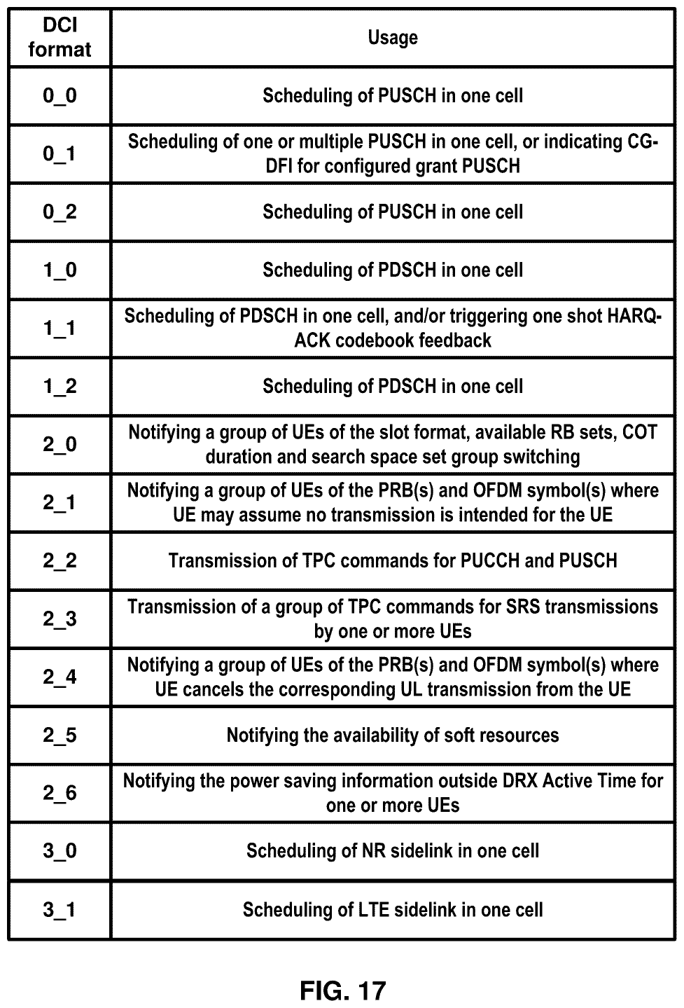

FIG. 17 shows several DCI formats. For example, the base station may use the DCI formats to transmit downlink control information to the wireless device. In an example, the wireless device may use the DCI formats for PDCCH monitoring. Different DCI formats may comprise different DCI fields and/or have different DCI payload sizes. Different DCI formats may have different signaling purposes. As shown in FIG. 17, DCI format 0_0 may be used to schedule PUSCH in one cell. In an example, DCI format 0_1 may be used to schedule one or multiple PUSCH in one cell or indicate CG-DFI (configured grant-Downlink Feedback Information) for configured grant PUSCH, etc.

In an example, the wireless device may support a baseline processing time/capability. For example, the wireless device may support additional aggressive/faster processing time/capability. In an example, the wireless device may report to the base station a processing capability, e.g., per sub-carrier spacing. In an example, a PDSCH processing time may be considered to determine, by a wireless device, a first uplink symbol of a PUCCH (e.g., determined at least based on a HARQ-ACK timing K1 and one or more PUCCH resources to be used and including the effect of the timing advance) comprising the HARQ-ACK information of the PDSCH scheduled by a DCI. In an example, the first uplink symbol of the PUCCH may not start earlier than a time gap (e.g., T_{proc,1}) after a last symbol of the PDSCH reception associated with the HARQ-ACK information. In an example, the first uplink symbol of the PUCCH which carries the HARQ-ACK information may start no earlier than at symbol L1, where L1 is defined as the next uplink symbol with its Cyclic Prefix (CP) starting after the time gap T_{proc,1} after the end of the last symbol of the PDSCH.

In an example, a PUSCH preparation/processing time may be considered for determining the transmission time of an UL data. For example, if the first uplink symbol in the PUSCH allocation for a transport block (including DM-RS) is no earlier than at symbol L2, the wireless device may perform transmitting the PUSCH. In an example, the symbol L2 may be determined, by a wireless device, at least based on a slot offset (e.g., K2), SLIV of the PUSCH allocation indicated by time domain resource assignment of a scheduling DCI. In an example, the symbol L2 may be specified as the next uplink symbol with its CP starting after a time gap with length T_{proc,2} after the end of the reception of the last symbol of the PDCCH carrying the DCI scheduling the PUSCH.

In an example, the one or more configuration parameters may comprise one or more DRX configuration parameters (e.g., DRX-Config). The one or more DRX configuration parameters may configure the wireless device with DRX operation. In an example, the one or more DRX configuration parameters may indicate monitoring the PDCCH for the DRX operation. For example, when in an RRC_CONNECTED state, if the DRX operation is configured (e.g., the DRX is configured or a DRX cycle is configured), for all the activated Serving Cells (e.g., the serving cell), the MAC entity of the wireless device may monitor the PDCCH discontinuously using the DRX operation. Otherwise, the MAC entity may monitor the PDCCH continuously.

For example, the wireless device may, based on the DRX operation being configured, use the DRX operation while communicating with the base station in the serving cell. For example, a MAC entity (or the MAC layer) of the wireless device, based on the DRX operation being configured, may control the PDCCH monitoring activity of the MAC entity. When the DRX operation is configured, the wireless device may monitor the PDCCH for at least one RNTI. In an example, the at least one RNTI may comprise one or more of the following: C-RNTI, cancelation indication RNTI (CI-RNTI), configured scheduling RNTI (CS-RNTI), interruption RNTI (INT-RNTI), slot format indication RNTI (SFI-RNTI), semi-persistent channel state information RNTI (SP-CSI-RNTI), transmit power control physical uplink control channel RNTI (TPC-PUCCH-RNTI), transmit power control physical shared channel RNTI (TPC-PUSCH-RNTI), transmit power control sounding reference signal RNTI (TPC-SRS-RNTI), or availability indicator RNTI (AI-RNTI).

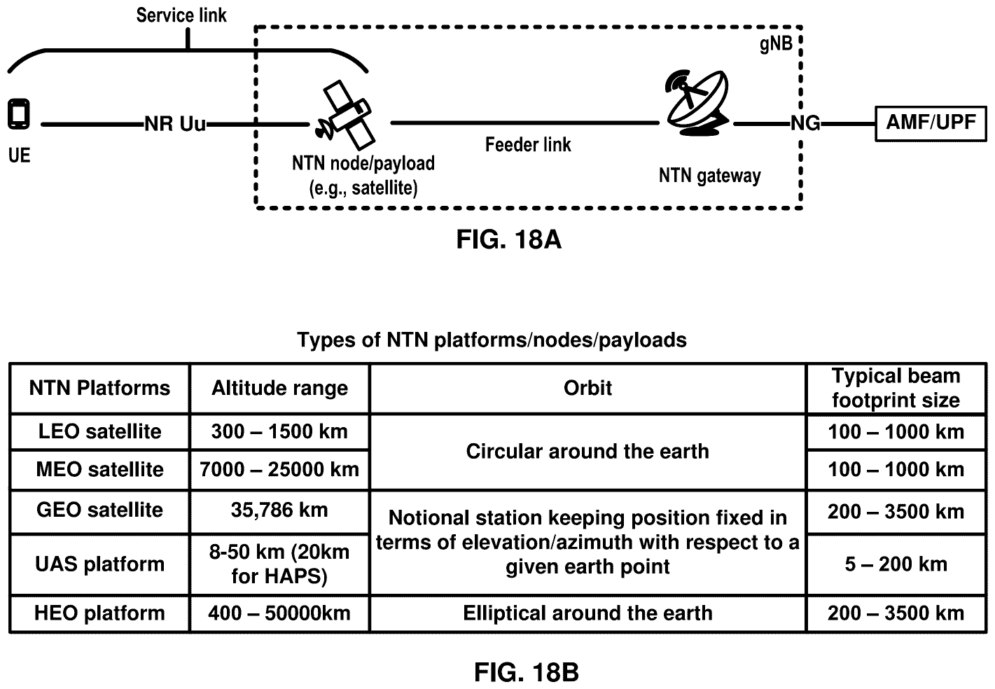

FIG. 18A shows an example of a non-terrestrial network. The non-terrestrial network (NTN) network (e.g., a satellite network) may be a network or network segment (e.g., an NG-RAN consisting of gNBs) for providing non-terrestrial NR access to wireless devices. The NTN may use a space-borne vehicle to embody a transmission equipment relay node (e.g., radio remote unit or a transparent payload) or a base station (or a regenerative payload). While a terrestrial network is a network located on the surface of the earth, an NTN may be a network which uses an NTN node (e.g., a satellite) as an access network, a backhaul interface network, or both. In an example, an NTN may comprise one or more NTN nodes (or payloads and/or space-borne vehicles), each of which may provide connectivity functions, between the service link and the feeder link.

An NTN node may embark a bent pipe payload (e.g., a transparent payload) or a regenerative payload. The NTN node with the transparent payload may comprise transmitter/receiver circuitries without the capability of on-board digital signal processing (e.g., modulation and/or coding) and connect to a base station (e.g., a base station of an NTN or the NTN base station or a non-terrestrial access point) via a feeder link. In some respects, as shown in FIG. 18A, the base station (e.g., a gNB) may further comprise the transparent NTN node, the feeder link, and/or a gateway (e.g., an NTN gateway). The gateway may be an earth station that is located at the surface of the earth, providing connectivity to the NTN payload using a feeder link. In some examples, the NTN node with the regenerative payload (e.g., the base station of the NTN or the NTN base station) may comprise functionalities of a base station, e.g., the on-board processing used to demodulate and decode the received signal and/or regenerate the signal before sending/transmitting it back to the earth. In some respects, as shown in FIG. 18A, the base station (e.g., the gNB) may further comprise the regenerative NTN node, the feeder link, and/or the gateway (e.g., the NTN gateway).

In some examples, the NTN node may be a satellite, a balloon, an air ship, an airplane, an unmanned aircraft system (UAS), an unmanned aerial vehicle (UAV), a drone, or the like. For example, the UAS may be a blimp, a high-altitude platform station (HAPS), e.g., an airborne vehicle embarking the NTN payload placed at an altitude between 8 and 50 km, or a pseudo satellite station. FIG. 18B is an example figure of different types of NTN platforms. In an example, a satellite may be placed into a low-earth orbit (LEO) at an altitude between 250 km to 1500 km, with orbital periods ranging from 90-130 minutes. From the perspective of a given point on the surface of the earth, the position of the LEO satellite may change. In an example, a satellite may be placed into a medium-earth orbit (MEO) at an altitude between 5000 to 20000 km, with orbital periods ranging from 2 hours to 14 hours. In an example, a satellite may be placed into a geostationary satellite earth orbit (GEO) at 35,786 km altitude, and directly above the equator. From the perspective of a given point on the surface of the earth, the position of the GEO satellite may not change.

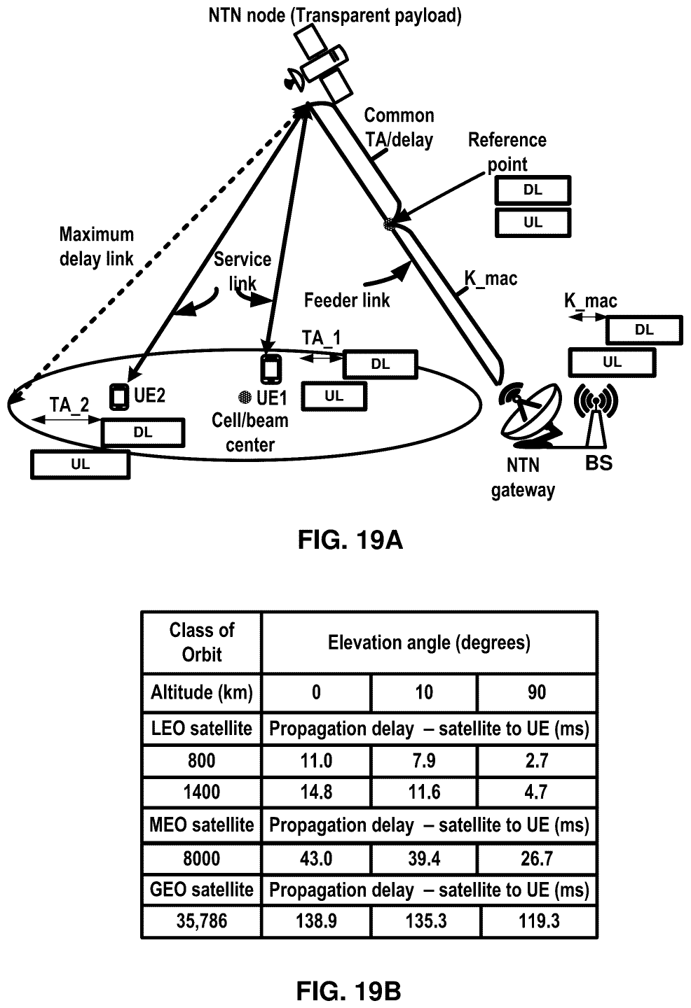

FIG. 19A shows an example of an NTN with a transparent NTN platform. As shown in FIG. 19A, the NTN node (e.g., the satellite) may forward a received signal from the NTN gateway on the ground back to the earth over the feeder link. In an example, the gateway and the base station may not be collocated. The NTN node may forward a received signal to the wireless device or the base station from another NTN node, e.g., over inter-link satellite communication links.

The NTN node may generate one or more beams over a given area (e.g., a coverage area or a cell). The footprint of a beam (or the cell) may be referred to as a spotbeam. For example, the footprint of a cell/beam may move over the Earth's surface with the satellite movement (e.g., a LEO with moving cells or a HAPS with moving cells). The footprint of a cell/beam may be Earth fixed with some beam pointing mechanism used by the satellite to compensate for its motion (e.g., a LEO with earth fixed cells). As shown in FIG. 18B, the size of a spotbeam may range from tens of kilometers to a few thousand kilometers. For example, the size of the spotbeam may depend on the system design.

A propagation delay may be an amount of time it takes for the head of the signal to travel from a sender (e.g., the base station or the NTN node) to a receiver (e.g., the wireless device) or vice versa. For uplink, the sender may be the wireless device and the receiver may be the base station/access network. For downlink, the sender may be the base station/access network and the receiver may be the wireless device. The propagation delay may vary depending on a change in distance between the sender and the receiver, e.g., due to movement of the NTN node, movement of the wireless device, a change of an inter-satellite link, and/or feeder link switching.

FIG. 19B shows examples of propagation delay corresponding to NTNs of different altitudes. The propagation delay in the figure may be one-way latency/delay. In an example, one-way latency/delay may be an amount of time required to propagate through a telecommunication system from the sender (e.g., the base station) to the receiver (e.g., the wireless device). In an example shown in FIG. 19B, for the transparent NTN, the round-trip propagation delay (RTD or UE-gNB RTT) may comprise service link delay (e.g., between the NTN node and the wireless device), feeder link delay (e.g., between the NTN gateway and the NTN node), and/or between the gateway and the base station (e.g., in the case the gateway and the NTN base station are not collocated). For example, the UE-gNB RTT (or the RTD) may be twice of the one-way delay between the wireless device and the base station. From FIG. 19B, in case of a GEO satellite with the transparent payload, the RTD may be four times of 138.9 milliseconds (approximately 556 milliseconds). In an example, the RTD of a terrestrial network (e.g., NR, E-UTRA, LTE) may be negligible compared to the RTD of an NTN scenario (e.g., the RTD of a terrestrial network may be less than 1 millisecond). A maximum RTD of a LEO satellite with the transparent payload and altitude of 600 km is approximately 25.77 milliseconds and with altitude of 1200 km is approximately 41.77 milliseconds.

A differential delay within a beam/cell of a NTN node may depend on, for example, the maximum diameter of the beam/cell footprint at nadir. For example, the differential delay withing the beam/cell may depend on the maximum delay link in FIG. 19A. In an example, the differential delay may imply the maximum difference between communication latency that two wireless devices, e.g., a first wireless device (UE1) that is located close to the center of the cell/beam and a second wireless device (UE2) that is located close to the edge of the cell/beam in FIG. 19B, may experience while communicating with the base station via the NTN node. The first wireless device may experience a smaller RTD compared to the second wireless device. The link with a maximum propagation delay (e.g., the maximum delay link) may experience the highest propagation delay (or the maximum RTD) in the cell/beam. In an example, the differential delay may imply a difference between the maximum delay of the cell/beam and a minimum delay of the cell/beam. In an example, the service link to a cell/beam center may experience the minimum propagation delay in the cell/beam. Depending on implementation, for a LEO satellite, the differential delay may be at least 3.12 milliseconds and may increase up to 8 milliseconds. In an example of a GEO satellite, depending on implementation, the differential delay may be as large as 32 milliseconds.

The wireless device (e.g., the first wireless device and/or the second wireless device in FIG. 19B) may receive the one or more configuration parameters, e.g., the one or more RRC configuration parameters from the base station. For example, the one or more configuration parameters may comprise one or more NTN configuration parameters. In some aspects, the wireless device may indicate a capability for NR NTN access (e.g., nonTerrestrialNetwork-r17), e.g., to receive the one or more NTN configuration parameters (e.g., via one or more NTN-specific SIBs and/or SIB1). For example, the one or more NTN configuration parameters may be received, by the wireless device, from a broadcast system information (e.g., SIB1 and/or the one or more NTN-specific SIBs). The one or more NTN configuration parameters may facilitate/manage the calculation/determination/measurement of the propagation delay (e.g., the UE-gNB RTT) and/or a timing advance (TA) at one or more wireless devices (e.g., the wireless device) camping in the cell/beam. In an example, the one or more NTN configuration parameters may comprise at least one or more ephemeris parameters (e.g., satellite ephemeris parameters or NTN ephemeris parameters), one or more common delay/TA parameters, a validity duration (or timer or window) for UL synchronization, an epoch time, and/or one or more timing offset parameters. The validity duration may be for uplink synchronization assistance information (e.g., the one or more NTN configuration parameters). In an example, the validity duration may indicate a maximum time during which the wireless device may apply the assistance information (e.g., the one or more NTN configuration parameters) without (re) acquiring new assistance information (e.g., without reacquiring the NTN-specific SIB or SIB1). For example, the one or more NTN configuration parameters may enable a TA reporting.

In an example, the wireless device may maintain/calculate a cell-specific timing offset, one or more beam-specific timing offsets, and/or a UE-specific timing offset (e.g., UE-specific K_Offset) based on the one or more timing offset parameters and/or one or more MAC CE commands and/or one or more RRC signaling. For example, the one or more timing offset parameters may comprise a first timing offset (e.g., Koffset in ServingCellConfigCommon). In some aspects, the first timing offset may account for the maximum RTD of the cell/beam. For example, the wireless device may track/update/maintain the cell/beam-specific timing offset based on receiving an update of the first timing offset from the base station. For example, the wireless device may receive a second timing offset (e.g., a Differential UE-Specific K_Offset MAC CE). The wireless device may update/track/maintain the UE-specific timing offset based on the second timing offset and/or the cell-specific timing offset.

In some examples, the one or more timing offset parameters may configure/indicate a third timing offset. The wireless device (or the base station) may set a MAC-specific timing offset (or a MAC layer timing offset), denoted by K-Mac, based on the third timing offset. For example, K-Mac may be 0, e.g., when the third timing offset is not indicated/configured. For example, in an NTN scenario with the transparent NTN node, when the UL frame and the DL frame are aligned at the base station, the third timing offset may be absent from the one or more NTN configuration parameters or may be 0. In an example, as shown in FIG. 19B, the MAC-specific timing offset may indicate a portion of the propagation delay (e.g., the UE-gNB RTT) that the base station may pre-compensate (e.g., when the UL frame and the DL frame are not aligned at the base station), e.g., the third timing offset may indicate the difference between the UL frame/configuration timing and the DL frame/configuration timing at the base station. As shown in FIG. 19B, the UL frame and DL frame may be aligned at a reference point on the feeder link. For example, the reference point may be the NTN node, e.g., the third timing offset is equal to the feeder link delay.

To maintain uplink orthogonality, transmissions from different wireless devices in a cell/beam (e.g., the first wireless device and the second wireless device in FIG. 19B) may need to be time-aligned at the base station and/or the NTN node (e.g., satellite). In an example, time alignment/synchronization may be achieved by using different timing advance (TA) values at different wireless devices to compensate for their different propagation delays (or RTDs). As shown in FIG. 19B, the first wireless device may use the first TA value (e.g., TA_1) and the second wireless device may use the second TA value (TA_2).

For example, the wireless device may calculate/measure/maintain a current TA (value) of the wireless device (e.g., NTA) based on at least a combination of a closed-loop TA procedure/control and/or an open-loop TA procedure/control. The current TA value of the first wireless device may be TA_1 and the current TA value of the second wireless device may be TA_2.

The closed-loop TA procedure/control may be based on receiving at least one TA command (TAC) MAC CE from the base station. For example, the at least one TAC CE may comprise a TA (or an absolute TA) command field of a Msg2 1312 (or a MsgB 1332).

The open-loop TA procedure/control may require a GNSS-acquired position (or location information) of the wireless device and/or receiving the one or more NTN configuration parameters, e.g., the one or more ephemeris parameters (e.g., the satellite ephemeris data), and/or the one or more common delay/TA parameters (e.g., the common TA value). The wireless device may, based on an implemented orbital predictor/propagator model, may use the one or more ephemeris parameters (and/or the GNSS-acquired position) to measure/calculate/maintain movement pattern of the satellite, estimate/measure the service link delay, and/or to adjust the current TA value (e.g., the TA of the wireless device) via the open-loop TA procedure/control. In an example, a combination of the closed-loop TA control and the open-loop TA control may be based on adding/summing the open-loop TA value (e.g., derived/calculated based on the open-loop TA procedure/control) and the closed-loop TA value (or a portion of the closed-loop TA procedure/control).

In an example, the wireless device may calculate/measure/estimate the UE-gNB RTT (or the RTD) based on the current TA value (e.g., corresponding to a TAG and/or a Serving Cell) and the third timing offset (e.g., K-Mac). For example, the UE-gNB RTT may be the summation of the current TA value (e.g., corresponding to a TAG and/or a Serving Cell) and K-Mac. In an example, if the third timing offset is not indicated or when the K-Mac is 0, the wireless device may determine/measure the UE-gNB RTT based on the current TA value (e.g., corresponding to a TAG and/or a Serving Cell), e.g., the UE-gNB RTT is equal to the current TA value (e.g., corresponding to a TAG and/or a Serving Cell). In an example, the wireless device may maintain/calculate/update the open-loop TA value (or the UE-gNB RTT) over the validity duration. For example, the validity duration may indicate the validity period of the (satellite) ephemeris data/information and/or the one or more common TA parameters. In an example, the validity duration may specify/indicate a maximum period/window (e.g., corresponding to an orbit predictor/propagator model the wireless device is using to estimate/calculate the propagation delay and/or a maximum tolerable error in estimating/measuring/calculating the open-loop TA value) during which the wireless device may not require to read/update/acquire the satellite ephemeris data and/or to acquire the one or more NTN-specific SIBs. For example, upon or in response to acquiring the new (satellite) ephemeris data (or parameters) and/or the one or more NTN-specific SIBs, the wireless device may start/restart the validity duration based on the epoch time indicated by the one or more NTN configuration parameters. In an example, in response to determining that the validity duration being expired, the wireless device may acquire the one or more NTN-specific SIBs to receive an updated (satellite) ephemeris data/information and/or an update of the one or more common TA parameters. In an example, upon the expiry of the validity duration and when the wireless device is not able to acquire the one or more NTN-specific SIBs, the wireless device may become unsynchronized with the base station, e.g., for UL communication with the base station.

In some aspects, in response to receiving the one or more NTN configuration parameters (e.g., via acquiring the one or more NTN-specific SIBs) and/or acquiring an updated GNSS-acquired position, the wireless device may calculate/measure/update the current TA value via the open-loop TA procedure/control. In another example, the wireless device may update the current TA value based on the closed-loop TA procedure/control, for example, based on receiving the one or more TAC MAC CEs. In an example, based on the current TA value being updated, the wireless device may adjust (recalculate) the UE-gNB RTT. In an example, based on receiving a new third timing offset, the wireless device may set K-Mac and adjust (recalculate) the UE-gNB RTT. In another example, the wireless device may periodically calculate/measure/update the current TA value. For example, the wireless device may, prior to performing an uplink transmission, calculate/measure/update the current TA value.

In an example, the wireless device may set the common TA/delay by zero in response to determining that the one or more common TA/delay parameters are absent from the one or more NTN configuration message. For example, when the reference point is located at the NTN node (e.g., the third timing offset is equal to the feeder link delay), the common TA/delay may be zero. In another example, for an NTN with the transparent payload, when the UL timing synchronization is held at the NTN node (e.g., the UL and DL frames are aligned at the base station), the wireless device may not pre-compensate the common TA.

In an example, the wireless device with GNSS capability may require estimating the propagation delay (or the service link delay) based on one or more measurements. For example, the one or more measurements may indicate the GNSS-acquired location information (position) of the wireless device. In an example, the one or more measurements may allow the wireless device to calculate/estimate the propagation delay (or the open-loop TA value) using the GNSS-acquired position and the (satellite) ephemeris data/information. In another example, the one or more measurements may allow the wireless devices to estimate/calculate the propagation delay via one or more timestamps (e.g., the timestamp of a configured broadcast signal) and/or the epoch time. In an example, the one or more measurements may allow the wireless device to estimate/measure a variation rate by which the common TA and/or the service link delay changes over a period.

A wireless device may communicate with a base station via an NTN (e.g., the base station and the wireless device may operate in the NTN and/or the base station may be an NTN base station). The communication of the wireless device and the base station may be subject to a long propagation delay (e.g., 20-40 ms in LEO satellite or approximately 600 ms in GEO satellite), e.g., due to a high altitude of the NTN payload/node (e.g., 400-1200 km in LEO satellite and up to 35786 km in GEO satellite) and/or a large cell/beam size (e.g., cell/beam radius of 200-3500 km). The base station may, for example, configure (e.g., via the one or more configuration parameters) the wireless device with one or more positioning sounding reference signal (SRS) configuration parameters (e.g., srs-PosRRC-InactiveConfig), e.g., for performing a positioning procedure. The one or more positioning SRS configuration parameters may indicate/configure at least one positioning SRS resource for (positioning) SRS transmission in/during/for a radio resource control (RRC) inactive/idle state/mode (e.g., RRC_INACTIVE/IDLE state/mode) of the wireless device. In an example, the one or more positioning SRS configuration parameters may comprise periodic and/or semi-persistent positioning SRS resource(s). The one or more positioning SRS configuration parameters may, for example, configure the wireless device with SRS procedure for the positioning procedure (e.g., a positioning SRS transmission procedure). The wireless device may, during the RRC inactive/idle state and to perform the positioning procedure, transmit positioning SRS (transmissions) via the at least one positioning SRS resource. For example, based on determining a TA (e.g., the TA of a TA group, e.g., a primary TA group or a secondary TA group, or the TA of the wireless device) being valid (e.g., a TA validation procedure in the RRC inactive/idle state), the wireless device may transmit the positioning SRS. The TA may be for the positioning SRS procedure (e.g., the TA value for/corresponding to/associated with SRS for Positioning transmission or the TA value for/corresponding to/associated with the positioning SRS transmission). In existing technologies, for determining the TA being valid, the wireless device may determine a reference signal received power (RSRP) of a downlink pathloss (DL-PL) reference being changed/varied/fluctuated (e.g., increased or decreased) less (or not greater) than an RSRP threshold (e.g., inactivePosSRS-RSRP-Change Threshold). For example, the wireless device may determine a time alignment timer (TAT), e.g., inactivePosSRS-TimeAlignmentTimer, being running. The one or more positioning SRS configuration parameters may indicate/configure the RSRP threshold and/or the inactivePosSRS-TimeAlignment Timer for the TA validation (procedure), e.g., for positioning SRS transmission in the RRC inactive/idle state.

In existing technologies, in an NTN scenario with moving NTN payload (e.g., a LEO satellite or a pseudo satellite, e.g., a HAPS) and/or an Earth-fixed cell/beam, by movement/displacement of the NTN payload/node there may be a continuous (and/or substantial) change/fluctuation of round-trip transmission delay between the wireless device and the base station (e.g., UE-gNB RTT). Based on existing technologies, the wireless device may fail to validate TA for positioning SRS transmission in the RRC inactive/idle state when the wireless device ignores (or does not consider) impact(s) of the movement/displacement of the NTN node/payload. For example, by ignoring impact(s) of the movement/displacement of the NTN node/payload, the wireless device may unnecessarily/mistakenly refrain from transmitting the positioning SRS, reducing efficiency/accuracy of a positioning procedure (e.g., multi-RTT procedure). In some other cases, by ignoring impact(s) of the movement/displacement of the NTN node/payload, the wireless device may mistakenly validate the TA for positioning SRS transmission in the RRC inactive/idle state, e.g., the wireless device may unnecessarily/mistakenly transmit the positioning SRS, increasing the consumed power of the wireless device.

Based on existing technologies, in an NTN scenario with the large cell/beam size (e.g., cell/beam radius of 200-3500 km), there may be an insignificant (or unclear) near-far effect of the RSRP of the DL-PL reference (e.g., DL-PL reference signal) across/through the cell/beam in the NTN scenario. Further, due to a large distance (e.g., 600 kms-36000 kms) between the wireless device and an NTN payload (e.g., a LEO/MEO/GEO satellite), the wireless device may have difficulties measuring the RSRP of the DL-PL accurately. Existing technologies for validating the TA for positioning SRS transmission in the RRC inactive/idle state (e.g., based on a change of the RSRP of the DL-PL reference compared to the RSRP threshold) may result in the wireless device mistakenly validating (or invalidating) the TA for the positioning SRS transmission in the RRC inactive/idle state.

Improvements in positioning SRS transmission (e.g., the SRS procedure for positioning procedure) in the RRC inactive/idle state may improve accuracy/efficiency of the positioning procedure and/or improve the consumed power of the wireless device.

According to example embodiments of the present disclosure, in an NTN scenario, for transmitting the positioning SRS in/during/for the RRC inactive/idle state/mode of the wireless device, the wireless device may maintain UL synchronization of a serving cell (or with the base station) during the RRC inactive/idle state. In an example embodiment, the wireless device may determine the one or more NTN configuration parameters being valid (e.g., not being invalidated) for the positioning SRS transmission in the RRC inactive/idle state. For example, based on the one or more non-terrestrial network (NTN) configuration parameters, the wireless device may determine whether the TA value for the positioning SRS transmission (e.g., in the RRC inactive/idle state) being valid or not. In some scenarios, the wireless device may perform the TA validation (procedure) for the positioning SRS transmission in the RRC inactive/idle state/mode based on the one or more non-terrestrial network (NTN) configuration parameters (e.g., whether the one or more NTN configuration parameters being valid or not). In an example embodiment, in response to determining the one or more NTN configuration parameters being valid, the wireless device may perform/transmit the positioning SRS transmission procedure. For example, the wireless device may determine a validity timer, of the one or more non-terrestrial network (NTN) configuration parameters, being running (e.g., not being expired).

In an example embodiment, in response to determining the one or more non-terrestrial network (NTN) configuration parameters not being valid (or being invalid), the wireless device may not perform the positioning SRS transmission procedure in/during the RRC inactive/idle state/mode. For example, the wireless device may determine a validity timer of the one or more non-terrestrial network (NTN) configuration parameters being expired.

In an example embodiment, the one or more configuration parameters may configure the wireless device with a first configuration parameter. In response to determining the first configuration parameter being indicated/configured (or being enabled or not being disabled or not being absent from the one or more configuration parameters), the wireless device may determine whether the TA validation procedure (e.g., for the positioning SRS transmission) is based on the one or more NTN configuration parameters or not. For example, based on the first configuration parameter being indicated/configured (or being enabled or not being disabled or not being absent from the one or more configuration parameters) and the one or more NTN configuration parameters being invalid (e.g., the validity timer being expired), the wireless device may not transmit the SRS for positioning (e.g., stop the positioning SRS transmission procedure and/or deactivate the SP positioning SRS resource(s)). For example, the wireless device may determine the time alignment timer (TAT), e.g., inactivePosSRS-TimeAlignmentTimer, is running. In some cases, the wireless device may determine the RSRP value of the DL-PL reference being changed (e.g., increased/decreased) less than the RSRP threshold. The one or more configuration parameters (e.g., the one or more positioning SRS configuration parameters and/or the one or more NTN configuration parameters) may indicate/configure the first configuration parameters.

In an example embodiment, in response to determining the first configuration parameter not being indicated/configured (or being disabled or being absent from the one or more configuration parameters), the wireless device may ignore validity of the one or more NTN configuration parameters for determining whether the TA value for the positioning SRS transmission is valid or not. In some cases, determining whether the TA value for the positioning SRS transmission is valid or not may be based on whether the time alignment timer (TAT), e.g., inactivePosSRS-TimeAlignment Timer, is running or not and/or whether the RSRP value of the DL-PL reference is changed (e.g., increased/decreased) more than the RSRP threshold or not.

In an example embodiment, the wireless device may transmit a UE-capability message to the base station. The UE capability message may indicate a capability of the wireless device for transmitting the SRS for positioning (in the RRC inactive/idle state/mode) when the wireless device is operating in an NTN scenario. In some cases, the UE capability message may indicate a capability of the wireless device for transmitting the SRS for positioning when the UL synchronization of a Serving Cell is lost (e.g., due to the expiry of a validity timer and/or invalidity of the one or more configuration parameters). In some other cases, the UE capability message may indicate a capability of the wireless device for transmitting the SRS for positioning when the UL synchronization of the Serving Cell is obtained/maintained (e.g., the validity timer is running).

In an example embodiment, based on the one or more NTN configuration parameters being invalid, the wireless device may not determine/derive the RSRP value of the DL-PL reference (e.g., for the TA validation of SRS for Positioning transmission in/during RRC_INACTIVE/IDLE state). For example, the wireless device may not expect receiving TAC MAC CE (e.g., for the inactivePosSRS-TimeAlignmentTimer), e.g., the wireless device may ignore the TAC MAC CE based on determining one or more NTN configuration parameters being invalid.

Example embodiments may allow the wireless device and the base station to stay UL synchronized (e.g., based on validity of the one or more NTN configuration parameters) for the positioning SRS transmission in/during the RRC inactive/idle state. Some example embodiments may improve the efficiency/accuracy of the SRS for positioning and/or reduce consumed power of the wireless device for the positioning SRS transmission.

In an example embodiment, in response to determining the one or more NTN configuration parameters being invalid (or not being valid), the wireless device may release the one or more positioning SRS configuration parameters (e.g., srs-PosRRC-InactiveConfig). In some scenarios, the wireless device may release the periodic (positioning) SRS resource(s) and/or the semi-persistent (positioning) SRS resource(s). For example, the wireless device may stop the inactivePosSRS-TimeAlignmentTimer.

In an example embodiment, in response to determining the one or more NTN configuration parameters being invalid (or not being valid) and the positioning SRS transmission procedure being ongoing during the RRC inactive/idle state, the wireless device may suspend the one or more positioning SRS configuration parameters. In some examples, the wireless device may suspend/deactivate the one or more positioning SRS configuration parameters for/during a wait (or suspension) window/duration/period. For example, the wait window may be for (re) acquiring an NTN-specific SIB or SIB1 (e.g., for validating the one or more NTN configuration parameters) by the wireless device. In response to suspending the one or more positioning SRS configuration parameters, the wireless device may stop transmitting (e.g., refrain from transmitting or not transmitting) the positioning SRS (e.g., performing the SRS procedure for the positioning procedure), e.g., during the wait window. For example, the wireless device may abort/cancel/deactivate the SRS procedure for the positioning procedure, e.g., during the wait window. In response to (re) acquiring the NTN-specific SIB and/or SIB1 (e.g., starting the validity timer and/or validating the one or more NTN configuration parameters), the wireless device may start/activate (or revive) the positioning SRS transmission procedure.

In an example embodiment, the one or more configuration parameters may indicate/comprise a second configuration parameter. In response to determining a second configuration parameter being indicated/configured (or being enabled or not being disabled or not being absent from the one or more configuration parameters), the wireless device may abort/cancel/stop/deactivate the SRS procedure for the positioning procedure (e.g., not transmitting the at least one positioning SRS) based on the one or more NTN configuration parameters being invalid. For example, based on the (re) acquitting the NTN-specific SIB and/or SIB1 (e.g., validating the one or more NTN configuration parameters), the wireless device may start the SRS procedure for the positioning procedure. The one or more configuration parameters (e.g., the one or more positioning SRS configuration parameters and/or the one or more NTN configuration parameters) may indicate/configure the first configuration parameters.

Example embodiments may allow the wireless device to (automatically) abort/cancel/stop/deactivate the SRS procedure for positioning procedure (e.g., during the RRC inactive/idle state) based on the expiry of the validity timer of the one or more NTN configuration parameters. Example embodiments may allow the wireless device to (automatically) start/revive/activate the aborted/canceled/stopped/deactivated the SRS procedure for positioning procedure (e.g., during the RRC inactive/idle state) based on the (re) acquitting the NTN-specific SIB and/or SIB1 (e.g., validating the one or more NTN configuration parameters). Example embodiments may enhance the performance of the SRS procedure for the positioning procedure and/or reduce the power consumption of the wireless device.

In an example embodiment, the UE capability message may indicate a capability of the wireless device for maintaining (e.g., avoiding/bypassing releasing/suspending/deactivating) the at least one positioning SRS resource despite the UL synchronization of a Serving Cell is lost (e.g., due to the expiry of a validity timer and/or invalidity of the one or more configuration parameters). In some other cases, the UE capability message may indicate a capability of the wireless device for performing (e.g., avoiding/bypassing stopping/aborting/canceling) the SRS procedure for the positioning procedure in response to the UL synchronization of the Serving cell of the one or more Serving Cells being lost. For example, the wireless device may avoid/bypass stop/abort/cancel the SRS procedure for the positioning procedure (or avoid/bypass release/suspend/deactivate the at least one positioning SRS resource) in response to the UL synchronization of the Serving cell of the one or more Serving Cells being lost.

In an example embodiment, the wireless device may, in response to receiving the one or more NTN configuration parameters (e.g., based on (re) acquiring the NTN-specific SIB and/or SIB1, determine a second RSRP value of the DL-PL reference. The wireless device may, for example, store the RSRP (value) of the DL-PL reference (or update the stored RSRP value of the DL-PL reference) with the second RSRP value of the DL-PL reference. For example, the wireless device may (re) acquire the NTN-specific SIB and/or the SIB1 for receiving the one or more NTN configuration parameters. In some examples, the wireless device may determine the SRS procedure for the positioning procedure being ongoing in/during the RRC inactive/idle state/mode.

In an example embodiment, the wireless device may, in response to determining relative position (or location information) of the NTN node (or the reference location) to the position (or location information) of the wireless device being changed (or fluctuated or varied or increased or decreased), determine the second RSRP value of the DL-PL reference and/or store the RSRP (value) of the DL-PL reference (or update the stored RSRP value of the DL-PL reference) with the second RSRP value of the DL-PL reference. In some examples, based on the one or more NTN configuration parameters (e.g., (re) acquiring the NTN-specific SIB or SIB1), the wireless device may determine the relative position (or location information) of the NTN node (or the reference location) to the position (or location information) of the wireless device being changed. In some cases, to determine relative position (or location information) of the NTN node (or the reference location) to the position (or location information) of the wireless device being changed the wireless device may determine at least one attribute of the service link (among/of the one or more attributes of the service link) being changed. For example, the wireless device may determine the length of the service link (e.g., distance between the wireless device and the NTN node or the reference location) being changed and/or the elevation angle of the service link being change and/or the propagation delay of the service link being changed. Example embodiments may improve efficiency of the positioning procedure in an NTN scenario, e.g., by measuring/maintaining/storing the second RSRP of the DL-PL reference.

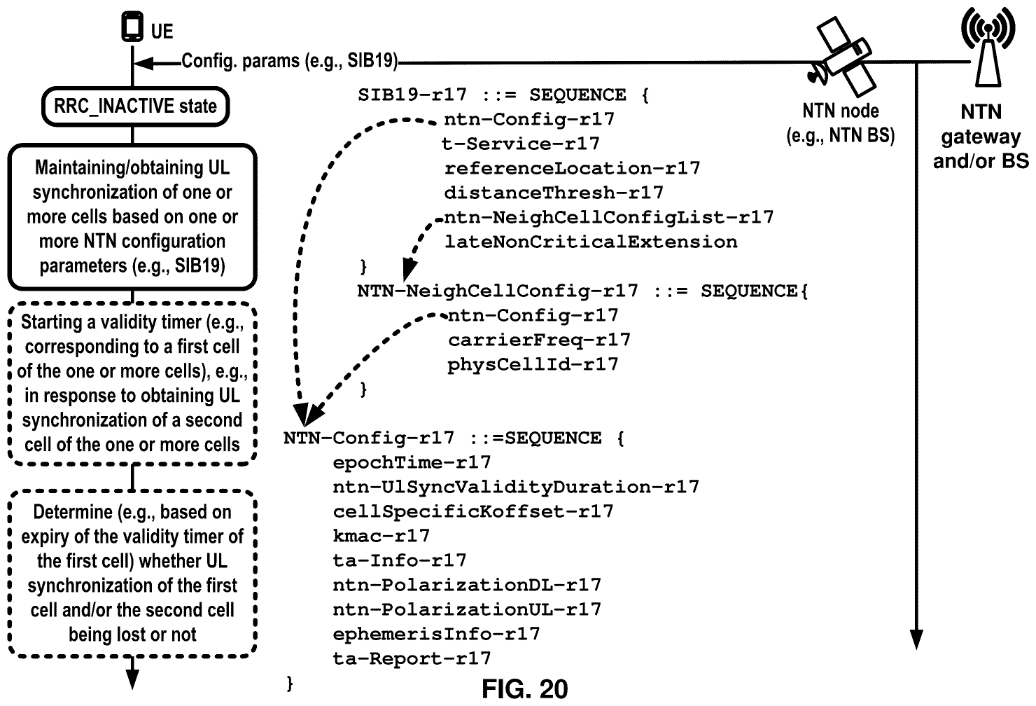

FIG. 20 shows an example embodiment of a procedure for uplink/downlink transmission in wireless communications systems per an aspect of the present disclosure. In some scenarios, FIG. 20 may show an example embodiment of a procedure for determining transmission occasion of an UL signal (e.g., at a wireless device) and/or a reception occasion of the UL signal (e.g., at a base station). For example, FIG. 20 may illustrate an example of an uplink signal transmission (e.g., PUSCH/PUCCH/PRACH/SRS) at the wireless device in an RRC connected state/mode (e.g., an RRC_CONNECTED state) and/or in an RRC non-connected state/mode (e.g., an RRC_INACTIVE/IDLE state or an RRC_IDLE state).

The wireless device may, for example, communicate with the base station via a non-terrestrial network (NTN), e.g., the wireless device and the base station may operate in the NTN and/or the base station may be an NTN base station and/or a cell (e.g., a Serving Cell of one or more Serving Cells) may be part of the NTN. For example, the cell may be a Serving Cell or a non-Serving Cell.

As shown in FIG. 20, the wireless device may, from the base station and at time TO, receive the one or more configuration parameters (e.g., the one or more RRC configuration parameters). The one or more configuration parameters may, for example, comprise one or more serving cell (e.g., the one or more Serving Cells or the one or more cells) configuration parameters (e.g., ServingCellConfigCommon, ServingCellConfigCommonSIB, and/or ServingCellConfig) for configuring one or more cells (e.g., the one or more Serving Cells).

For example, the one or more cells may comprise a master (or primary) cell group (MSG) and/or a secondary cell group (SCG). In some cases, a cell of the one or more cells may be a primary secondary cell (PSCell), or a primary cell (PCell), or a secondary cell (SCell), or a special cell (SpCell). In some other cases, a cell of the one or more cells may belong to a first cell group corresponding to a primary TAG (pTAG) or a second cell group corresponding to a secondary TAG (sTAG). For example, the one or more configuration parameters may configure the wireless device for multi-cell communication and/or carrier aggregation.

As shown in FIG. 20, the one or more configuration parameters may comprise the one or more NTN configuration parameters. For example, the wireless device may receive the one or more NTN configuration parameters by acquiring SIB1 and/or the NTN-specific SIB (e.g., SIB19).

In some cases, as shown in FIG. 20, the one the one or more NTN configuration parameters may comprise a plurality of NTN-specific configuration parameters (e.g., ntn-Config), e.g., one or more NTN-specific configuration parameters. For example, the one the one or more NTN configuration parameters may comprise the one or more ephemeris parameters (e.g., the satellite ephemeris data and/or at least one satellite ephemeris data/information), and/or the one or more common delay/TA parameters (e.g., at least one common TA/delay parameter) and/or a reference location (e.g., referenceLocation) and/or antenna polarization mode(s) (e.g., vertical horizontal, right-hand circular, or left-hand circular) of at least one NTN node/payload. The base station may communicate with the wireless device via the at least one NTN node/payload (e.g., via at least one service link).

As shown in FIG. 20, a first NTN-specific configuration parameters of the plurality of the NTN-specific configuration parameters (or the one or more NTN configuration parameters) may correspond to a first Serving Cell of the one or more Serving Cells (e.g., NTN-Config-r17 IE of the NTN-specific SIB). For example, the one or more NTN configuration parameters may comprise one or more second NTN-specific configuration parameters corresponding to one or more NTN neighbor cells (e.g., NTN-Config-r17 IE of ntn-NeighCellConfigList IE of the NTN-specific SIB). For example, an NTN neighbor cell of the one or more NTN neighbor cells may be one of the one or more Serving Cells. In another example, an NTN neighbor cell of the one or more NTN neighbor cells may not be one of the one or more Serving Cells (e.g., may be a non-Serving Cell). In some examples, as shown in FIG. 20, an NTN neighbor cell of the one or more NTN neighbor cells may correspond to a physical cell ID (e.g., PhysCellld) and/or a carrier frequency.

In some examples, a cell of the one or more cells may be the (first) Serving Cell or a cell of the one or more NTN neighbor cells. For example, the cell may comprise one or more NTN nodes and/or one or more service links (e.g., for communicating with the wireless device). For example, the cell (e.g., the Serving Cell) may comprise one or more second cells (e.g., each cell of the one or more second cells may correspond to each of one or more service links or the one or more NTN nodes).

For example, an NTN-specific configuration parameters of the plurality of the NTN-specific configuration parameters (e.g., the first NTN-specific configuration parameters or a second NTN-specific configuration parameters of the one or more second NTN-specific configuration parameters) may comprise one or more corresponding ephemeris parameters (e.g., corresponding satellite ephemeris data, e.g., ephemerisinfo), and/or the one or more corresponding common delay/TA parameters (e.g., ta-Info) and/or one or more corresponding antenna polarization mode(s) (e.g., vertical horizontal, right-hand circular, or left-hand circular) for UL/DL communications on a corresponding service link (or a corresponding Serving Cell).

In some cases, a Serving Cell corresponding to an NTN-specific configuration parameters of the plurality of the NTN-specific configuration parameters may comprise a single NTN node/payload. The one or more corresponding ephemeris parameters (e.g., corresponding satellite ephemeris data, e.g., ephemerisinfo), and/or the one or more corresponding common delay/TA parameters (e.g., ta-Info) and/or the one or more corresponding antenna polarization mode(s) (e.g., vertical horizontal, right-hand circular, or left-hand circular) may correspond to a service link corresponding to the single NTN node.

In some other cases, a Serving Cell corresponding to an NTN-specific configuration parameters of the plurality of the NTN-specific configuration parameters may comprise one or more NTN nodes/payloads. The one or more corresponding ephemeris parameters (e.g., corresponding satellite ephemeris data, e.g., ephemerisInfo), and/or the one or more corresponding common delay/TA parameters (e.g., ta-Info) and/or the one or more corresponding antenna polarization mode(s) (e.g., vertical horizontal, right-hand circular, or left-hand circular) may, for example, correspond to one or more service links corresponding to the one or more NTN nodes/payloads.

For example, the wireless device may determine at least one common TA/delay using/based on the one or more common TA parameters of the plurality of NTN-specific configuration parameters. Each common TA/delay of the at least one common TA/delay may correspond to a TAG and/or a Serving Cell of the one or more Serving Cells and/or an NTN node of the one or more NTN nodes. The at least one common TA/delay may correspond to one or more TAGS (e.g., a primary TAG or a secondary TAG). A common TA/delay of the at least one common TA/delay may correspond to a Serving Cell (e.g., the one or more Serving Cells) and/or a non-Serving Cell (e.g., of one or more non-Serving Cells). In some examples, a common TA/delay of at least one common TA/delay may correspond to a feeder link of a Serving Cell or a feeder link of a non-Serving Cell. The wireless device may determine a common TA/delay of at least one common TA/delay based on one or more common TA parameters of a corresponding NTN-specific configuration parameters of the plurality of the NTN-specific configuration parameters.

For example, the wireless device may determine at least one service link delay using/based on the one or more ephemeris parameters of the plurality of NTN-specific configuration parameters. Each service link delay of the at least one service link delay may correspond to a TAG and/or a Serving Cell of the one or more Serving Cells and/or an NTN node of the one or more NTN nodes. The at least one service link delay may correspond to one or more TAGS (e.g., a primary TAG or a secondary TAG). A common TA/delay of the at least one service link delay may correspond to a Serving Cell (e.g., the one or more Serving Cells) and/or a non-Serving Cell (e.g., of one or more non-Serving Cells). In some examples, a service link delay of at least one service link delay may correspond to a service link of a Serving Cell or a service link of a non-Serving Cell. The wireless device may determine a service link delay of at least one service link delay based on one or more ephemeris parameters of a corresponding NTN-specific configuration parameters of the plurality of the NTN-specific configuration parameters.

For example, the wireless device may determine at least one open-loop TA (e.g., each open-loop TA of the at least one open-loop TA may correspond to a TAG or a Serving Cell of the one or more Serving Cells and/or an NTN node of the one or more NTN nodes) using/based on the plurality of NTN-specific configuration parameters. The at least one open-loop TA may correspond to one or more TAGS (e.g., a primary TAG or a secondary TAG). An open-loop TA of the at least one open-loop TA may correspond to a Serving Cell (e.g., the one or more Serving Cells) and/or a non-Serving Cell (e.g., of one or more non-Serving Cells). In some examples, an open-loop TA of at least one open-loop TA may correspond to an NTN node of the at least one NTN node. The wireless device may determine an open-loop TA of at least one open-loop TA based on a corresponding common TA/delay and/or a corresponding service link delay. For example, the wireless device may, corresponding to an open-loop TA of at least one open-loop TA, determine a corresponding UE-gNB RTT.

For example, the wireless device may determine/maintain/calculate at least one TA value (e.g., each TA value of the at least one TA value may correspond to a TAG or a Serving Cell of the one or more Serving Cells) using/based on the at least one open-loop TA and/or one or more TAC MAC CEs. The one or more TAC MAC CEs may be received, by the wireless device, from the one or more Serving Cells or the Serving Cell or the at least one Serving Cell. For example, a first (or each) TAC MAC CE of the one or more TAC MAC CEs may comprise a first TA fix/correction/update (or a first TA value) and at least one first index/ID. The at least one first index/ID may be one of the following: a first TAG ID, and/or a first cell ID, and/or a first beam ID, and/or a first NTN node ID/index, and/or the like. Based on receiving the first TAC MAC CE of the one or more TAC MAC CEs, the wireless device may calculate/maintain/update/determine a TA value of the at least one TA value corresponding to the indicated the at least one first TAG ID. The at least one TA value may correspond to one or more TAGS (e.g., a primary TAG or a secondary TAG). A TA value of the at least one TA value may correspond to a Serving Cell (e.g., the one or more Serving Cells) and/or a non-Serving Cell (e.g., of one or more non-Serving Cells). In some examples, a TA value of at least one TA value may correspond to an NTN node of the at least one NTN node.

For example, the wireless device may determine at least one UE-gNB RTT (e.g., each UE-gNB RTT of the at least one UE-gNB RTT may correspond to a TAG or a Serving Cell of the one or more Serving Cells) using/based on the plurality of NTN-specific configuration parameters. The at least one UE-gNB RTT may correspond to one or more TAGs (e.g., a primary TAG or a secondary TAG). A UE-gNB RTT of the at least one UE-gNB RTT may correspond to a Serving Cell (e.g., the one or more Serving Cells) and/or a non-Serving Cell (e.g., of one or more non-Serving Cells). In some examples, a UE-gNB RTT of at least one UE-gNB RTT may correspond to an NTN node of the at least one NTN node. The wireless device may determine a UE-gNB RTT of at least one UE-gNB RTT based on a corresponding open-loop TA (a corresponding TA value) and/or a corresponding MAC-layer timing offset (e.g., K-Mac). In some examples, the wireless device may determine a UE-gNB RTT of the at least one UE-gNB RTT based on (e.g., by summing) the corresponding open-loop TA value (or a corresponding TA value) of the at least one open-loop TA value (e.g., in ms/slots/symbols/subframes) and a corresponding MAC-layer timing offset (e.g., K-Mac) (e.g., in ms/slots/symbols/subframes).

In an example, as shown in FIG. 20, each NTN-specific configuration parameter of the plurality of NTN-specific configuration parameters may comprise an MAC-layer timing offset (e.g., K-Mac or Kmac), e.g., corresponding to a feeder link and/or an NTN node and/or a Serving Cell and/or a non-Serving Cell, or the like. For example, the one or more NTN configuration parameters may indicate one or more MAC-layer timing offsets corresponding to the one or more feeder links and/or the one or more Serving Cells. For example, the one or more NTN configuration parameters may indicate a first MAC-layer timing offset of the one or more MAC-layer timing offsets corresponding to the primary TAG. In some examples, the one or more NTN configuration parameters may indicate a second MAC-layer timing offset of the one or more MAC-layer timing offsets corresponding to the secondary TAG.

For example, the one or more NTN configuration parameters may indicate a first MAC-layer timing offset of the one or more MAC-layer timing offsets corresponding to the primary TAG or a first cell group (e.g., the MSG). In some examples, the one or more NTN configuration parameters may indicate a second MAC-layer timing offset of the one or more MAC-layer timing offsets corresponding to the secondary TAG and/or a second cell group (e.g., the SCG). In an example, each NTN-specific configuration parameter of the plurality of NTN-specific configuration parameters may comprise a cell-specific timing offset (e.g., CellSpecific_K_offset), e.g., corresponding to a Serving Cell or a TAG or a service link of the Serving Cell or an NTN node of the Serving Cell, or the like. For example, the one or more NTN configuration parameters may indicate one or more (or at least one) cell-specific timing offsets corresponding to the one or more service links and/or one or more NTN nodes/payloads and/or the one or more cells (e.g., the one or more Serving Cells).

For example, the one or more NTN configuration parameters may indicate a first cell-specific timing offset of the one or more cell-specific timing offsets corresponding to the primary TAG or a first cell group (e.g., the MSG). In some examples, the one or more NTN configuration parameters may indicate a second cell-specific timing offset of the one or more cell-specific timing offsets corresponding to the secondary TAG and/or a second cell group (e.g., the SCG).

For example, the wireless device may use the one or more NTN configuration parameters to determine/measure/calculate/maintain/update/estimate the at least one open-loop TA value of the wireless device and/or the at least one common TA/delay and/or the at least one service link delay and/or the at least one UE-gNB RTT and/or at least one TA value. In some cases, each TA value of the at least one TA value (and/or each open-loop TA value of the at least one open-loop TA value and/or each cell-specific timing offset of the at least one cell-specific timing offset and/or each MAC-layer timing offset of the at least one MAC-layer timing offset) may correspond to a Serving Cell and/or a service link and/or a TAG and/or an NTN node and/or a feeder link, and/or the like.

In some other cases, the wireless device may, based on the one or more NTN configuration parameters, determine/measure/maintain one or more NTN-specific parameters/values. In some implementations, the one or more NTN-specific parameters/values (and/or the one or more NTN configuration parameters) may comprise a type of NTN payload (e.g., a GEO satellite, a MEO satellite, a LEO satellite, and/or a HAPS) corresponding to the at least one Serving Cell. In some implementations, the one or more NTN-specific parameters/values (and/or the one or more NTN configuration parameters) may comprise a type of the cell/beam (e.g., an Earth-fixed cell/beam or an Earth-moving cell/beam) corresponding to the at least one Serving Cell or one or more non-Serving Cells. In some cases, the wireless device may determine at least one location information (or position) of the at least one NTN node/payload based on the one or more NTN configuration parameters and/or the one or more NTN-specific parameters/values. For example, the wireless device may use the one or more NTN configuration parameters (e.g., the one or more ephemeris parameters and/or the one or more common delay/TA parameters and/or referenceLocation) to calculate/determine/maintain/update the at least one location information of the at least one NTN node/payload (e.g., satellite).

As shown in FIG. 20, the wireless device may maintain/obtain UL synchronization of the one or more cells in response to acquiring/reacquiring the NTN-specific SIB and/or SIB1 (e.g., receiving the one or more NTN configuration parameters). For example, the wireless device may determine whether UL synchronization of a first cell of the one or more cells and/or a second cell of the one or more cells being lost or not.

In some cases, in response to obtaining the UL synchronization of the first cell of the one or more cells (e.g., based on receiving the one or more NTN configuration parameters or receiving the one or more NTN configuration parameters corresponding to the first cell), the wireless device may determine the UL synchronization of the second cell of the one or more cells being obtained/maintained. For example, in response to losing the UL synchronization of the first cell of the one or more cells, the wireless device may determine the UL synchronization of the second cell of the one or more cells being lost. For example, the first cell may correspond to the primary TAG. In some cases, the first cell may be the cell that the wireless device is receiving the NTN-specific SIB and/or SIB1. In some cases, the first cell may be a PCell and/or be a cell of the MSG. For example, the wireless device may determine the UL synchronization of the second cell being lost based on a validity timer of the first cell being expired. For example, the wireless device may determine the UL synchronization of the second cell being obtained based on the validity timer of the first cell being running.

In some examples, the wireless device may obtain/maintain UL synchronization of the second cell independently from the UL synchronization of the first cell. For example, the wireless device may avoid/bypass determining the UL synchronization of the second cell being lost in response to the UL synchronization of the first cell being lost. In another example, the wireless device may not determine the UL synchronization of the second cell being obtained in response to the UL synchronization of the first cell being obtained. For example, the wireless device may determine the UL synchronization of the second cell being lost based on a validity timer of the second cell being expired. The wireless device may, for example, determine the UL synchronization of the second cell being obtained based on the validity timer of the second cell being running.

In an example, an NTN-specific configuration parameters of the plurality of the NTN-specific configuration parameters may comprise a duration ntn-UISyncValidityDuration and/or an epoch Time. In some cases, the wireless device may start/restart at least one validity timer/window/period/duration (e.g., with the duration UlSyncValidityDuration) based on acquiring/reacquiring the NTN-specific SIB and/or SIB1 (e.g., receiving the one or more NTN configuration parameters). A validity timer (e.g., T430 timer) of the at least one validity timer may correspond to a cell (e.g., the Serving Cell or an NTN neighbor cell) of the one or more cells and/or a TAG (e.g., the primary TAG or the secondary TAG) and/or a service link of the at least one service link and/or an NTN node or the at least one NTN node and/or a cell group (e.g., the PCG or SCG).

In an embodiment, e.g., in the RRC inactive/idle state, the wireless device may start/restart a (each) validity timer (e.g., corresponding to a cell of the one or more cells, e.g., a Serving Cell of the one or more Serving Cells, and/or a TAG and/or a service link of the at least one service link and/or a cell group and/or an NTN node of the at least one NTN node) in response to receiving the one or more NTN configuration parameters, e.g., an NTN-specific configuration parameters corresponding to the cell (e.g., the Serving Cell) and/or the TAG and/or the service link of the at least one service link and/or the cell group and/or the NTN node of the at least one NTN node. For example, the wireless device may start/restart the validity timer (e.g., of the Serving Cell) with a duration ntn-UlSyncValidityDuration of the corresponding NTN-specific configuration parameters from a subframe indicated by an epoch Time of the corresponding NTN-specific configuration parameters. In some scenarios, the wireless device may determine the epoch Time based on a subframe that the corresponding NTN-specific configuration parameters (and/or the NTN-specific SIB or SIB1) is received/acquired and/or a system information (SI) modification window and/or an SFN. The wireless device may require (or attempt to re-acquire) the NTN-specific SIB (e.g., SIB19) and/or SIB1 before expiry of a validity timer of the at least one validity timer (e.g., before an end of the duration indicated by ntn-UlSyncValidityDuration of the NTN-specific configuration parameters of the corresponding Serving Cell).

In an example, in response to a validity timer of the at least one validity timer (e.g., corresponding to a Serving Cell of the one or more Serving Cells and/or a non-Serving Cell and/or the TAG and/or the service link of the at least one service link and/or the cell group and/or the NTN node of the at least one NTN node) being expired, the wireless device may determine UL synchronization of each Serving Cell of the one or more Serving Cells being lost (e.g., the wireless device may stop the at least one validity timer, if running). For example, the wireless device (re)-acquire the NTN-specific SIB and/or SIB1. For example, based on the validity timer corresponding to a cell of the one or more cells (e.g., a PCell or a cell in the pTAG or a cell in MCG or a PsCell) being expired, the wireless device may determine UL synchronization of each Serving Cell of the one or more Serving Cells being lost (e.g., the wireless device may stop the at least one validity timer, if running).

In an example, in response to a validity timer of the at least one validity timer (e.g., corresponding to a Serving Cell of the one or more Serving Cells) being expired, the wireless device may determine UL synchronization of the Serving Cell of the one or more Serving Cells being lost. For example, the wireless device (re)-acquire the NTN-specific SIB and/or SIB1.

In some other cases, corresponding to each open-loop TA value of the at least one TA value (or a TAG or a Serving Cell of the one or more Service Cells), the wireless device may run/maintain/start/restart a validity timer/window/duration. In response to a validity timer corresponding to a TAG or a Serving Cell being expired, the wireless device may determine UL synchronization of the corresponding Serving Cell (or each Serving Cell of the one or more Serving Cells or a corresponding non-Serving Cell) being lost. For example, the wireless device (re)-acquires the NTN-specific SIB and/or SIB1 and/or corresponding NTN-specific configuration parameters.

In some implementations, the wireless device may transmit a UE-capability message to the base station. The UE capability message may indicate a capability of the wireless device for (simultaneously) maintaining/estimating/updating/measuring/calculating the at least one open-loop TA value of the wireless device (and/or the at least one UE-gNB RTT). In other implementations, the UE-capability message may indicate a capability of the wireless device for maintaining (e.g., running, starting, restarting) the at least one validity timer corresponding to the one or more Serving Cells (e.g., comprising the Serving Cell and the one or more NTN neighbor cells). In other implementations, the UE-capability message may indicate a capability of the wireless device for maintaining (e.g., running, starting, restarting) a single validity timer corresponding to all Serving Cells (e.g., comprising the Serving Cell and the one or more NTN neighbor cells).

For example, the UE-capability message may indicate a capability of the wireless device for simultaneously communicating to the base station via the at least one NTN node/payload and/or at least one service link (and/or at least one feeder link). For example, an NTN node of the at least one NTN node may correspond to a Serving Cell. In some other cases, an NTN node of the at least one NTN node may correspond to a non-Serving Cell. In some examples, the at least one NTN node may correspond to different Serving Cells.

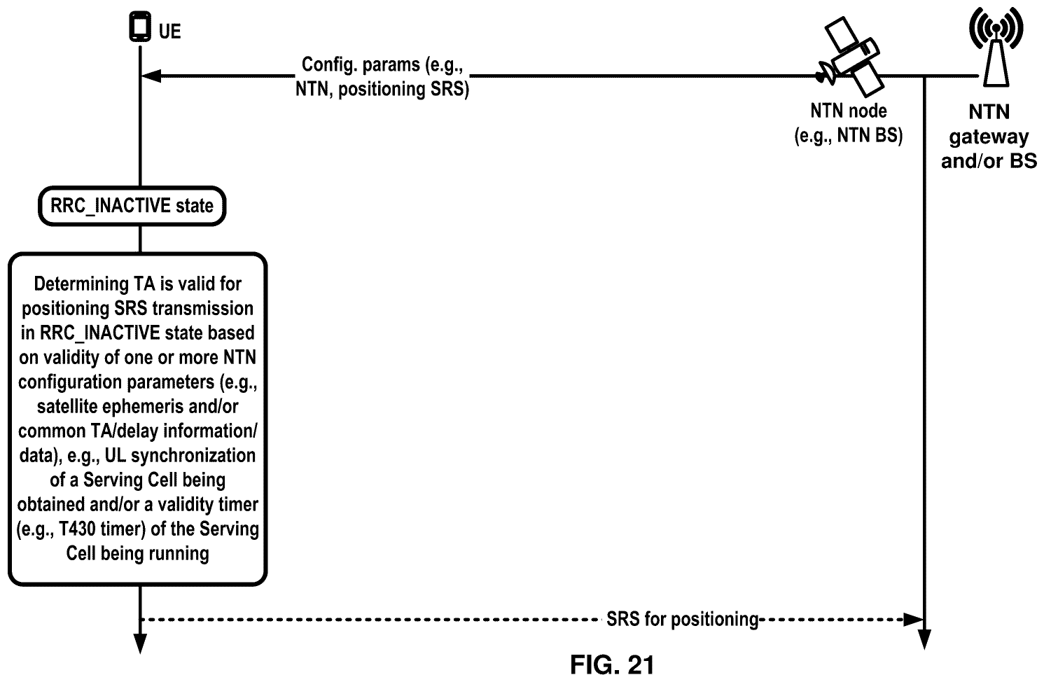

FIG. 21 shows an example embodiment of an SRS procedure for a positioning procedure in wireless communications systems per an aspect of the present disclosure. In some examples, FIG. 21 may illustrate an example of a positioning SRS transmission procedure (e.g., performing the SRS procedure for the positioning procedure) in an RRC inactive/idle (RRC_INACTIVE/IDLE) state/mode (e.g., without the wireless device transitioning/switching to an RRC_CONNECTED state/mode). In some aspects, FIG. 21 may depict an implementation of a method (or a process) for the positioning procedure at a base station (e.g., and/or a location management function and/or an LTE positioning protocol) and/or at the wireless device.

In some examples, the SRS procedure for the positioning procedure may be used by the wireless device for transmission of a positioning SRS (e.g., a positioning SRS resource) during/in the RRC inactive/idle state. In an example, the positioning procedure may be for validating/determining a location information/position of the wireless device (e.g., Network verified UE location) at an NTN node/payload (e.g., a satellite) and/or at the base station (or core network). In some examples, the positioning procedure may be used to estimate/determine velocity (and/or direction of movement) of the wireless device. For example, based on the positioning procedure, a location management function (LMF) and/or an LTE positioning protocol (LPP) may validate/determine the location information/position of the wireless device.

In some aspects, the positioning procedure (e.g., a UE-based version, UE-assisted/LMF-based version, or an NG-RAN node assisted version) may be based on at least one of the following: an enhanced-cell identification (E-CID) method/procedure, a downlink-time difference of arrival (DL-TDOA) method/procedure, downlink-angle of departure (DL-AoD) method/procedure, Multiple round-trip time (Multi-RTT) method/procedure, an uplink-time difference of arrival (UL-TDOA) method/procedure, and/or an uplink-angle of arrival (UL-AoA) method/procedure. In some other aspects, the positioning procedure may be based on an AI/ML-based positioning procedure. The positioning procedure may be based on a UE Positioning function of NG-RAN which provides the mechanisms to support or assist the calculation of the geographical position of the wireless device. In some examples, position knowledge of the wireless device may be used, for example, in support of Radio Resource Management functions, location-based services for operators, subscribers, and third-party service providers.

In some examples of the present disclosure, the SRS procedure for the positioning procedure may be based on a small data transmission (SDT) procedure in the RRC inactive/idle state. For example, based on the SDT procedure being ongoing, the SRS procedure for the positioning procedure may be ongoing/performed. The SRS procedure for the positioning procedure may not be for transmission of UL data/packets.

The base station may communicate with the wireless device via/using one or more cells (e.g., one or more Serving Cells/serving cells). In some examples, the wireless device may be in an RRC_IDLE (or an RRC idle) state/mode and/or an RRC_INACTIVE/IDLE (or an RRC inactive/idle) state/mode, or an RRC_CONNECTED (or an RRC connected) state/mode. In some examples, the wireless device may be in a RRC non-connected state/mode (e.g., the RRC inactive/idle state/mode or the RRC idle state/mode). The wireless device may, in some examples, communicate with the base station via a non-terrestrial network (NTN), e.g., the wireless device and the base station may operate in the NTN and/or the base station may be an NTN base station and/or a cell (e.g., a Serving Cell of the one or more Serving Cells) may be part of the NTN. For example, the cell may be the Serving Cell or a non-Serving Cell.

As depicted in FIG. 21, the wireless device may, from the base station, receive the one or more configuration parameters (e.g., the one or more RRC configuration parameters). The one or more configuration parameters may, for example, comprise one or more serving cell (e.g., the one or more Serving Cells or the one or more cells) configuration parameters (e.g., ServingCellConfigCommon, ServingCellConfigCommonSIB, and/or ServingCellConfig) for configuring the one or more cells (e.g., the one or more Serving Cells and/or one or more non-Serving Cells). For example, the one or more cells may comprise a master (or primary) cell group (MSG) and/or a secondary cell group (SCG). In some cases, a cell of the one or more cells may be a primary secondary cell (PSCell), or a primary cell (PCell), or a secondary cell (SCell), or a special cell (SpCell). In some other cases, a cell of the one or more cells may belong to a first cell group corresponding to a primary TAG (pTAG) or a second cell group corresponding to a secondary TAG (sTAG). In some examples, the one or more configuration parameters may configure the wireless device for multi-cell communication and/or carrier aggregation.

As shown in FIG. 21, the one or more configuration parameters may comprise the one or more NTN configuration parameters. In some examples, the wireless device may receive the one or more NTN configuration parameters by acquiring SIB1 and/or the NTN-specific SIB (e.g., SIB19).

The one or more configuration parameters may comprise one or more positioning SRS configuration parameters. In some implementations, the base station may configure the one or more positioning SRS configuration parameters (e.g., srs-PosRRC-InactiveConfig) via an RRC release message (e.g., RRCRelease message). In some examples, the wireless device may, in response to receiving the RRC release message from the base station, release an RRC connection or the suspension of the RRC connection. In some cases, the wireless device may transit/switch from the RRC connected (e.g., RRC_CONNECTED) state to the RRC inactive/idle or non-connected (e.g., RRC_INACTIVE/IDLE) state.

The one or more positioning SRS configuration parameters (e.g., via SRS-PosConfig 1E in the srs-PosRRC-InactiveConfig 1E) may comprise/indicate at least one positioning SRS resource (e.g., configuration(s) corresponding to/for Positioning SRS for RRC_INACTIVE/IDLE). In some examples, the one or more positioning SRS configuration parameters may indicate/configure a plurality of positioning SRS resources. The plurality of positioning SRS resources may, in some examples, comprise a list (or a plurality) of SRS-PosResources and/or a list (or a plurality) of SRSPosResourceSets. Each resource set of the plurality of positioning SRS resources (e.g., the list of the SRS-PosResources and/or the list of SRSPosResourceSets) may indicate/configure a set of positioning SRS resource(s). For example, the set of positioning SRS resource(s) may comprise the at least one positioning SRS resource. The at least one positioning SRS resource may not be for transmission of UL data.

In some cases, a positioning SRS resource of the at least one positioning SRS resource may be a positioning periodic SRS resource (e.g., periodic SRS resource(s) and/or periodic positioning SRS resource(s) and/or periodic SRS resource(s) for positioning). In some other cases, a positioning SRS resource of the at least one positioning SRS resource may be a positioning semi-persistent (SP) SRS resource (e.g., semi-persistent SRS resource(s) and/or semi-persistent positioning SRS resource(s) and/or semi-persistent SRS resource(s) for positioning).

In some examples, the at least one positioning SRS resource may comprise one or more resource sets of Semi-Persistent Positioning SRS. In some cases, the at least one positioning SRS resource (e.g., the one or more resource sets of Semi-Persistent Positioning SRS) may correspond to a cell (e.g., the Serving Cell of the one or more Serving Cells). In some other cases, the at least one positioning SRS resource (e.g., the one or more resource sets of Semi-Persistent Positioning SRS) may correspond to one or more Serving Cells (e.g., comprising the Serving Cell) of the one or more Serving Cells.

In some cases, an (or each) NTN-specific configuration parameters of the plurality of the NTN-specific configuration parameters may comprise at least one (antenna) polarization mode/information. In some examples, the at least one antenna polarization mode of an NTN-specific configuration parameters may comprise at least one DL antenna polarization mode (e.g., ntn-PolarizationDL) indicating one or more polarization information/modes for DL transmissions (e.g., PDCCH/PDSCH/SSB transmissions) on the corresponding service link (e.g., the service link of the Serving Cell corresponding to the NTN-specific configuration parameters). In another example, the at least one antenna polarization mode may comprise at least UL antenna polarization modes/information (e.g., ntn-PolarizationUL) indicating one or more polarization information/modes for UL transmissions (e.g., PUSCH/PUCCH/PRACH/SRS transmissions) on the service link (e.g., the service link of the Serving Cell corresponding to the NTN-specific configuration parameters).

In some examples, an antenna polarization mode of an NTN node/payload of a Serving Cell (or a non-Serving Cell) may be based on the at least one antenna polarization mode of an NTN-specific configuration parameters. In some examples, the antenna polarization mode of an NTN node/payload may correspond to a DL antenna polarization mode on the corresponding service link (e.g., for DL transmission) or an UL antenna polarization mode on the corresponding service link (e.g., for UL transmission). In some cases, the at least UL antenna polarization mode of the NTN node/payload of a Serving Cell (or a non-Serving Cell) may be the same as the at least DL antenna polarization mode of the NTN node/payload of a Serving Cell (or a non-Serving Cell).

In some implementations the at least one positioning SRS resource (e.g., of a cell, e.g., a Serving Cell or a non-Serving Cell) may correspond to at least one antenna polarization mode (e.g., vertical horizontal, right-hand circular, or left-hand circular) of the wireless device and/or of an NTN node/payload (e.g., corresponding to the cell). For example, a positioning SRS resource of the at least one positioning SRS resource may correspond to the at least one antenna polarization mode (e.g., vertical horizontal, right-hand circular, or left-hand circular) of the wireless device and/or of the NTN node/payload (e.g., corresponding to the cell). A positioning SRS resource of the at least one positioning SRS resource may comprise an indication indicating the at least one antenna polarization mode (e.g., vertical horizontal, right-hand circular, or left-hand circular).

In some examples, the wireless device may refrain from transmitting (e.g., may not be expected to transmit) multiple positioning SRS resources with different spatial relations in the same OFDM symbol and/or with different antenna polarization mode (e.g., in the same OFDM symbol or slot or subframe or a time duration).

In some examples, the one or more positioning SRS configuration parameters may configure a positioning SRS resource (e.g., SRS-PosResource) with a spatial relation information (e.g., spatialRelationinfoPos). In some examples, the spatial relation information may contain/comprise an ID of a reference RS and/or the at least one polarization mode. The reference RS may be an SRS resource (e.g., SRS-Resource or SRS-PosResource) (e.g., corresponding to the Serving Cell or a service link of the Serving Cell), CSI-RS (e.g., corresponding to the Serving Cell or a service link of the Serving Cell), SS/PBCH block (e.g., corresponding to the Serving Cell or a service link of the Serving Cell), an/or a DL PRS (e.g., corresponding to the Serving Cell or a service link of the Serving Cell). In some cases, reference RS may be a SS/PBCH block (e.g., corresponding to a non-Serving Cell or a service link of the non-Serving Cell) or a DL PRS (e.g., corresponding to a non-Serving Cell or a service link of the non-Serving Cell).

In some scenarios, the one or more positioning SRS configuration parameters (e.g., srs-PosRRC-InactiveConfig) may comprise at least one of the following: an RSRP threshold (e.g., inactivePosSRS-RSRP-Change Threshold) for a change/variation/update/fluctuation (e.g., increase and/or decrease) of RSRP (e.g., a RSRP value of a DL-PL reference) for a time alignment (TA) validation (e.g., for the positioning SRS transmission in/during/for the RRC inactive/idle state); and/or a bwp indicating a BWP configuration for positioning SRS transmission procedure (e.g., SRS for Positioning and/or for transmitting positioning SRS) during/in (or for) the RRC_INACTIVE/IDLE state; and/or a SSB threshold (e.g., inactivePosSRS-AbsThreshSS-BlocksConsolidation) indicating an absolute RSRP threshold for determining a set of SSB(s) for derivation/determination/calculation of the DL-PL reference (e.g., the RSRP value of a DL-PL reference (e.g., DL-PL reference signal) for the TA validation; and/or a SSB count (e.g., inactivePosSRS-NrofSS-Blocks ToAverage) indicating a number of SSB(s) with largest/highest RSRPs for derivation/determination of the DL-PL reference (e.g., the RSRP value of a DL-PL reference) for the TA validation; and/or a second TAT (e.g., inactivePosSRS-TimeAlignmentTimer), e.g., corresponding to a cell (e.g., the Serving Cell) and/or a TAG, for controlling how long the MAC entity considers the positioning SRS transmission in the RRC_INACTIVE/IDLE to be uplink time aligned. The DL-PL reference may correspond to a path-loss measure/value/estimate of a DL reference signal (e.g., a DL-PL reference signal), e.g., SSB.

In some examples, the DL-PL reference (e.g., the RSRP value of a DL-PL reference) may correspond to a Serving Cell or a non-Serving Cell. In some examples, the DL-PL reference (e.g., the RSRP value of a DL-PL reference) may correspond to a service link (e.g., corresponding to the Serving Cell or the non-Serving Cell). In some other examples, the DL-PL reference (e.g., the RSRP value of a DL-PL reference) may correspond to an NTN node (e.g., corresponding to the Serving Cell or the non-Serving Cell or corresponding to the service link).

In some examples, when the wireless device is communicating via the one or more cells, the wireless device may determine/maintain/calculate one or more DL-PL references (e.g., RSRP values corresponding to each of the one or more DL-PL reference) corresponding to the one or more cells.

In some examples, when the wireless device is communicating via a cell of the one or more cells (e.g., the Serving Cell or the non-Serving Cell), the wireless device may determine/maintain/calculate the one or more DL-PL references (e.g., RSRP values corresponding to each of the one or more DL-PL reference) corresponding to one or more service links of the cell and/or one or more NTN nodes corresponding to the cell (or the one or more service links).

In some examples, the second TAT (e.g., corresponding to a TAG and/or a Serving Cell of the one or more Serving Cells) may be different than a time alignment timer (e.g., per TAG, or associated with the primary TAG or the secondary TAG). For example, the second TAT (e.g., corresponding to a TAG and/or a Serving Cell of the one or more Serving Cells) may be different than a cg-SDT-TimeAlignment Timer. In some other cases, the second TAT (e.g., corresponding to a TAG and/or a Serving Cell of the one or more Serving Cells) may be the cg-SDT-TimeAlignment Timer.

In some cases, to perform the positioning SRS transmission procedure, the wireless device may transmit the positioning SRS via/using/based on the at least one positioning SRS resource (e.g., the positioning periodic SRS resource or the positioning semi-persistent (SP) SRS resource) to the base station, e.g., on a cell (e.g., the Serving Cell) and/or via the at least one NTN node. For example, by transmitting the positioning SRS, the wireless device may transmit positioning periodic SRS based on (or via or using) a positioning periodic SRS resource (e.g., the at least one positioning SRS resource) and/or positioning Semi-Persistent (SP) SRS based on (or via or using) a positioning SP SRS resource (e.g., the at least one positioning SRS resource).

In some examples, the wireless device may, to transmit the positioning SRS during (or in or for) the RRC inactive/idle state/mode to the base station (e.g., on a Serving Cell), determine a TA value (e.g., corresponding to a TAG and/or the Serving Cell of the one or more Serving Cells, and/or a service link of the at least one service link) for the positioning SRS transmission procedure being valid (e.g., TA validation of the positioning SRS transmission in RRC_INACTIVE/IDLE state). For example, the wireless device may determine the second TAT (e.g., corresponding to a TAG and/or a Serving Cell of the one or more Serving Cells, and/or a service link of the at least one service link) being running (e.g., not being expired/stopped).

In some examples, as shown in FIG. 21, when the one or more positioning SRS configuration parameters are configured/indicated for the positioning SRS transmission in/during the RRC inactive/idle state, the wireless device may maintain/obtain UL synchronization of the at least one Serving Cell (or with the base station) for the transmission of the positioning SRS during/in the RRC inactive/idle state. In some cases, the wireless device may determine the second TAT (e.g., corresponding to a TAG and/or a Serving Cell of the one or more Serving Cells, and/or a service link of the at least one service link) being running. For example, the wireless device may determine the UL synchronization of each Serving Cell (e.g., a Serving Cell of the one or more Serving Cells) not being lost (e.g., being obtained or maintained).

In some examples, to determine the UL synchronization of the at least one Serving Cell being maintained/obtained, the wireless device may determine the one or more NTN configuration parameters being valid (e.g., not being invalidated), e.g., for the positioning SRS transmission in the RRC inactive/idle state to the base station. For example, the wireless device may determine an (or each) NTN-specific configuration parameters, of the plurality of NTN-specific configuration parameters, corresponding to a TAG and/or a cell (e.g., a Serving Cell or a non-Serving Cell) and/or a service link of the at least one service link, being valid (e.g., the corresponding validity timer of the cell being running). For example, the wireless device may determine at least one validity timer/window/duration (e.g., corresponding to the at least one Serving Cell or a cell/service link on/via which the wireless device is communicating with the base station) being running. In some cases, the wireless device may, corresponding to a cell that the wireless device is transmitting positioning SRS transmission in the RRC inactive/idle state, determine the corresponding NTN-specific configuration parameters being valid and/or the corresponding validity timer being running. For example, the wireless device may determine the UL synchronization of the cell that the device is transmitting positioning SRS transmission in the RRC inactive/idle state is maintained/obtained.

In some examples, based on the one or more non-terrestrial network (NTN) configuration parameters (e.g., an NTN-specific configuration parameters corresponding to a TAG and/or a Serving Cell and/or a service link of the at least one service link), the wireless device may determine whether the TA value (e.g., corresponding to the TAG and/or the Serving Cell of the one or more Serving Cells, or the service link) for the positioning SRS transmission (e.g., to the base station, e.g., on the Serving Cell) in the RRC inactive/idle state being valid or not (e.g., determining the TA validation for the positioning SRS transmission in the RRC inactive/idle state/mode). In an example embodiment, in response to determining the one or more NTN configuration parameters (e.g., an NTN-specific configuration parameters corresponding to a TAG or a Serving Cell, and/or a service link of the at least one service link) being valid, the wireless device may, e.g., on the Serving Cell, perform/transmit the positioning SRS transmission procedure (e.g., the TA value for the positioning SRS transmission is valid). For example, the wireless device may determine the second TAT (e.g., corresponding to a TAG and/or a Serving Cell of the one or more Serving Cells, and/or a service link of the at least one service link) being running (e.g., not being expired/stopped). In some cases, the wireless device may determine a RSRP value of the DL-PL reference (e.g., corresponding to the Serving Cell) not being changed/fluctuated/varied (or increased or decreased) more than the RSRP threshold. For example, to determine whether the RSRP value of the DL-PL reference (e.g., corresponding to the Serving Cell) is changed more than the RSRP threshold or not, the wireless device may measure/determine/calculate a (current) RSRP value of the DL-PL reference (e.g., corresponding to the Serving Cell) (e.g., before transmitting the positioning SRS and/or before the at least one SRS resource) and compare it to a stored RSRP value of the DL-PL reference (e.g., corresponding to the Serving Cell). In some cases, the wireless device may determine a change/fluctuation/variation (e.g., increase or decrease) of the RSRP value of the DL-PL reference (e.g., corresponding to the Serving Cell) between the (current) RSRP value of the DL-PL reference (e.g., corresponding to the Serving Cell) and the stored RSRP value of the DL-PL reference (e.g., corresponding to the Serving Cell) based on determining the one or more NTN configuration parameters (e.g., an NTN-specific configuration parameters corresponding to the TAG or the Serving Cell) being valid (e.g., the validity timer corresponding to the Serving Cell and/or the TAG not being expired).

In some examples, in response to determining the one or more non-terrestrial network (NTN) configuration parameters (e.g., corresponding to a TAG and/or a Serving Cell of the one or more Serving Cells) not being valid (or being invalid, e.g., the validity timer of the Serving Cell and/or the TAG being expired), the wireless device may not perform (e.g., on the Serving Cell) the positioning SRS transmission procedure. For example, the wireless device may determine the second TAT (e.g., corresponding to the TAG and/or the Serving Cell of the one or more Serving Cells) being running (e.g., not being expired/stopped). In some cases, the wireless device may determine the RSRP value of the DL-PL reference (e.g., corresponding to the Serving Cell) not being changed (e.g., increased/decreased) more than the RSRP threshold.

In some examples, the wireless device may determine the TA value (e.g., corresponding to a TAG and/or a Serving Cell of the one or more Serving Cells) for the positioning SRS transmission (e.g., on the Serving Cell) in the RRC inactive/idle state being invalid (e.g., not being valid) based on at least one of the following: the one or more non-terrestrial network (NTN) configuration parameters (e.g., corresponding to a TAG and/or a Serving Cell of the one or more Serving Cells) not being valid (e.g., the validity timer corresponding to the Serving Cell and/or the TAG being expired); and/or the second TAT (e.g., corresponding to the TAG and/or the Serving Cell of the one or more Serving Cells) not being running (e.g., being stopped/expired); and/or a difference between the RSRP value of the DL-PL reference (e.g., corresponding to the Serving Cell) and the stored RSRP value of the DL-PL reference (e.g., corresponding to the Serving Cell) being more than the RSRP threshold. For example, in response to determining the one or more non-terrestrial network (NTN) configuration parameters (e.g., corresponding to a TAG and/or a Serving Cell of the one or more Serving Cells) not being valid, the wireless device may not update the stored RSRP value of the DL-PL reference (e.g., corresponding to the Serving Cell). In some cases, in response to determining the one or more non-terrestrial network (NTN) configuration parameters (e.g., corresponding to a TAG and/or a Serving Cell of the one or more Serving Cells) not being valid, the wireless device may not derive/determine the RSRP value of the DL-PL reference (e.g., corresponding to the Serving Cell). In some other cases, in response to determining the one or more non-terrestrial network (NTN) configuration parameters (e.g., corresponding to a TAG and/or a Serving Cell of the one or more Serving Cells) not being valid, the wireless device may ignore a TAC MAC CE for the positioning SRS transmission (e.g., for the second TAT and/or corresponding to the TAG and/or the Serving Cell of the one or more Serving Cells). For example, the wireless device may not transmit the positioning SRS transmission (e.g., not perform the positioning procedure, e.g., on the Serving Cell).

In some implementations, in response to receiving the one or more NTN configuration parameters (e.g., via receiving/acquiring SIB1 and/or NTN-specific SIB, e.g., SIB19), the wireless device may start/restart a validity timer/window/duration (e.g., T430 timer), e.g., corresponding to a TAG and/or a Serving Cell of the one or more Serving Cells. In some cases, the wireless device may receive the one or more NTN configuration parameters (e.g., an NTN-specific configuration parameters corresponding to a TAG or a Serving Cell) before transiting/switching from the RRC connected state to the RRC inactive/idle state. In some other cases, the wireless device may receive the one or more NTN configuration parameters (e.g., an NTN-specific configuration parameters corresponding to a TAG or a Serving Cell) during in the RRC inactive/idle state. Yet in some other cases, the wireless device may receive the one or more NTN configuration parameters (e.g., an NTN-specific configuration parameters corresponding to a TAG or a Serving Cell) before performing an initial access procedure or handover. For example, the wireless device may acquire the NTN-specific SIB or SIB1 in response to the expiry of the validity timer (e.g., corresponding to a TAG and/or a Serving Cell of the one or more Serving Cells) and the positioning SRS transmission being ongoing (e.g., the SRS procedure for the positioning procedure being ongoing).

For example, the wireless device may, in response to switching from the RRC connected state to the RRC inactive/idle state, acquire (e.g., periodically and/or based on a validity timer corresponding to a Serving Cell of the one or more Serving Cells, e.g., prior to the expiry of the validity timer or in response to the expiry of the validity timer) the one or more NTN configuration parameters (e.g., acquiring the NTN-specific SIB and/or SIB1). In some cases, the wireless device may determine the SRS procedure for the positioning procedure in the RRC inactive/idle state is ongoing.

In some examples, upon (or in response to) an expiry of a validity timer of a TAG and/or a Serving Cell of the one or more Serving Cells, the wireless device may determine the one or more NTN configuration parameters (e.g., an NTN-specific configuration parameters corresponding to the TAG or the Serving Cell) being invalid (or not being valid). For example, the wireless device may determine UL synchronization of the Serving Cell of the one or more Serving Cells (e.g., for UL transmission with the base station) being lost. In an example embodiment, the wireless device may, when being in the RRC inactive/idle state and/or the SRS procedure for the positioning procedure being ongoing, determine the UL synchronization of the Serving Cell of the one or more Serving Cells being lost, e.g., based on the expiry of the validity timer of the Serving Cell of the one or more Serving Cells and/or or the one or more NTN configuration parameters (e.g., an NTN-specific configuration parameters corresponding to a TAG or the Serving Cell) being invalid. In some implementations, the wireless device may determine the UL synchronization of the Serving Cell of the one or more Serving Cells (e.g., for transmitting the positioning SRS via the at least one positioning SRS resource) being lost, e.g., based on the expiry of the validity timer of the Serving Cell of the one or more Serving Cells and/or or the one or more NTN configuration parameters (e.g., an NTN-specific configuration parameters corresponding to a TAG or the Serving Cell) being invalid.

In some implementations, in response to an expiry of a validity timer corresponding to a Serving Cell and/or a TAG, the higher layers (e.g., the RRC sublayer) of the wireless device may inform/notify the lower layers (e.g., the MAC sublayer) of the wireless device that the UL synchronization is lost on the Serving Cell of the one or more Serving Cells (e.g., for UL transmission with the base station and/or for transmitting the positioning SRS via the at least one positioning SRS resource in the RRC inactive/idle state/mode). For example, the higher layers (e.g., the RRC sublayer) of the wireless device may send/transmit a first indication to lower layers (e.g., the MAC layers) of the wireless device for indicating the UL synchronization of the (or each) Serving Cell (of the one or more Serving Cells) is lost. For example, the first indication may indicate UL synchronization of each serving cell (e.g., a Serving Cell of the one or more Serving Cells and/or the Serving Cell) is lost. In an example, the wireless device may flush all HARQ buffers and/or not perform an (e.g., any) uplink transmission (e.g., comprising the positioning SRS transmission procedure during the RRC inactive/idle state) on the (or each) Serving Cell of the one or more Serving Cells. For example, the wireless device may determine the positioning SRS transmission procedure (e.g., on/in the Serving Cell) being ongoing in the RRC inactive/idle state. In some aspects, based on determining the UL synchronization of the Serving Cell being lost and the positioning SRS transmission procedure being ongoing in the RRC inactive/idle state in/on the Serving Cell, the wireless device may (re) acquire the NTN-specific SIB (e.g., SIB19) and/or SIB1. For example, the wireless device may initiate a random access procedure to resynchronize with the base station on the Serving Cell, e.g., for transmission of the positioning SRS via the Serving Cell. In some cases, the wireless device may not transit to the RRC connected state/mode.

In some implementations, upon or in response to the expiry of a validity timer of the Serving Cell of the one or more Serving Cells and/or a TAG, the wireless device may (re) acquire the NTN-specific SIB and/or SIB1. For example, the wireless device may receive the one or more NTN configuration parameters (e.g., an NTN-specific configuration parameters corresponding to the TAG or the Serving Cell) by (re) acquiring the NTN-specific SIB and/or SIB1. Upon or in response to successful acquisition of the NTN-specific SIB and/or SIB1, the higher layers of the wireless device may inform/notify the lower layers of the wireless device that the UL synchronization of the Serving Cell of the one or more Serving Cells is obtained/maintained (e.g., for UL transmission with the base station, e.g., for transmission of the positioning SRS in the RRC inactive/idle state). In some scenarios, the higher layers (e.g., the RRC sublayer) of the wireless device may send/transmit a second indication to the lower layers (e.g., the MAC layers) of the wireless device for indicating the UL synchronization of the Serving Cell of the one or more Serving Cells is obtained/revived. For example, the second indication may indicate UL synchronization of the (or each) serving cell (e.g., the Serving Cell of the one or more Serving Cells) is obtained. In an example, the wireless device may perform uplink transmission (e.g., for transmission of the positioning SRS in the RRC inactive/idle state) to the base station on a (or each) serving cell (e.g., the Serving Cell of the one or more Serving Cells). For example, the wireless device may start/restart a/each validity timer of a/each Serving Cell of the one or more Serving Cells in response to (re)-acquiring the NTN-specific SIB and/or SIB1.

In some scenarios, the second indication may be for starting the second TAT (e.g., inactivePosSRS-TimeAlignment Timer) (e.g., corresponding to a TAG and/or a Serving Cell of the one or more Serving Cells). In response to receiving the second indication from the higher layers of the wireless device, the wireless device (e.g., the MAC layer of the wireless device) may start/restart the second TAT (e.g., corresponding to the TAG and/or the Serving Cell of the one or more Serving Cells). In some cases, the second indication may be for starting/reviving the positioning SRS transmission procedure in the RRC inactive/idle state/mode (e.g., on the Serving Cell).

In some examples, in response to the one or more NTN configuration parameters (e.g., an NTN-specific configuration parameters corresponding to a TAG or a Serving Cell) being invalid (or not being valid), e.g., due to expiry of a validity timer of the Serving Cell of the one or more Serving Cells, and the positioning SRS transmission procedure being ongoing during the RRC inactive/idle state, the wireless device may perform the positioning SRS transmission (e.g., transmit the positioning SRS via the at least one positioning SRS resource), e.g., on the Serving Cell. For example, the wireless device may determine the second TAT (e.g., corresponding to the TAG and/or the Serving Cell of the one or more Serving Cells) being running (e.g., not being expired/stopped). In some cases, the wireless device may determine the RSRP value of the DL-PL reference (e.g., corresponding to the Serving Cell) not being changed/varied (e.g., increased/decreased) more than an RSRP threshold (e.g., inactivePosSRS-RSRP-ChangeThreshold). When operating in an NTN scenario, some example embodiments may allow the base station to determine the position of the wireless device (e.g., using the SRS procedure for the positioning procedure during the RRC inactive/idle state), e.g., when the one or more NTN configuration parameters (e.g., an NTN-specific configuration parameters corresponding to the TAG or the Serving Cell) is invalid. Example embodiments may allow the wireless device to not regularly/periodically (re) acquire the NTN-specific SIB and/or SIB1, e.g., reducing complexity/power consumption of the wireless device. For example, the wireless device may not indicate/transmit a GNSS capability (e.g., via the UE capability message) to the base station.

In some implementations, the base station may configure (e.g., via the one or more configuration parameters) the wireless device with a first configuration parameter. According to an example embodiment, the one or more configuration parameters may comprise the first configuration parameter. The first configuration parameter may, for example, indicate whether the wireless device use/adopt the one or more NTN configuration parameters (e.g., an NTN-specific configuration parameters corresponding to a TAG or a Serving Cell) to determine whether the TA value (e.g., corresponding to the TAG and/or the Serving Cell of the one or more Serving Cells) for the positioning SRS transmission is valid or not (e.g., whether the TA validation for the SRS procedure for the positioning procedure during the RRC inactive/idle state is based on the one or more NTN configuration parameters or not), e.g., via/on the Serving Cell. For example, in response to determining the first configuration parameter being indicated/configured (or being enabled or not being disabled or not being absent from the one or more configuration parameters), the wireless device may determine whether the TA value (e.g., corresponding to the TAG and/or the Serving Cell of the one or more Serving Cells) for the positioning SRS transmission is valid or not based on the one or more NTN configuration parameters (e.g., based on whether the one or more NTN configuration parameters being valid or not).

In some examples, based on the first configuration parameter being indicated/configured (or being enabled or not being disabled or not being absent from the one or more configuration parameters) and the one or more NTN configuration parameters (e.g., an NTN-specific configuration parameters corresponding to a TAG or a Serving Cell) being valid, the wireless device may transmit the SRS for positioning, e.g., on the Serving Cell and/or to the base station. For example, the wireless device may determine the TA value (e.g., corresponding to the TAG and/or the Serving Cell of the one or more Serving Cells) for the positioning SRS transmission being valid, e.g., based on the second TAT (e.g., corresponding to the TAG and/or the Serving Cell of the one or more Serving Cells) being running and/or the RSRP value of the DL-PL reference (e.g., corresponding to the Serving Cell) being changed less than an RSRP threshold (e.g., inactivePosSRS-RSRP-Change Threshold).

In some examples, based on the first configuration parameter being indicated/configured (or being enabled or not being disabled or not being absent from the one or more configuration parameters) and the one or more NTN configuration parameters (e.g., an NTN-specific configuration parameters corresponding to a TAG or a Serving Cell) being invalid, the wireless device may not transmit the SRS for positioning (e.g., stop the positioning SRS transmission procedure and/or deactivate the SP positioning SRS resource(s), e.g., on the Serving Cell and/or to the base station.

In some examples, in response to determining the first configuration parameter not being indicated/configured (or being disabled or being absent from the one or more configuration parameters), the wireless device may determine whether the TA value (e.g., corresponding to a TAG and/or a Serving Cell of the one or more Serving Cells) for the positioning SRS transmission is valid or not based on whether the second TAT (e.g., corresponding to the TAG and/or the Serving Cell of the one or more Serving Cells) is running or not and/or whether the RSRP value of the DL-PL reference (e.g., corresponding to the Serving Cell) is changed more than an RSRP threshold (e.g., inactivePosSRS-RSRP-ChangeThreshold) or not.

In some examples, based on the first configuration parameter not being indicated/configured and the one or more NTN configuration parameters (e.g., an NTN-specific configuration parameters corresponding to a TAG or a Serving Cell) being invalid, the wireless device may transmit the SRS for positioning. For example, the wireless device may determine the second TAT (e.g., corresponding to the TAG and/or the Serving Cell of the one or more Serving Cells) being running and/or the RSRP value of the DL-PL reference (e.g., corresponding to the Serving Cell) being changed less than an RSRP threshold (e.g., inactivePosSRS-RSRP-Change Threshold).

In some implementations, the UE capability message may indicate a capability of the wireless device for transmitting the SRS for positioning when the wireless device is operating in an NTN scenario. In some cases, the UE capability message may indicate a capability of the wireless device for transmitting the SRS for positioning when the UL synchronization of a Serving Cell of the one or more Serving Cells is lost (e.g., due to the expiry of the validity timer of the Serving Cell). In some other cases, the UE capability message may indicate a capability of the wireless device for transmitting, e.g., on a Serving Cell, the SRS for positioning when the UL synchronization of the Serving Cell of the one or more Serving Cells is obtained/maintained (e.g., not being lost).

In some examples, the UE-capability may not comprise GNSS capability (e.g., gnss-Location-r16). For example, when the wireless device is not equipped with a GNSS or A-GNSS receiver (e.g., for providing detailed location information of the wireless device in the RRC inactive/idle state/mode), the wireless device may, to the base station on/via a Serving Cell, transmit the positioning SRS transmission despite losing the UL synchronization of the Serving Cell of the one or more Serving Cells (e.g., the one or more NTN configuration parameters, e.g., corresponding to the Serving Cell, being invalid).

In some examples, the UE-capability may comprise the antenna polarization mode (e.g., vertical horizontal, right-hand circular, or left-hand circular) of the wireless device.

In some cases, the wireless device may determine (or

derive/calculate/measure/derive/estimate/evaluate/obtain) DL-PL reference (or the RSRP value of the DL-PL reference corresponding to a Serving Cell) for TA validation of SRS for Positioning transmission (e.g., for positioning SRS transmission) in/during RRC_INACTIVE/IDLE state. For example, the wireless device may acquire SIB2 (e.g., based on a stored version of SIB2 being invalid and/or regardless of whether the one or more NTN configuration parameters is valid or not), and/or verify the configuration of (e.g., verify the one or more positioning SRS configuration parameters comprise) the SSB count (e.g., nrofSS-Blocks ToAverage) and/or the SSB threshold (e.g., absThreshSS-BlocksConsolidation) is available. When the one or more positioning SRS configuration parameters do not indicate/configure the SSB threshold (e.g., abs ThreshSS-BlocksConsolidation) (e.g., the SSB threshold is not configured), the wireless device may determine the RSRP value of the DL-PL reference (e.g., corresponding to the Serving Cell) for the TA validation of SRS for Positioning transmission (e.g., for positioning SRS transmission) in/during RRC_INACTIVE/IDLE state as the highest beam measurement quantity value. When the one or more positioning SRS configuration parameters indicate/configure the SSB threshold (e.g., abs ThreshSS-BlocksConsolidation) (e.g., the SSB threshold is configured) and the highest beam measurement quantity value is below or equal to the SSB threshold (e.g., absThreshSS-BlocksConsolidation), the wireless device may determine the RSRP value of the DL-PL reference (e.g., corresponding to the Serving Cell) for the TA validation of SRS for Positioning transmission (e.g., for positioning SRS transmission) in/during RRC_INACTIVE/IDLE state as the highest beam measurement quantity value. In some examples, the wireless device may determine the RSRP value of the DL-PL reference as the linear average of the power values of up to the SSB count (e.g., the nrofSS-Blocks ToAverage) of the highest beam measurement quantity values above the SSB threshold (e.g., absThreshSS-BlocksConsolidation), e.g., when the one or more positioning SRS configuration parameters indicate/configure the SSB threshold (e.g., abs ThreshSS-BlocksConsolidation) (e.g., the SSB threshold is configured).

In some examples, SIB2 may comprise cell re-selection information common for intra-frequency, inter-frequency and/or inter-RAT cell re-selection (e.g., applicable for more than one type of cell reselection) and/or intra-frequency cell re-selection information other than neighboring cell related.

In some examples, based on the one or more NTN configuration parameters (e.g., an NTN-specific configuration parameters corresponding to a TAG or a Serving Cell) being valid, the wireless device may acquire SIB2 when the stored version of SIB2 is invalid. For example, the wireless device may determine a first configuration parameter being indicated/configured (or being enabled or not being disabled or not being absent from the one or more configuration parameters). For example, the wireless device may determine the SRS procedure for the positioning procedure being ongoing.

In some cases, in response to (re) acquiring the NTN-specific SIB, the wireless device may acquire SIB2 when the stored version of SIB2 is invalid. For example, the wireless device may determine the first configuration parameter being indicated/configured (or being enabled or not being disabled or not being absent from the one or more configuration parameters). For example, the wireless device may determine the SRS procedure for the positioning procedure (e.g., on a Serving Cell) being ongoing.

In some other cases, in response to the one or more NTN configuration parameters (e.g., an NTN-specific configuration parameters corresponding to a TAG or a Serving Cell) being invalid and the stored version of SIB2 being invalid, the wireless device may not acquire SIB2. For example, the wireless device may determine the first configuration parameter not being indicated/configured (or being disabled). For example, the wireless device may determine the SRS procedure for the positioning procedure (e.g., on the Servig Cell) not being ongoing (e.g., being aborted/stopped).

In some examples, irrespective of whether the one or more NTN configuration parameters (e.g., an NTN-specific configuration parameters corresponding to a TAG or a Serving Cell) being valid or not, the wireless device may acquire SIB2 when the stored version of SIB2 is invalid. For example, the wireless device may determine the first configuration parameter not being indicated/configured (or being disabled or being absent from the one or more configuration parameters).

The one or more configuration parameters (e.g., using the RRCReconfiguration or RRCResume) may comprise one or more measurements configuration parameters (e.g., MeasConfig). In an example, the one or more measurements configuration parameters may configure the wireless device to perform measurements (e.g., the one or more location related measurements and/or perform the positioning measurement procedure), e.g., on the at least one Serving Cell (e.g., the Serving Cell) or on at least one non-Serving Cell. The one or more measurements configuration parameters (e.g., MeasConfig) may indicate/specify/configure one or more measurements (e.g., the at least one measurement and/or the one or more location related measurements). In some cases, one or more measurements configuration parameters (e.g., MeasConfig) may cover/comprise intra-frequency, inter-frequency and inter-RAT mobility as well as configuration of measurement gaps. The wireless device may perform the one or more measurements (e.g., the one or more location related measurements and/or the positioning measurement procedure) using/based on the one or more measurements configuration parameters (e.g., MeasConfig). For example, to perform the positioning procedure the wireless device may perform the one or more measurements (e.g., the at least one measurement and/or the one or more location related measurements), e.g., measuring RSRP value of the DL-PL reference (e.g., corresponding to a Serving Cell or a non-Serving Cell).

In some examples, when the one or more configuration parameters indicate/configure meas Object (e.g., MeasConfig) for a Serving Cell (of the one or more Serving Cells), e.g., where the wireless device receives the one or more positioning SRS configuration parameters, the wireless device may store the RSRP of the DL-PL reference (e.g., corresponding to the Serving Cell) derived/determined based on the measObject configured for the Serving Cell. In some scenarios, the wireless device may determine the one or more NTN configuration parameters (e.g., an NTN-specific configuration parameters corresponding to a TAG or the Serving Cell) being valid. For example, the wireless device may determine the first configuration parameter being indicated/configured (or being enabled or not being disabled or not being absent from the one or more configuration parameters).

In some examples, the measObject configured for the Serving Cell may correspond to a polarization mode of the wireless device and/or the at least one NTN node. The wireless device may store the RSRP of the DL-PL reference (e.g., corresponding to the Serving Cell), corresponding to the polarization mode of the wireless device and/or the at least one NTN node, derived/determined based on the measObject configured for the Serving Cell.

In some other examples, irrespective of whether the one or more NTN configuration parameters (e.g., an NTN-specific configuration parameters corresponding to a TAG or a Serving Cell) being valid or not, the wireless device may store the RSRP of the DL-PL reference (e.g., corresponding to the Serving Cell) derived/determined based on the measObject configured for the Serving Cell. For example, the wireless device may determine the first configuration parameter not being indicated/configured (or being disabled or being absent from the one or more configuration parameters).

In some scenarios, the wireless device may receive a Timing Advance Command (TAC) MAC CE (e.g., comprising a TAG ID and/or a Serving Cell ID or the like) from the base station. For example, the wireless device may determine a TA value (e.g., NTA), e.g., of the at least one TA value, being maintained corresponding to the (indicated) TAG or Serving Cell of the TAC MAC CE. In response to the TAC MAC CE and the NTA associated with the indicated TAG or the Serving Cell being maintained, the wireless device may apply the TAC for the indicated TAG or the Serving Cell. For example, in response to the second TAT (e.g., corresponding to the indicated TAG and/or the Serving Cell of the one or more Serving Cells) being configured and there is an ongoing Positioning SRS Transmission (e.g., on the Serving Cell and/or associated with the TAG) in the RRC_INACTIVE/IDLE (e.g., a positioning SRS transmission procedure being ongoing or a transmission positioning SRS being ongoing), the wireless device may start/restart the second TAT (e.g., the inactivePosSRS-TimeAlignment Timer) associated with the (indicated) TAG or the Serving Cell. The wireless device may update the stored DL-PL reference (e.g., the stored RSRP value of the DL-PL reference, e.g., corresponding to the Serving Cell) with a current RSRP value of the DL-PL reference (e.g., corresponding to the Serving Cell). In some scenarios, the wireless device may determine the one or more NTN configuration parameters (e.g., an NTN-specific configuration parameters corresponding to the TAG or the Serving Cell) being valid. For example, the wireless device may determine the first configuration parameter being indicated/configured (or being enabled or not being disabled or not being absent from the one or more configuration parameters).

In some examples, irrespective of whether the one or more NTN configuration parameters (e.g., an NTN-specific configuration parameters corresponding to a TAG or a Serving Cell) being valid or not, in response to receiving the TAC MAC CE, the wireless device may start/restart the second TAT (e.g., the inactivePos SRS-TimeAlignment Timer) associated with the (indicated) TAG and/or the Serving Cell. For example, the wireless device may determine the first configuration parameter not being indicated/configured (or being disabled or being absent from the one or more configuration parameters).

In some scenarios, in response to an expiry of the second TAT (e.g., the inactivePosSRS-TimeAlignment Timer) associated with the (indicated) TAG and/or the Serving Cell, the wireless device may release the one or more positioning SRS configuration parameters (e.g., Positioning SRS for RRC_INACTIVE/IDLE configuration(s) corresponding to the TAG and/or the Serving Cell. For example, the lower layers (e.g., the MAC layer) of the wireless device may notify the upper layer (e.g., the RRC sublayers) to release the one or more positioning SRS configuration parameters.

In some examples, the one or more configuration parameters may indicate/configure/enable the first configuration parameter. In an example embodiment, based on the one or more NTN configuration parameters (e.g., an NTN-specific configuration parameters corresponding to a TAG or a Serving Cell) being invalid, the wireless device may not determine/derive the RSRP value of the DL-PL reference (e.g., corresponding to the Serving Cell) for the TA validation of SRS for Positioning transmission (e.g., for positioning SRS transmission) in/during RRC_INACTIVE/IDLE state, e.g., on/via the Serving Cell. For example, the wireless device may not expect receiving TAC MAC CE (e.g., for the second TAT and/or associated with the TAG and/or the Serving Cell), e.g., the wireless device may ignore the TAC MAC CE based on determining one or more NTN configuration parameters (e.g., an NTN-specific configuration parameters corresponding to the TAG or the Serving Cell) being invalid.

In some examples, the one or more configuration parameters may not indicate/configure/enable the first configuration parameter. In an example embodiment, based on the one or more NTN configuration parameters (e.g., an NTN-specific configuration parameters corresponding to a TAG or a Serving Cell) being invalid, the wireless device may determine/derive the RSRP value of the DL-PL reference (e.g., corresponding to the Serving Cell) for the TA validation of SRS for Positioning transmission (e.g., for positioning SRS transmission) in/during RRC_INACTIVE/IDLE state, e.g., on/via the Serving Cell. In some scenarios, the wireless device may apply the TAC MAC CE (e.g., for the second TAT and/or associated with the TAG and/or the Serving Cell) based on determining one or more NTN configuration parameters (e.g., an NTN-specific configuration parameters corresponding to the TAG or the Serving Cell) being invalid.

The base station may, for example, estimate/measure position/location (or velocity) of the wireless device based on receiving the positioning SRS transmission of the at least one positioning SRS resource (e.g., by performing UL-TDOA positioning procedure and/or UL-AOA positioning procedure). The base station may, to estimate the position/location (or the velocity) of the wireless device, estimate/measure RX time delay based on receiving the positioning SRS transmission of the at least one positioning SRS resource. The base station may estimate/measure RX timing error, e.g., based on the estimated/measure RX time delay. In some cases, the base station may report estimated location/position (or the velocity) of the wireless device to AMF/LMF.

In some examples, when the wireless device is in the RRC connected state (e.g., regardless of whether UL synchronization of the Serving Cell being maintained/obtained), the wireless device may not transmit the positioning SRS transmission of the at least one positioning SRS resource. The wireless device may not start/restart the second TAT (e.g., of the TAG) when the wireless device is in the RRC connected state.

In some examples, the wireless device and the base station may stay UL synchronized on the Serving Cell of the one or more Serving Cells (e.g., based on validity of the one or more NTN configuration parameters) for the positioning SRS transmission. Example embodiment may improve efficiency of the positioning SRS transmission (e.g., by reducing interference on positioning SRS transmission of other wireless devices residing/communicating in the cell/beam), e.g., on/via the Serving Cell.

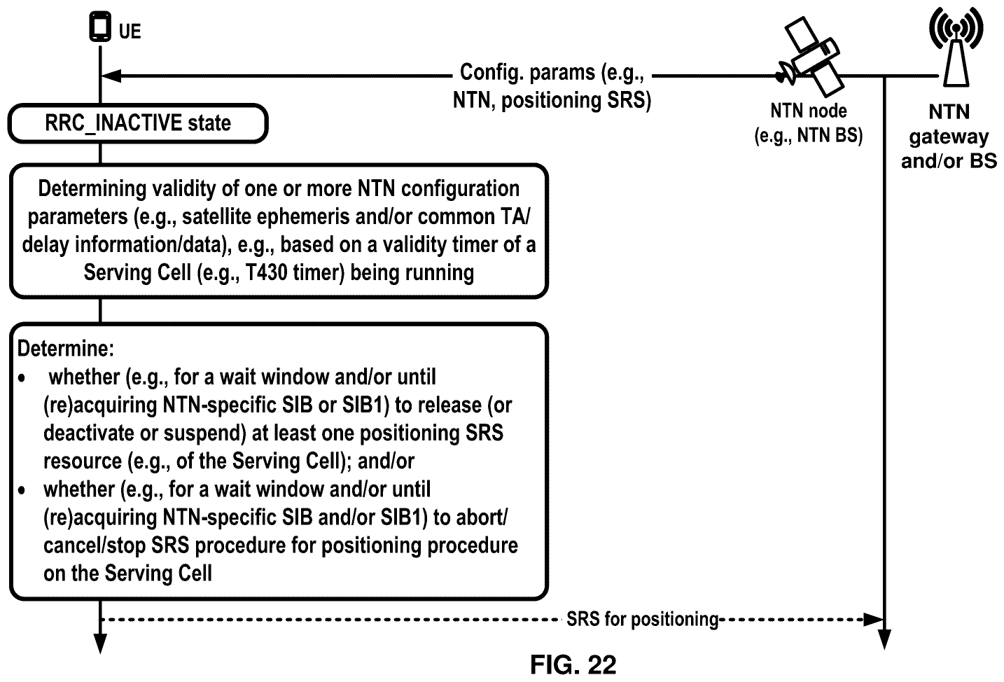

FIG. 22 shows an example embodiment of an SRS procedure for positioning procedure in wireless communications systems per an aspect of the present disclosure. For example, FIG. 22 may illustrate an example of a positioning SRS transmission procedure (e.g., an SRS procedure for positioning procedure) in an RRC inactive/idle (RRC_INACTIVE/IDLE) state (e.g., without the wireless device transitioning/switching to an RRC_CONNECTED state). In some aspects, FIG. 22 may show an implementation of a method (or a process) for the positioning procedure at a base station and/or the wireless device. For example, the SRS procedure for the positioning procedure may be used by the wireless device for transmission of a positioning SRS (e.g., the positioning SRS resource) to the base station (e.g., on/via/in a Serving Cell) during/in the RRC inactive/idle state.

The base station may communicate with the wireless device via/using the one or more cells (e.g., the one or more Serving Cells). As shown in FIG. 22, the wireless device may be in the RRC_INACTIVE/IDLE (or an RRC inactive/idle) state/mode. In some cases, the wireless device may switch from the RRC connected state to the RRC inactive/idle state, e.g., based on receiving the RRC release message from the base station. For example, the RRC release message may comprise the one or more positioning SRS configuration parameters. For example, the wireless device may be in a RRC non-connected state/mode (e.g., the RRC inactive/idle state/mode or the RRC idle state/mode). The wireless device may, for example, communicate with the base station via a non-terrestrial network (NTN), e.g., the wireless device and the base station may operate in the NTN and/or the base station may be an NTN base station and/or a cell (e.g., a Serving Cell of the one or more Serving Cells) may be part of the NTN. For example, the cell may be the Serving Cell or a non-Serving Cell.

As shown in FIG. 22, the wireless device may, from the base station, receive the one or more configuration parameters (e.g., the one or more RRC configuration parameters). The one or more configuration parameters may, for example, comprise the one or more serving cell configuration parameters (e.g., ServingCellConfigCommon, ServingCellConfigCommonSIB, and/or ServingCellConfig) for configuring the one or more cells (e.g., the one or more Serving Cells). The one or more configuration parameters may, for example, comprise the one or more positioning SRS configuration parameters. For example, the one or more configuration parameters may, for example, comprise the one or more NTN configuration parameters, e.g., for maintaining UL synchronization with the base station and/or of the one or more Serving Cells.

As shown in FIG. 22, during/in the RRC inactive/idle state, the wireless device may determine the one or more NTN configuration parameters (e.g., an NTN-specific configuration parameters corresponding to a TAG or a Serving Cell) being invalid. For example, based on the expiry of a validity timer of the Serving Cell of the one or more Serving Cells and/or receiving the first indication at the lower layers (e.g., the MAC layer) of the wireless device from the higher layer (e.g., RRC layer) of the wireless device, the wireless device may determine the one or more NTN configuration parameters (e.g., an NTN-specific configuration parameters corresponding to the TAG or the Serving Cell) being invalid (e.g., the UL synchronization of the Serving Cell being lost).

In some examples, as shown in FIG. 22, in response to determining the one or more NTN configuration parameters (e.g., an NTN-specific configuration parameters corresponding to the TAG or the Serving Cell) being invalid (or not being valid), the wireless device may, e.g., corresponding to the Serving Cell, determine whether to release (or suspend or deactivate) at least one positioning SRS resource (e.g., configured by the one or more positioning SRS configuration parameters (e.g., srs-PosRRC-InactiveConfig)) or not.

In some examples, in response to determining the one or more NTN configuration parameters (e.g., an NTN-specific configuration parameters corresponding to a TAG or a Serving Cell) being invalid (or not being valid), the wireless device may, e.g., corresponding to the Serving Cell, release (or suspend or deactivate) at least one positioning SRS resource (e.g., configured by the one or more positioning SRS configuration parameters (e.g., srs-PosRRC-InactiveConfig)). In some cases, the wireless device may consider/determine the TA value (e.g., corresponding to the TAG and/or the Serving Cell of the one or more Serving Cells) for SRS for Positioning transmission (e.g., on/via the Serving Cell and/or to the base station) being invalid. In some examples, the higher layers (e.g., the RRC sublayer) of the wireless device may inform/notify (e.g., by send/transmit a third indication to) the lower layers (e.g., the MAC sublayer) a release request of the least one positioning SRS resource, e.g., corresponding to the Serving Cell. For example, the third indication may indicate a positioning SRS configuration (e.g., for/during/in RRC_INACTIVE/IDLE state) release request of the least one positioning SRS resource, e.g., corresponding to the Serving Cell. In some scenarios, the wireless device may, e.g., corresponding to the Serving Cell, release the periodic (positioning) SRS resource(s) (e.g., the least one positioning SRS resource comprises the periodic (positioning) SRS resource(s)) and/or the semi-persistent (positioning) SRS resource(s) (e.g., the least one positioning SRS resource comprises the semi-persistent (positioning) SRS resource(s)). For example, the wireless device may stop the second TAT (e.g., corresponding to the TAG and/or the Serving Cell of the one or more Serving Cells). In an example, the upper/higher layers (e.g., the RRC sublayer) of the wireless device may send/transmit a fourth indication/instruction to the lower layer (e.g., the MAC sublayer) of the wireless device. The fourth indication may be for stopping the second TAT (e.g., corresponding to the TAG and/or the Serving Cell of the one or more Serving Cells). In response to receiving the fourth indication, the wireless device (e.g., the MAC layer of the wireless device) may stop the second TAT (e.g., corresponding to the TAG and/or the Serving Cell of the one or more Serving Cells).

In some examples, the wireless device may determine the positioning SRS transmission procedure (e.g., corresponding to the Serving Cell) being ongoing during the RRC inactive/idle state. In some examples, the wireless device may, e.g., corresponding to the Serving Cell, suspend the least one positioning SRS configuration parameters for/during a wait (or suspension) window/duration/period. For example, the wait window may be for (re) acquiring the NTN-specific SIB and/or SIB1 (e.g., validating the one or more NTN configuration parameters, e.g., corresponding to the Serving Cell) by the wireless device.

In response to releasing/suspending the least one positioning SRS configuration parameters, the wireless device may stop transmitting (e.g., refrain from transmitting or not transmitting) to the base station (e.g., on the Serving Cell of the one or more Serving Cells) the at least one positioning SRS resource (e.g., performing the SRS procedure for the positioning procedure), e.g., during the wait window. For example, the wireless device may abort/cancel the SRS procedure for the positioning procedure.

In response to (re) acquiring the NTN-specific SIB and/or SIB1 (e.g., starting a validity timer corresponding to the Serving Cell and/or validating the one or more NTN configuration parameters corresponding to the Serving Cell), the wireless device may, e.g., corresponding to the Serving Cell, start (or revive) the positioning SRS transmission procedure (e.g., by removing the suspension of the at least one positioning SRS resource or unsuspending the (suspended) at least one positioning SRS resource). For example, the wireless device may, to the base station via the Serving Cell, transmit positioning SRS via/using the at least one positioning SRS resource based on (re) acquiring the NTN-specific SIB and/or SIB1. In some cases, the wireless device may start/restart the second TAT (e.g., corresponding to the TAG and/or the Serving Cell of the one or more Serving Cells). For example, the wireless device may revive the positioning SRS transmission procedure from the EpochTime of the one or more NTN configuration parameters (e.g., the NTN-specific configuration parameters corresponding to the TAG or the Serving Cell) and/or an occasion that the one or more NTN configuration parameters (e.g., the NTN-specific configuration parameters corresponding to the TAG or the Serving Cell) become available and/or when/from/at/in (e.g., a slot, subframe, frame, or symbol that) the validity timer corresponding to the Serving Cell and/or the TAG is started/restarted.

In some cases, in response to the expiry of the wait window and not (successfully) (re) acquiring NTN-specific SIB and/or SIB1 (e.g., failing to validate the one or more NTN configuration parameters), the wireless device may, e.g., corresponding to the Serving Cell, release the at least one positioning SRS configuration parameters.

In some implementations, the base station (e.g., the network) may transmit (e.g., corresponding to a Serving Cell) a semi-persistent (SP) Positioning SRS Activation MAC CE to the wireless device. For example, the SP Positioning SRS Activation MAC CE may be for activating at least one resource set of Semi-Persistent Positioning SRS of the one or more resource set of Semi-Persistent Positioning SRS. The (activated) at least one resource set of Semi-Persistent Positioning SRS may correspond to a cell (e.g., the Serving Cell of the one or more Serving Cells). The at least one resource set of Semi-Persistent Positioning SRS may be initially deactivated, e.g., upon/after (re-) configuration by upper layers (e.g., the RRC layer) of the wireless device and/or upon/after reconfiguration with sync (e.g., after performing handover) and/or upon/after receiving the RRC release message, e.g., from the base station. The wireless device may indicate to the lower layers (e.g., the PHY layer) of the wireless device information regarding the SP Positioning SRS Activation/Deactivation MAC CE (e.g., the at least one resource set of Semi-Persistent Positioning SRS). In some examples, the wireless device may, to the base station and/or via/on the Serving Cell, transmit the positioning SRS via/using the at least one resource set of Semi-Persistent Positioning SRS (e.g., the at least one positioning SRS resources) based on the TA of the positioning SRS transmission being valid. For example, the wireless device may determine the one or more NTN configuration parameters (e.g., an NTN-specific configuration parameters corresponding to a TAG or the Serving Cell) being valid and/or the validity timer corresponding to the Serving Cell and/or the TAG being running.

In some examples, in response to determining the one or more NTN configuration parameters (e.g., an NTN-specific configuration parameters corresponding to a TAG or a Serving Cell) being invalid (or not being valid) and the at least one resource set of Semi-Persistent Positioning SRS being activated (e.g., via receiving the SP Positioning SRS Activation MAC CE and/or the positioning SRS transmission procedure being ongoing) during/in the RRC inactive/idle state, the wireless device may (autonomously) deactivate the at least one resource set of Semi-Persistent Positioning SRS, e.g., corresponding to the Serving Cell. For example, the wireless device may (autonomously) deactivate the at least one resource set of Semi-Persistent Positioning SRS (e.g., corresponding to the Serving Cell of the one or more Serving Cells) for/during the wait window. In response to the at least one resource set of Semi-Persistent Positioning SRS being deactivated, the wireless device may stop/abort/cancel the SRS procedure for the positioning procedure (e.g., not transmitting or refrain from transmitting the positioning SRS), e.g., on the Serving Cell of the one or more Serving Cells. For example, the wireless device may stop the second TAT (e.g., corresponding to a TAG and/or the Serving Cell of the one or more Serving Cells). In an example, the upper/higher layers (e.g., the RRC sublayer) of the wireless device may send/transmit the fourth indication/instruction to the lower layer (e.g., the MAC sublayer) of the wireless device.

In response to (re) acquiring the NTN-specific SIB (and/or SIB1) and the at least one resource set of Semi-Persistent Positioning SRS being deactivated (e.g., due to expiry of the validity timer, e.g., corresponding to a Serving Cell) on the Serving Cell, the wireless device may (autonomously) activate the at least one resource set of Semi-Persistent Positioning SRS on the Serving Cell. In some cases, the wireless device may determine a deactivation MAC CE, for deactivating the at least one resource set of Semi-Persistent Positioning SRS (e.g., a SP Positioning SRS Deactivation MAC CE) corresponding to the Serving Cell, not being received from the base station (e.g., during the wait window). For example, the wireless device may, to the base station on the Serving Cell, transmit positioning SRS via/using the at least one resource set of Semi-Persistent Positioning SRS. In some implementations, the wireless device may start the second TAT (e.g., corresponding to the TAG and/or the Serving Cell of the one or more Serving Cells).

In some cases, in response to the expiry of the wait window and not (successfully) (re) acquiring NTN-specific SIB and/or SIB1, the wireless device may release the at least one positioning SRS configuration parameters (e.g., the at least one resource set of Semi-Persistent Positioning SRS) on the Serving Cell. For example, the wireless device may initiate/trigger an RA procedure on the Serving Cell to resynchronize with the base station on the Serving Cell and/or to request the NTN-specific SIB.

In some implementations, the base station may configure (e.g., via the one or more configuration parameters) the wireless device with a second configuration parameter. According to an example embodiment, the one or more configuration parameters may comprise the second configuration parameter. The second configuration parameter may, for example, indicate whether the wireless device use/adopt the one or more NTN configuration parameters (e.g., an NTN-specific configuration parameters corresponding to a TAG or a Serving Cell) to determine whether to release/deactivate the at least one positioning SRS configuration parameters (e.g., the at least one resource set of Semi-Persistent Positioning SRS) corresponding to at least one Serving Cell, e.g., the Serving Cell, based on the one or more NTN configuration parameters (e.g., an NTN-specific configuration parameters corresponding to the TAG or the Serving Cell) being invalid.

In some examples, in response to determining the second configuration parameter being indicated/configured (or being enabled or not being disabled or not being absent from the one or more configuration parameters), the wireless device may release/deactivate the at least one positioning SRS configuration parameters (e.g., the at least one resource set of Semi-Persistent Positioning SRS) of a Serving Cell based on the one or more NTN configuration parameters (e.g., an NTN-specific configuration parameters corresponding to a TAG or the Serving Cell) being invalid (e.g., an expiry of a validity timer corresponding to the Serving Cell). For example, based on the (re) acquitting the NTN-specific SIB and/or SIB1 (e.g., validating the one or more NTN configuration parameters (e.g., the NTN-specific configuration parameters corresponding to the TAG or the Serving Cell)), the wireless device may revive/activate the at least one positioning SRS configuration parameters (e.g., the at least one resource set of Semi-Persistent Positioning SRS) on/corresponding to the Serving Cell.

In some examples, in response to determining the second configuration parameter being indicated/configured (or being enabled or not being disabled or not being absent from the one or more configuration parameters), the wireless device may abort/cancel/stop (e.g., not transmitting the at least one positioning SRS) the SRS procedure (e.g., on a Serving Cell) for the positioning procedure based on the one or more NTN configuration parameters (e.g., an NTN-specific configuration parameters corresponding to a TAG or the Serving Cell) being invalid (e.g., an expiry of a validity timer corresponding to the Serving Cell). For example, based on the (re) acquitting the NTN-specific SIB and/or SIB1 (e.g., validating the one or more NTN configuration parameters (e.g., the NTN-specific configuration parameters corresponding to the TAG or the Serving Cell), the wireless device may start the SRS procedure for the positioning procedure on the Serving Cell.

In some examples, the UE capability message may indicate a capability of the wireless device for (automatically) releasing/suspending/deactivating the at least one positioning SRS resource of a Serving Cell when the UL synchronization of the Serving Cell is lost (e.g., due to the expiry of a validity timer corresponding to the Serving Cell and/or invalidity of the one or more configuration parameters). In some other cases, the UE capability message may indicate a capability of the wireless device for automatically stopping/aborting/canceling the SRS procedure, e.g., of the Serving Cell, for the positioning procedure in response to the UL synchronization of the Serving cell of the one or more Serving Cells being lost. For example, the wireless device may stop/abort/cancel the SRS procedure for the positioning procedure (or release/suspend/deactivate the at least one positioning SRS resource) in response to the UL synchronization of the Serving cell of the one or more Serving Cells being lost.

In some examples, the UE capability message may indicate a capability of the wireless device for maintaining (e.g., not releasing/suspending/deactivating) the at least one positioning SRS resource, e.g., of the Serving Cell, despite the UL synchronization of the Serving Cell is lost (e.g., due to the expiry of the validity timer of the Serving Cell or the TAG). In some other cases, the UE capability message may indicate a capability of the wireless device for performing (e.g., not stopping/aborting/canceling) the SRS procedure for the positioning procedure (e.g., on/via the Serving Cell) in response to the UL synchronization of the Serving cell of the one or more Serving Cells being lost. For example, the wireless device may not stop/abort/cancel the SRS procedure for the positioning procedure (or not release/suspend/deactivate the at least one positioning SRS resource) in response to the UL synchronization of the Serving cell of the one or more Serving Cells being lost.

Example embodiments may allow the wireless device to determine whether the at least one SRS resource (e.g., for the positioning SRS transmission in/during the RRC inactive/idle state) being suspended/deactivated or not (e.g., based on validity of the one or more NTN configuration parameters (e.g., an NTN-specific configuration parameters corresponding to a TAG or a Serving Cell)). Example embodiments may allow the wireless device to (automatically) abort/cancel/stop the SRS procedure for positioning procedure (e.g., during the RRC inactive/idle state) based on the expiry of the validity timer. Example embodiments may allow the wireless device to (automatically) start/revive the aborted/canceled/stopped the SRS procedure for positioning procedure (e.g., during the RRC inactive/idle state) based on the (re) acquitting the NTN-specific SIB (e.g., validating the one or more NTN configuration parameters (e.g., an NTN-specific configuration parameters corresponding to a TAG or a Serving Cell). Example embodiments may enhance the performance of the SRS procedure for the positioning procedure and/or reduce the power consumption of the wireless device.

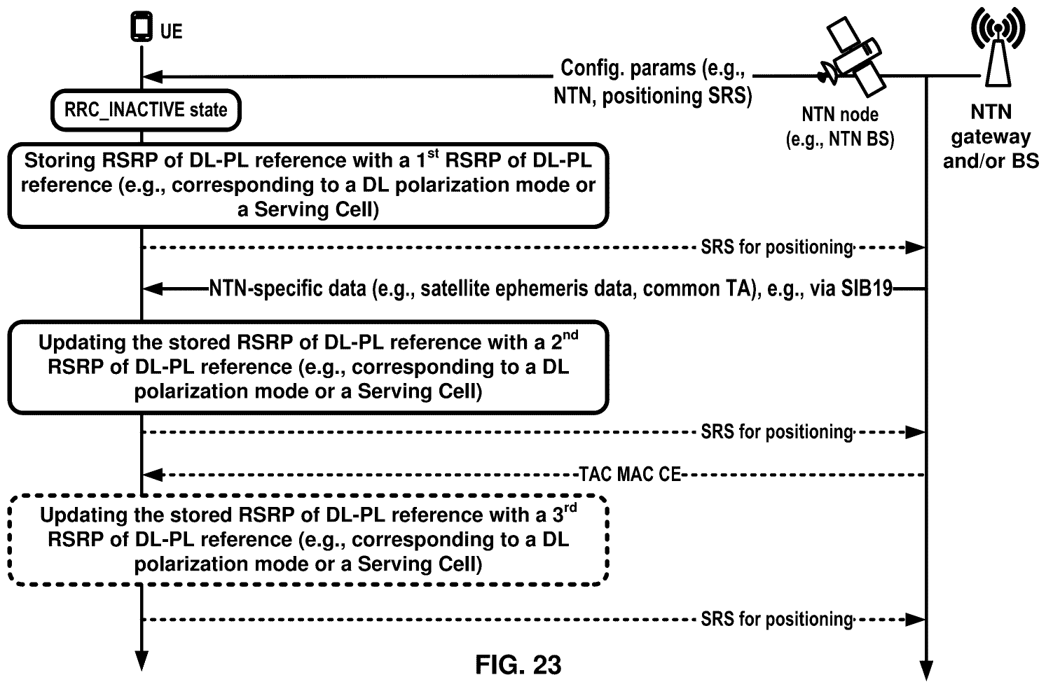

FIG. 23 shows an example embodiment of an SRS procedure for positioning procedure in wireless communications systems per an aspect of the present disclosure. For example, FIG. 23 may illustrate an example of a positioning SRS transmission procedure (e.g., an SRS procedure for positioning procedure) in an RRC inactive/idle (RRC_INACTIVE/IDLE) state (e.g., without the wireless device transitioning/switching to an RRC_CONNECTED state). In some aspects, FIG. 23 may show an implementation of a method (or a process) for the positioning procedure at a base station and/or the wireless device. For example, the SRS procedure for the positioning procedure may be used by the wireless device for transmission of a positioning SRS (e.g., a positioning SRS resource) during/in the RRC inactive/idle state.

The base station may communicate with the wireless device via/using the one or more cells (e.g., the one or more Serving Cells). As shown in FIG. 23, the wireless device may be in the RRC_INACTIVE/IDLE (or an RRC inactive/idle) state/mode. In some cases, the wireless device may switch from the RRC connected state to the RRC inactive/idle state, e.g., based on receiving the RRC release message, e.g., from the base station via/on the Serving Cell. For example, the RRC release message may comprise the one or more positioning SRS configuration parameters. For example, the wireless device may be in a RRC non-connected state/mode (e.g., the RRC inactive/idle state/mode or the RRC idle state/mode). The wireless device may, for example, communicate with the base station via a non-terrestrial network (NTN), e.g., the wireless device and the base station may operate in the NTN and/or the base station may be an NTN base station and/or a cell (e.g., a Serving Cell of the one or more Serving Cells) may be part of the NTN. For example, the cell may be the Serving Cell or a non-Serving Cell.

As shown in FIG. 23, the wireless device may, from the base station, receive the one or more configuration parameters (e.g., the one or more RRC configuration parameters). The one or more configuration parameters may, for example, comprise the one or more serving cell configuration parameters (e.g., ServingCellConfigCommon, ServingCellConfigCommonSIB, and/or ServingCellConfig) for configuring the one or more cells (e.g., the one or more Serving Cells). The one or more configuration parameters may, for example, comprise the one or more positioning SRS configuration parameters. For example, the one or more configuration parameters may, for example, comprise the one or more NTN configuration parameters (e.g., an NTN-specific configuration parameters corresponding to a TAG or a Serving Cell), e.g., for maintaining UL synchronization with the base station and/or the one or more cells (e.g., the Serving Cell).

In some cases, the wireless device may determine the DL-PL reference (e.g., the RSRP value of the DL-PL reference, e.g., corresponding to the Serving Cell) for the TA validation of the SRS for Positioning transmission (e.g., for the positioning SRS transmission) in/during RRC_INACTIVE/IDLE state on the at least one Serving Cell. In an example, as shown in FIG. 23, in response to receiving the RRC release message and/or the one or more positioning SRS configuration parameters, the wireless device may determine a first RSRP value of the DL-PL reference (e.g., corresponding to the Serving Cell of the one or more Serving Cells). The wireless device may store the RSRP (value) of the DL-PL reference (e.g., corresponding to the Serving Cell) with the first RSRP value of the DL-PL reference (e.g., corresponding to the Serving Cell). As shown in FIG. 23, the wireless device may transmit the positioning SRS (e.g., via/using/based on the at least one positioning SRS resource) to the base station, e.g., on/via the Serving Cell. For example, the wireless device may determine the TA value (e.g., corresponding to a TAG and/or the Serving Cell of the one or more Serving Cells) for the transmitting the positioning SRS being valid based on at least one of the following: the one or more non-terrestrial network (NTN) configuration parameters (e.g., corresponding to the TAG and/or the Serving Cell of the one or more Serving Cells) being valid; and/or the second TAT (e.g., corresponding to the TAG and/or the Serving Cell of the one or more Serving Cells) being running (e.g., not being stopped/expired); and/or a difference between a (current) RSRP value of the DL-PL reference (e.g., corresponding to the Serving Cell) and the stored RSRP value (the first RSRP value) of the DL-PL reference (e.g., corresponding to the Serving Cell) being smaller than an RSRP threshold (e.g., inactivePosSRS-RSRP-ChangeThreshold). For example, prior to transmitting the positioning SRS to the base station on the Serving Cell, the wireless device may determine the (current) RSRP value of the DL-PL reference, e.g., corresponding to the Serving Cell. In some cases, the wireless device may not transmit (e.g., refrain from transmitting), e.g., on the Serving Cell and/or to the base station, the positioning SRS (e.g., via/using/based on the at least one positioning SRS resource) based on the TA value (e.g., corresponding to the indicated TAG and/or the Serving Cell of the one or more Serving Cells) for the transmitting the positioning SRS being invalid.

In an example embodiment, the current RSRP value of the DL-PL reference (e.g., corresponding to the Serving Cell) and/or the stored RSRP value of the DL-PL reference (e.g., corresponding to the Serving Cell) may correspond to a (same) polarization mode/information, e.g., the polarization mode of the wireless device and/or the at least one NTN node. For example, the polarization mode may correspond to a polarization mode of the at least one NTN node. In some cases, the polarization mode may correspond to a DL antenna polarization mode/information on a service link between the wireless device and an NTN node of the at least one NTN node (e.g., a service link corresponding to a Serving Cell of the one or more Serving Cells). In some cases, the polarization mode may correspond to the at least one positioning SRS resource (e.g., the at least one positioning SRS resource may compare an indication for indicating the polarization mode). In some other cases, the polarization mode may correspond to an UL antenna polarization mode/information on a service link between the wireless device and an NTN node of the at least one NTN node (e.g., a service link corresponding to a Serving Cell of the one or more Serving Cells).

In an example embodiment, as shown in FIG. 23, the wireless device may, in response to receiving the one or more NTN configuration parameters (e.g., an NTN-specific configuration parameters corresponding to a TAG or a Serving Cell), determine a second RSRP value of the DL-PL reference (e.g., corresponding to the Serving Cell and/or the polarization mode, e.g., the DL polarization mode of the service link or the UL polarization mode of the service link). The wireless device may, for example, store (or update the stored) the RSRP (value) of the DL-PL reference (e.g., corresponding to the Serving Cell and/or the polarization mode) with the second RSRP value of the DL-PL reference (e.g., corresponding to the Serving Cell and/or the polarization mode). For example, the wireless device may (re) acquire the NTN-specific SIB and/or the SIB1 for receiving the one or more NTN configuration parameters (e.g., an NTN-specific configuration parameters corresponding to the TAG or the Serving Cell). In some examples, the wireless device may determine the SRS procedure for the positioning procedure being ongoing in/during the RRC inactive/idle state/mode, e.g., via/on the Serving Cell. As shown in FIG. 23, the wireless device may, e.g., to the base station vialon the Serving Cell, transmit the positioning SRS (e.g., via/using/based on the at least one positioning SRS resource), e.g., based on the TA value (e.g., corresponding to the TAG and/or the Serving Cell of the one or more Serving Cells) for the transmitting the positioning SRS being valid. For example, the wireless device may transmit the positioning SRS based on the UL polarization of the service link and/or a polarization mode corresponding to the positioning SRS resource. In some cases, the wireless device may not transmit (e.g., refrain from transmitting) the positioning SRS (e.g., via/using/based on the at least one positioning SRS resource) based on the TA value (e.g., corresponding to the TAG and/or the Serving Cell of the one or more Serving Cells) for the transmitting the positioning SRS being invalid.

In some implementations, the base station may configure (e.g., via the one or more configuration parameters) the wireless device with a third configuration parameter. According to an example embodiment, the one or more configuration parameters may comprise the third configuration parameter. The third configuration parameter may, for example, indicate whether the wireless device determine/measure/calculate the second RSRP value of the DL-PL reference (and/or store/update the RSRP of the DL-PL reference with the second RSRP value of the DL-PL reference) (e.g., corresponding to a Serving Cell and/or the polarization mode) based on (re) acquiring the NTN-specific SIB and/or SIB1 (e.g., for receiving the one or more NTN configuration parameters (e.g., an NTN-specific configuration parameters corresponding to a TAG or the Serving Cell)).

In an example embodiment, in response to determining the third configuration parameter being indicated/configured (or being enabled or not being disabled or not being absent from the one or more configuration parameters) and (re) acquiring the NTN-specific SIB and/or SIB1 (e.g., for receiving the one or more NTN configuration parameters (e.g., an NTN-specific configuration parameters corresponding to a TAG or a Serving Cell), the wireless device may determine the second RSRP value of the DL-PL reference (e.g., corresponding to the Serving Cell and/or the polarization mode).

In an example embodiment, in response to determining the third configuration parameter being indicated/configured (or being enabled or not being disabled or not being absent from the one or more configuration parameters) and (re) acquiring the NTN-specific SIB and/or SIB1 (e.g., for receiving the one or more NTN configuration parameters (e.g., an NTN-specific configuration parameters corresponding to a TAG or a Serving Cell)), the wireless device may store the RSRP (value) of the DL-PL reference (or update the stored RSRP value of the DL-PL reference) (e.g., corresponding to the Serving Cell and/or the polarization mode) with the second RSRP value of the DL-PL reference (e.g., corresponding to the Serving Cell and/or the polarization mode).

In some examples, the third configuration parameter may indicate determining/measuring/calculating an RSRP value (e.g., the first/second/third or the current RSRP value) of the DL-PL reference (e.g., corresponding to the Serving Cell and/or the polarization mode) based on the polarization mode.

In response to determining the third configuration parameter being indicated/configured (or being enabled or not being disabled or not being absent from the one or more configuration parameters), the wireless device may, for example, determine an antenna polarization mode of the wireless device matching the DL antenna polarization of a service link (e.g., the service link corresponding to the Serving Cell of the one or more Serving Cells). In an example, the wireless device may determine an antenna polarization mode of the wireless device (and/or the antenna polarization of the positioning SRS resource) matching the UL antenna polarization of a service link (e.g., the service link corresponding to the Serving Cell of the one or more Serving Cells).

In an example embodiment, as shown in FIG. 23, the wireless device may, in response to receiving the TAC MAC CE (e.g., for the positioning SRS transmission and/or corresponding to the second TAT (e.g., corresponding to the TAG and/or the Serving Cell of the one or more Serving Cells), determine a third RSRP value of the DL-PL reference (e.g., corresponding to the Serving Cell and/or the polarization mode). The wireless device may, for example, store the RSRP (value) of the DL-PL reference (or update the stored RSRP value of the DL-PL reference) (e.g., corresponding to the Serving Cell and/or the polarization mode) with the third RSRP value of the DL-PL reference (e.g., corresponding to the Serving Cell and/or the polarization mode). In some examples, the wireless device may determine the SRS procedure for the positioning procedure, e.g., corresponding to the Service Cell and/or the antenna polarization (e.g., via the positioning SRS resource), being ongoing in/during the RRC inactive/idle state/mode. As shown in FIG. 23, the wireless device may transmit the positioning SRS (e.g., via/using/based on the at least one positioning SRS resource), e.g., based on the TA value (e.g., corresponding to the TAG and/or the Serving Cell of the one or more Serving Cells) for the transmitting the positioning SRS being valid and/or the polarization mode (e.g., of the positioning SRS resource or the UL polarization mode of the service link corresponding to the Serving Cell). In some cases, the wireless device may not transmit (e.g., refrain from transmitting) the positioning SRS (e.g., via/using/based on the at least one positioning SRS resource) based on the TA value (e.g., corresponding to the TAG and/or the Serving Cell of the one or more Serving Cells) for the transmitting the positioning SRS being invalid and/or a mismatch between the polarization mode of the positioning SRS resource (or the wireless device) and the polarization mode of the service link corresponding to the Serving Cell (or the corresponding the NTN node).

In an example embodiment, the UE capability message may indicate a capability of the wireless device for determining/measuring/calculating the second RSRP value of the DL-PL reference (and/or storing/updating the RSRP of the DL-PL reference with the second RSRP value of the DL-PL reference) (e.g., corresponding to the Serving Cell) based on (re) acquiring the NTN-specific SIB and/or SIB1 (e.g., for receiving the one or more NTN configuration parameters (e.g., an NTN-specific configuration parameters corresponding to a TAG or the Serving Cell).

In an example embodiment, the UE capability message may indicate a capability of the wireless device for determining/measuring/calculating the second RSRP value of the DL-PL reference (and/or storing/updating the RSRP of the DL-PL reference with the second RSRP value of the DL-PL reference) (e.g., corresponding to a Serving Cell) based on the polarization mode. For example, the UE capability message may indicate a capability of the wireless device for determining/measuring/calculating the second RSRP value of the DL-PL reference (and/or storing/updating the RSRP of the DL-PL reference with the second RSRP value of the DL-PL reference) (e.g., corresponding to a Serving Cell) when there is a mismatch between the polarization mode of the positioning SRS resource (or the wireless device) and the polarization mode of the service link corresponding to the Serving Cell (or the corresponding the NTN node). In another example, the UE capability message may indicate a capability of the wireless device for determining/measuring/calculating the second RSRP value of the DL-PL reference (and/or storing/updating the RSRP of the DL-PL reference with the second RSRP value of the DL-PL reference) (e.g., corresponding to a Serving Cell) when the polarization mode of the positioning SRS resource (or the wireless device) matches to the polarization mode of the service link corresponding to the Serving Cell (or the corresponding the NTN node).

Example embodiments may allow the wireless device to determine/store the RSRP value of the DL-PL reference in response to (re) acquiring the NTN-specific SIB (e.g., for receiving the one or more NTN configuration parameters (e.g., an NTN-specific configuration parameters corresponding to a TAG or a Serving Cell). Example embodiments may enhance the performance of the SRS procedure for the positioning procedure, e.g., by properly determining/storing the RSRP value of the DL-PL reference (e.g., corresponding to a Serving Cell). Example embodiments may allow the wireless device to maintain the RSRP value of the DL-PL reference (e.g., corresponding to a Serving Cell and/or the polarization mode).

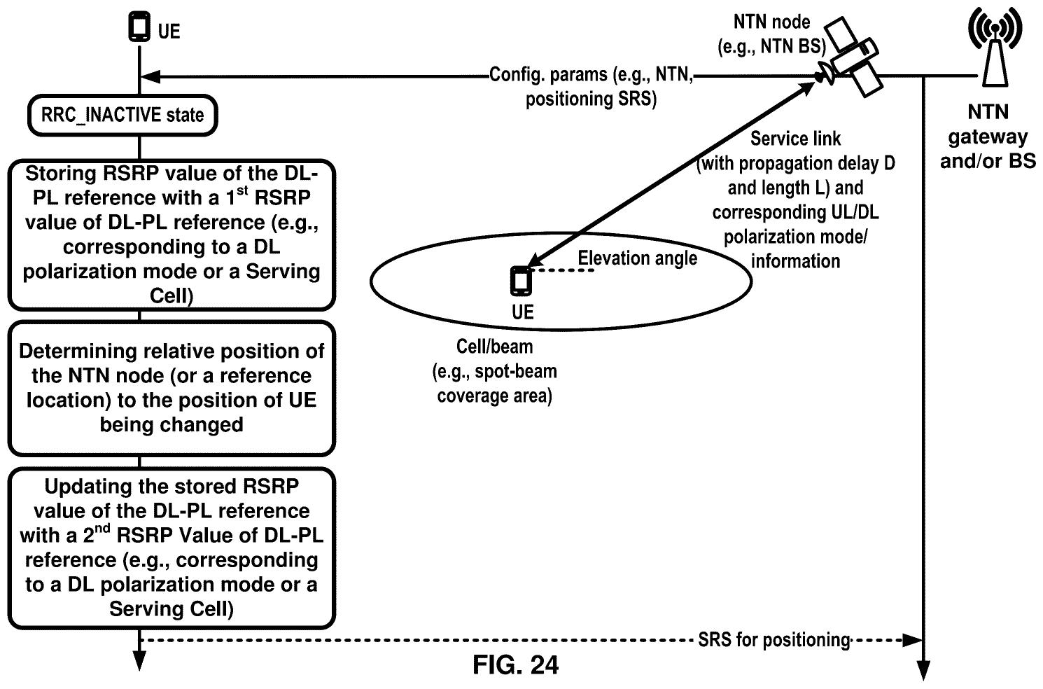

FIG. 24 shows an example embodiment of an SRS procedure for positioning procedure in wireless communications systems per an aspect of the present disclosure. For example, FIG. 23 may illustrate an example of a positioning SRS transmission procedure (e.g., an SRS procedure for positioning procedure) in an RRC inactive/idle (RRC_INACTIVE/IDLE) state (e.g., without the wireless device transitioning/switching to an RRC_CONNECTED state). In some aspects, FIG. 24 may show an implementation of a method (or a process) for the positioning procedure at a base station and/or the wireless device. For example, the SRS procedure for the positioning procedure may be used by the wireless device for transmission of a positioning SRS (e.g., a positioning SRS resource) during/in the RRC inactive/idle state.

The base station may communicate with the wireless device via/using the one or more cells (e.g., the one or more Serving Cells). As shown in FIG. 24, the wireless device may be in the RRC_INACTIVE/IDLE (or an RRC inactive/idle) state/mode. In some cases, the wireless device may switch from the RRC connected state to the RRC inactive/idle state, e.g., based on receiving the RRC release message. For example, the RRC release message may comprise the one or more positioning SRS configuration parameters. For example, the wireless device may be in a RRC non-connected state/mode (e.g., the RRC inactive/idle state/mode or the RRC idle state/mode). The wireless device may, for example, communicate with the base station via a non-terrestrial network (NTN), e.g., the wireless device and the base station may operate in the NTN and/or the base station may be an NTN base station and/or a cell (e.g., a Serving Cell of the one or more Serving Cells) may be part of the NTN. For example, the cell may be the Serving Cell or a non-Serving Cell.

As shown in FIG. 24, the wireless device may, from the base station, receive the one or more configuration parameters (e.g., the one or more RRC configuration parameters). The one or more configuration parameters may, for example, comprise the one or more serving cell configuration parameters (e.g., ServingCellConfigCommon, ServingCellConfigCommonSIB, and/or ServingCellConfig) for configuring the one or more cells (e.g., the one or more Serving Cells). The one or more configuration parameters may, for example, comprise the one or more positioning SRS configuration parameters. For example, the one or more configuration parameters may, for example, comprise the one or more NTN configuration parameters (e.g., an NTN-specific configuration parameters corresponding to a TAG or a Serving Cell), e.g., for maintaining UL synchronization with the base station and/or the one or more cells (e.g., the Serving Cell).

In some cases, the wireless device may determine the DL-PL reference (e.g., the RSRP value of the DL-PL reference) (e.g., corresponding to the Serving Cell) for the TA validation of the SRS for Positioning transmission (e.g., for the positioning SRS transmission) in/during RRC_INACTIVE/IDLE state. In an example, as shown in FIG. 24, in response to receiving the RRC release message (e.g., from the base station, e.g., via/on the Serving Cell) and/or the one or more positioning SRS configuration parameters, the wireless device may determine the first RSRP value of the DL-PL reference (e.g., corresponding to the Service Cell and/or a polarization mode, e.g., the UL/DL polarization mode of a service link corresponding to the Serving Cell). The wireless device may store the RSRP (value) of the DL-PL reference (e.g., corresponding to the Serving Cell and/or the polarization mode) with the first RSRP value of the DL-PL reference (e.g., corresponding to the Serving Cell and/or the polarization mode). As shown in FIG. 24, the wireless device may transmit the positioning SRS (e.g., via/using/based on the at least one positioning SRS resource) to the base station on the Service Cell (e.g., via the service link and/or the polarization mode, e.g., the UL polarization mode of the service link corresponding to the Service Cell and/or the polarization mode of the positioning SRS resource). For example, the wireless device may determine the TA value (e.g., corresponding to a TAG and/or the Serving Cell of the one or more Serving Cells) for the transmitting the positioning SRS (e.g., to the base station via/on the Serving Cell) being valid. In some cases, the wireless device may, e.g., to the base station on/via the Serving Cell, not transmit (e.g., refrain from transmitting) the positioning SRS (e.g., via/using/based on the at least one positioning SRS resource) based on the TA value (e.g., corresponding to the TAG and/or the Serving Cell of the one or more Serving Cells) for the transmitting the positioning SRS being invalid and/or a mismatch between the polarization mode of the positioning SRS resource (or the wireless device) and the polarization mode of the service link corresponding to the Serving Cell (or the corresponding the NTN node).

In an example embodiment, as shown in FIG. 24, the wireless device may, in response to determining relative position (or location information) of an NTN node of the at least one NTN node, e.g., corresponding to the Serving Cell, (or the reference location) to the position (or location information) of the wireless device being changed (or fluctuated or varied or increased or decreased), determine the second RSRP value of the DL-PL reference (e.g., corresponding to the Service Cell and/or the polarization mode). For example, the wireless device may store the RSRP (value) of the DL-PL reference (or update the stored RSRP value of the DL-PL reference) with the second RSRP value of the DL-PL reference (e.g., corresponding to the Serving Cell and/or the polarization mode). In some examples, based on the one or more NTN configuration parameters (e.g., by (re) acquiring the NTN-specific SIB or SIB1), e.g., corresponding to the Serving Cell, the wireless device may determine the relative position (or location information) of the NTN node, e.g., corresponding to the Serving Cell, (or the reference location) to the position (or location information) of the wireless device being changed. In some cases, to determine relative position (or location information) of the NTN node, e.g., corresponding to the Serving Cell, (or the reference location) to the position (or location information) of the wireless device being changed the wireless device may determine at least one attribute of the service link of/corresponding to the Serving Cell or the NTN node (among/of one or more attributes of the service link of/corresponding to the Serving Cell or the NTN node) being changed. For example, the wireless device may determine at least one of the following: the length of the service link of/corresponding to the Serving Cell or the NTN node (e.g., distance between the wireless device and the NTN node or the reference location) being changed and/or the elevation angle of the service link of/corresponding to the Serving Cell or the NTN node being change and/or the propagation delay of the service link of/corresponding to the Serving Cell or the NTN node being changed. In some cases, the service link may correspond to a non-Serving Cell.

In some implementations, the wireless device may determine the relative position (or location information) of the NTN node, e.g., corresponding to the Serving Cell, (or the reference location) to the position (or location information) of the wireless device being changed more than a threshold. For example, the one or more configuration parameters may configure the threshold.

In some examples, the one or more NTN-specific values/parameters may correspond to (or be associated with) the one or more attributes (or characteristics or qualities or features or properties or aspects or elements) of a communication link between the wireless device and the base station (or the reference location), e.g., a service link of/corresponding to the Serving Cell or the NTN node and/or a feeder link of/corresponding to the Serving Cell or the NTN node. For example, the wireless device may determine the one or more attributes of the service link of/corresponding to the Serving Cell or the NTN node based on (or using) the one or more NTN configuration parameters (e.g., the one or more ephemeris parameters and/or the one or more common delay/TA parameters and/or a reference location, e.g., referenceLocation), e.g., corresponding to the Serving Cell, and/or the one or more NTN-specific parameters/values.

In some implementations, an attribute of a service link (e.g., a service link of the at least one service link and/or the service link corresponding to the Serving Cell or the NTN node) may be at least one of the one or more attributes of the service link. For example, the one of one or more attributes of the service link may comprise (or be) at least one of the following: a UE-gNB RTT corresponding to the service link (e.g., the UE-gNB RTT of the Serving Cell of the one or more Serving Cells), a propagation delay of the service link, and/or a length of the service link (e.g., distance between the wireless device and the NTN payload or a relative location/position of the NTN node/payload to the location/position of the wireless device and/or distance between the wireless device and the reference location), and/or an elevation angle of the service link, and/or the like. For example, the one or more attributes of the service link may be based on (or depend on) an GNSS-acquired position (or a location information) of the wireless device.

In some examples, the service link of/corresponding to the Serving Cell or the NTN node may comprise one or more intermediary nodes (e.g., airplanes and/or drones (UAV) and/or HAPS nodes/payload and/or low-orbit satellites). For example, using the one or more NTN configuration parameters corresponding to the Serving Cell, the wireless device may determine the one or more attributes of the service link of/corresponding to the Serving Cell or the NTN node.

In some other implementations, the one or more attributes of the service link of/corresponding to the Serving Cell or the NTN node may be based on one or more timestamps (e.g., the timestamp of the one or more NTN configuration parameters and/or the timestamp of the NTN-specific SIB) and/or an epoch time (e.g., an epoch time of the NTN-specific SIB or an epoch time of SIBx, where x=1, 2, . . . ). For example, the determining the least one location information/position of the NTN node of the at least one NTN node may be based on the one or more timestamps.

In some cases, to determine relative position (or location information) of the NTN node, e.g., corresponding to the Serving Cell and/or the NTN node, (or the reference location) to the position (or location information) of the wireless device being changed more than the threshold, the wireless device may determine at least one attribute of the service link (among/of the one or more attributes of the service link) of/corresponding to the Serving Cell and/or the NTN node being changed more than the threshold. For example, the wireless device may determine at least one of the following being satisfied: the length of the service link of/corresponding to the Serving Cell and/or the NTN node (e.g., distance between the wireless device and the NTN node or the reference location) being changed more than a first threshold; and/or the elevation angle of the service link of/corresponding to the Serving Cell and/or the NTN node being change more than a second threshold and/or the propagation delay of the service link of/corresponding to the Serving Cell and/or the NTN node being changed more than a third threshold. In some examples, the one or more configuration parameters may configure at least one of the first threshold and/or the second threshold and/or the third threshold.

In some aspects, during the RRC inactive/idle state, in response to receiving the one or more NTN configuration parameters (e.g., via (re) acquiring the NTN-specific SIB or the SIB1) and/or acquiring an updated GNSS-acquired position (e.g., the location information or position) of the wireless device and/or receiving, from the base station, a verification of the location information of the wireless device, the wireless device may determine whether the relative position (or location information) of the NTN node, e.g., corresponding to the Serving Cell or the NTN node, (or the reference location) to the position (or location information) of the wireless device being changed (e.g., more than the threshold). For example, the wireless device may (re) calculate/(re) measure/update the one or more NTN-specific values. For example, the wireless device may determine/(re) calculate/(re) measure/update/maintain/estimate the one or more attributes of the service link of/corresponding to the Serving Cell and/or the NTN node. In some scenarios, the wireless device may determine/(re) calculate/(re) measure/update/maintain/estimate the TA value (e.g., corresponding to a TAG and/or the Serving Cell of the one or more Serving Cells) of the wireless device for the positioning SRS transmission. In some other scenarios, the wireless device may determine/(re) calculate/(re) measure/update/maintain/estimate a UE-gNB RTT (e.g., corresponding to the TAG and/or the Serving Cell of the one or more Serving Cells) and/or an open-loop TA value or TA value (e.g., corresponding to the TAG and/or the Serving Cell of the one or more Serving Cells) of the wireless device.

In some implementations, during/in the RRC inactive/idle state, the wireless device may, using the one or more NTN configuration parameters (e.g., the one or more common delay/TA parameters and/or the one or more ephemeris parameters), e.g., corresponding to the Serving Cell or the NTN node, periodically (e.g., each 10 ms or each 20 ms or the like) (re) calculate/(re) measure/update/estimate the one or more NTN-specific values. For example, the wireless device may determine/(re) calculate/(re) measure/update/maintain/estimate the one or more attributes of the service link (e.g., corresponding to the Serving Cell or the NTN node) and/or determine/(re) calculate/(re) measure/update/maintain/estimate the TA value (e.g., corresponding to the TAG and/or the Serving Cell of the one or more Serving Cells) for the positioning SRS transmission. In some examples, the wireless device may determine/(re) calculate/(re) measure/update/maintain/estimate the open-loop TA value (e.g., corresponding to the TAG and/or the Serving Cell of the one or more Serving Cells) of the wireless device. For example, the wireless device may, periodically (e.g., each 10 ms or each 20 ms or the like), (re) calculate/(re) measure/update the location information/position of the least one NTN node, e.g., based on the one or more NTN configuration parameters (e.g., the one or more common delay/TA parameters and/or the one or more ephemeris parameters), and/or the GNSS-acquired position (e.g., the location information or position) of the wireless device. In response to each (re) calculating/(re) measuring/updating the location information/position of the least one NTN and/or the GNSS-acquired position (e.g., the location information or position) of the wireless device the wireless device may determine whether the relative position (or location information) of an NTN node, e.g., corresponding to the Serving Cell, of the at least one NTN node (or the reference location) to the position (or location information) of the wireless device being changed (e.g., more than the threshold). In some examples, the wireless device may determine the SRS procedure for the positioning procedure being ongoing in/during the RRC inactive/idle state/mode on the Serving Cell.

In some implementations, the base station may configure (e.g., via the one or more configuration parameters) the wireless device with a fourth configuration parameter. According to an example embodiment, the one or more configuration parameters may comprise the fourth configuration parameter. The fourth configuration parameter may, for example, indicate whether the wireless device determine the second RSRP value of the DL-PL reference (and/or store/update the RSRP of the DL-PL reference with the second RSRP value of the DL-PL reference) based on determining the relative position (or location information) of the NTN node, e.g., corresponding to the Serving Cell or the service link, (or the reference location) to the position (or location information) of the wireless device being changed (e.g., more than the threshold).

In an example embodiment, in response to determining the fourth configuration parameter being indicated/configured (or being enabled or not being disabled or not being absent from the one or more configuration parameters) and the relative position (or location information) of the NTN node, e.g., corresponding to the Serving Cell or the service link, (or the reference location) to the position (or location information) of the wireless device being changed (e.g., more than the threshold), the wireless device may determine the second RSRP value of the DL-PL reference (e.g., corresponding to a Service Cell and/or a polarization mode, e.g., the UL/DL polarization mode of a service link).

In an example embodiment, in response to determining the fourth configuration parameter being indicated/configured (or being enabled or not being disabled or not being absent from the one or more configuration parameters) and the relative position (or location information) of the NTN node, e.g., corresponding to the Serving Cell or the service link, (or the reference location) to the position (or location information) of the wireless device being changed (e.g., more than the threshold), the wireless device may store the RSRP (value) of the DL-PL reference (or update the stored RSRP value of the DL-PL reference) with the second RSRP value of the DL-PL reference (e.g., corresponding to the Service Cell and/or the polarization mode, e.g., the UL/DL polarization mode of a service link).

As shown in FIG. 24, the wireless device may, to the base station via/on the Serving Cell, transmit the positioning SRS (e.g., via/using/based on the at least one positioning SRS resource), e.g., based on the TA value (e.g., corresponding to a TAG and/or the Serving Cell of the one or more Serving Cells) for the transmitting the positioning SRS being valid. In some cases, the wireless device may not transmit (e.g., refrain from transmitting) the positioning SRS (e.g., via/using/based on the at least one positioning SRS resource) based on the TA value (e.g., corresponding to the TAG and/or the Serving Cell of the one or more Serving Cells) for the transmitting the positioning SRS being invalid and/or a mismatch between the polarization mode of the positioning SRS resource (or the wireless device) and the polarization mode of the service link corresponding to the Serving Cell (or the corresponding the NTN node).

In an example embodiment, the UE capability message may indicate a capability of the wireless device for determining/measuring/calculating the second RSRP value of the DL-PL reference (and/or storing/updating the RSRP of the DL-PL reference with the second RSRP value of the DL-PL reference) (e.g., corresponding to the Serving Cell and/or the polarization mode) based on the relative position (or location information) of the least one NTN node, e.g., corresponding to the Serving Cell or the service link, (or the reference location) to the position (or location information) of the wireless device being changed (e.g., more than the threshold).

Example embodiments may allow the wireless device to determine/store the RSRP value of the DL-PL reference (e.g., corresponding to a Serving Cell and/or the polarization mode) in response to determining the relative position (or location information) of the NTN node, e.g., corresponding to the Serving Cell or the service link, to the position (or location information) of the wireless device being changed (e.g., more than the threshold). Example embodiments may enhance the performance of the SRS procedure for the positioning procedure, e.g., by determining/storing the RSRP value of the DL-PL reference (e.g., corresponding to the Serving Cell and/or the polarization mode). Example embodiments may allow the wireless device to maintain the RSRP value of the DL-PL reference (e.g., corresponding to the Serving Cell and/or the polarization mode).

An example method comprising: receiving, by a wireless device, one or more configuration parameters comprising: one or more non-terrestrial network (NTN) configuration parameters indicating a validity timer; and one or more positioning sounding reference signal (SRS) configuration parameters indicating: at least one positioning SRS resource for positioning SRS transmission in a radio resource control (RRC) inactive state of the wireless device; and a time alignment timer; starting the validity timer in response to the receiving the one or more NTN configuration parameters; starting the time alignment timer based on receiving a timing advance (TA) command; and based on both the validity timer and the time alignment timer being running, transmitting, in the RRC inactive state, a positioning SRS via the at least one positioning SRS resource.

The above-example method further comprises determining a TA value of the wireless device, for the positioning SRS transmission in the RRC inactive state, being valid.

One or more of the above-example methods, wherein the determining the TA value of the wireless device, for the positioning SRS transmission in the RRC inactive state, being valid is based on the one or more NTN configuration parameters.

One or more of the above-example methods, further comprising determining first NTN configuration parameters of the one or more NTN configuration parameters being valid, wherein the first NTN configuration parameter corresponds to at least one of: a serving cell that is a part of an NTN; a service link of the serving cell; or an NTN node corresponding to the serving cell or the service link.

One or more of the above-example methods, wherein the validity timer corresponds to the first NTN configuration parameters of the one or more NTN configuration parameters, wherein the first NTN configuration parameters of the one or more NTN configuration parameters comprise at least one of: at least one satellite ephemeris information corresponding to one or more NTN nodes; or one or more common delay configuration parameters corresponding to the one or more NTN nodes.

One or more of the above-example methods, further comprising receiving, at a medium access control (MAC) layer of the wireless device and from an RRC layer of the wireless device and in response to the receiving the one or more NTN configuration parameters, a first indication indicating an uplink synchronization of a serving cell being obtained, wherein the serving cell is part of an NTN.

One or more of the above-example methods, wherein the determining the TA, for the positioning SRS transmission, being valid is further based on a difference between a first reference signal received power (RSRP) of a downlink pathloss (DL-PL) reference signal and a second RSRP of the DL-PL reference signal being smaller than an RSRP threshold.

One or more of the above-example methods, wherein the first RSRP of the DL-PL reference and the second RSRP of the DL-PL reference correspond to a same DL polarization mode of a service link on an NTN, wherein the wireless device and a base station are communicating with each other via the service link of the NTN.

One or more of the above-example methods, wherein the second RSRP of the DL-PL reference is determined prior to the at least one positioning SRS resource and after determining the first RSRP of the DL-PL reference.

One or more of the above-example methods, further comprising determining/measuring/storing/maintaining the first RSRP of the DL-PL reference in response to at least one of: receiving the one or more positioning SRS configuration parameters in the RRC inactive state; receiving the TA command, wherein the TA command corresponds to a positioning SRS transmission procedure; a distance between the wireless device and a non-terrestrial network (NTN) node being changed, wherein the distance between the wireless device and the NTN node is based on the one or more NTN configuration parameters; receiving the one or more NTN configuration parameters; receiving a new one or more NTN configuration parameters, wherein the new one or more NTN configuration parameters comprise an update of the one or more NTN configuration parameters; starting or restarting the validity timer; receiving, at a MAC layer of the wireless device and from an RRC layer of the wireless device, a first indication indicating an uplink synchronization of a serving cell being obtained, wherein the serving cell is part of an NTN; or receiving, at the MAC layer of the wireless device and from the RRC layer of the wireless device, a second indication indicating the uplink synchronization of the serving cell being lost.

One or more of the above-example methods, wherein the determining the distance between the wireless device and the NTN node being changed is based on determining at least one of: relative location information/position of the wireless device to the location information/position of the NTN node being changed; relative location information/position of the wireless device to a reference location being changed, wherein the one or more configuration parameters indicate the reference location; an elevation angle between the wireless device and the NTN node being changed; or a propagation delay between the wireless device and the NTN node being changed.

One or more of the above-example methods, wherein the determining the distance between the wireless device and the NTN node being changed is based on determining at least one of: the relative location information of the wireless device to the location information of the NTN node being changed more than a first preconfigured threshold; relative location information/position of the wireless device to a reference location being changed more than a second preconfigured threshold; the elevation angle between the wireless device and the NTN node being changed more than a third preconfigured threshold; or the propagation delay between the wireless device and the NTN node being changed more than a fourth preconfigured threshold.

One or more of the above-example methods, wherein the determining the distance between the wireless device and the NTN node being changed is based on at least one of: a change in the location information/position of the wireless device; or a change in the location information/position of the NTN node.

One or more of the above-example methods, wherein the change in the location information of the NTN node is determined based on one or more common delay configuration parameters, wherein the one or more NTN configuration parameters comprise the one or more common delay configuration parameters.

One or more of the above-example methods, wherein the change in the location information of the NTN node is determined based on at least one satellite ephemeris information, wherein the one or more NTN configuration parameters comprise the at least one satellite ephemeris information.

One or more of the above-example methods, further comprising determining the TA value of the wireless device, for the positioning SRS transmission, based on the one or more NTN configuration parameters.

One or more of the above-example methods, wherein the determining the TA for the positioning SRS transmission is based on at least one of: at least one satellite ephemeris information, wherein the one or more NTN configuration parameters comprise the at least one satellite ephemeris information; one or more common delay configuration parameters, wherein the one or more NTN configuration parameters comprise the one or more common delay configuration parameters; or the TA command.

One or more of the above-example methods, wherein the TA for the positioning SRS transmission corresponds to a TA group (TAG) or a serving cell.

One or more of the above-example methods, wherein the time alignment timer is for the positioning SRS transmission in the RRC inactive state.

One or more of the above-example methods, further comprising determining the validity timer being expired.

One or more of the above-example methods, further comprising receiving, in response to the validity timer being expired, at a MAC layer of the wireless device and from a higher layer of the wireless device, a second indication indicating an uplink synchronization loss of a serving cell, wherein the serving cell is part of an NTN.

One or more of the above-example methods, further comprising stopping the time alignment timer in response to the validity timer being expired.

One or more of the above-example methods, further comprising releasing, in response to the validity timer being expired, the at least one positioning SRS resource.

One or more of the above-example methods, further comprising stopping/halting, in response to the validity timer being expired, the positioning SRS transmission during a time duration, wherein the time duration is for acquiring a new one or more NTN configuration parameters.

One or more of the above-example methods, wherein the at least one positioning SRS resource is a periodic positioning SRS resource.

One or more of the above-example methods, wherein the at least one positioning SRS resource is a semi-persistent positioning SRS resource.

One or more of the above-example methods, further comprising: receiving a medium access control (MAC) control element (CE) indicating activating the semi-persistent positioning SRS resource; activating, based on the MAC CE, the semi-persistent positioning SRS resource; determining the validity timer being expired; and deactivating, in response to the validity timer being expired, the semi-persistent positioning SRS resource.

One or more of the above-example methods, further comprising: acquiring, in response to the validity timer being expired, a new one or more NTN configuration parameters; and activating, in response to the acquiring the new one or more NTN configuration parameters, the semi-persistent positioning SRS resource.

One or more of the above-example methods, wherein the one or more positioning SRS configuration parameters is received in the RRC inactive state.

One or more of the above-example methods, further comprising determining a first configuration parameter being enabled, wherein the one or more configuration parameters indicate the first configuration parameter.

One or more of the above-example methods, further comprising transmitting a user-equipment (UE) capability message to a base station, wherein the UE-capability indicates at least one of: a capability for transmission of the positioning SRS during the RRC inactive state when the wireless device and the base station are operating in an NTN; or a capability for transmission of the positioning SRS during the RRC inactive state when an uplink synchronization of a serving cell being maintained, wherein the serving cell is part of the NTN.

One or more of the above-example methods, further comprising: determining, irrespective of whether the one or more NTN configuration parameters are valid or invalid, the TA value of the wireless device being valid based on at least one of: a change in RSRP value of a DL-PL reference being smaller than a threshold; or the time alignment timer being running; and transmitting, based on the determining, a second positioning SRS via the at least on positioning SRS resource.

One or more of the above-example methods, further comprising determining a first configuration parameter being disabled, wherein the one or more configuration parameters indicate the first configuration parameter.

One or more of the above-example methods, further comprising transmitting a user-equipment (UE) capability to a base station, wherein the UE-capability indicates a capability for transmission of the positioning SRS during the RRC inactive state when the one or more NTN configuration parameters are invalid.

One or more of the above-example methods, further comprising, for the transmitting the positioning SRS, avoiding/bypassing acquisition of SIB2 based on: a stored SIB2 being invalid; and the validity timer being expired.

One or more of the above-example methods, wherein while the validity timer is running, at least one of the following is satisfied: the first NTN configuration parameters of the one or more NTN configuration parameters are valid; or the one or more NTN configuration parameters are valid.

One or more of the above-example methods, further comprising refraining from transmitting (e.g., not transmitting), in an RRC connected state of the wireless device, positioning SRS via the at least one positioning SRS resource.

One or more of the above-example methods, further comprising transmitting a second positioning SRS via the at least one positioning SRS resource based on at least one of the following: the time alignment timer being running; or the validity timer being running.

An example method comprising: receiving, by a wireless device, one or more configuration parameters comprising: one or more non-terrestrial network (NTN) configuration parameters indicating a validity timer; and one or more positioning sounding reference signal (SRS) configuration parameters indicating: at least one positioning SRS resource for positioning SRS transmission in a radio resource control (RRC) inactive state of the wireless device; starting the validity timer in response to the receiving the one or more NTN configuration parameters; and based on both the validity timer, transmitting, in the RRC inactive state, a positioning SRS via the at least one positioning SRS resource.

An example method comprising: receiving, by a wireless device, one or more configuration parameters indicating: one or more non-terrestrial network (NTN) configuration parameters; and one or more positioning sounding reference signal (SRS) configuration parameters indicating at least one positioning SRS resource for positioning SRS transmission in a radio resource control (RRC) inactive state of the wireless device; starting a validity timer in response to the receiving the one or more NTN configuration parameters; and refraining, in the RRC inactive state, from transmitting a positioning SRS in response to the validity timer being expired.

An example method comprising: receiving, by a wireless device, one or more configuration parameters indicating: one or more non-terrestrial network (NTN) configuration parameters for maintaining uplink synchronization of a serving cell; and one or more positioning sounding reference signal (SRS) configuration parameters indicating at least one positioning SRS resource for positioning SRS transmission in a radio resource control (RRC) inactive state of the wireless device; and transmitting, based on the uplink synchronization of the serving cell in the RRC inactive state being obtained, a positioning SRS via the at least on positioning SRS resource.

An example method comprising: receiving, by a wireless device, one or more configuration parameters indicating: one or more non-terrestrial network (NTN) configuration parameters; and one or more positioning sounding reference signal (SRS) configuration parameters indicating at least one positioning SRS resource for positioning SRS transmission in a radio resource control (RRC) inactive state of the wireless device; determining, based on the one or more non-terrestrial network (NTN) configuration parameters, a timing advance (TA) value of the wireless device, for the positioning SRS transmission in the RRC inactive state, being valid; and transmitting, based on the determining, a positioning SRS via the at least on positioning SRS resource.

1. A wireless device comprising one or more processors and memory storing instructions that, when executed by the one or more processors, cause the wireless device at least to perform:
receiving one or more radio resource control (RRC) messages comprising:
one or more non-terrestrial network (NTN) configuration parameters indicating a validity timer, wherein the validity timer indicates a maximum time duration that the one or more NTN configuration parameters are valid; and
one or more positioning sounding reference signal (SRS) configuration parameters indicating at least one positioning SRS resource for SRS positioning in an RRC inactive state of the wireless device;
starting, in response to the receiving the one or more NTN configuration parameters, the validity timer; and
based on the validity timer running in the RRC inactive state, transmitting, in the RRC inactive state, a positioning SRS via the at least one positioning SRS resource.

2. The wireless device of claim 1, wherein the transmitting the positioning SRS is further based on a time alignment timer being running, wherein:
the one or more positioning SRS configuration parameters indicate the time alignment timer; and
the time alignment timer is for positioning SRS transmission in the RRC inactive state.

3. The wireless device of claim 2, wherein the instructions further cause the wireless device to perform: based on receiving an RRC release message:
transitioning from RRC connected state to the RRC inactive state; and
starting a time alignment timer.

4. The wireless device of claim 3, wherein the instructions further cause the wireless device to perform, in response to the receiving the RRC release message, keep running the validity timer based on the RRC messages comprising the one or more positioning SRS configuration parameters.

5. The wireless device of claim 1, wherein the instructions further cause the wireless device to perform transmitting a use-equipment (UE) capability message indicating a capability for transmitting the positioning SRS in the RRC inactive state via a cell of the NTN.

6. The wireless device of claim 1, wherein the validity timer corresponds to at least two service links of the NTN.

7. The wireless device of claim 1, wherein the validity timer corresponds to a first NTN configuration parameters of the one or more NTN configuration parameters, wherein the first NTN configuration parameters of the one or more NTN configuration parameters comprise at least one of:
at least one satellite ephemeris information corresponding to one or more NTN nodes; or
one or more common delay configuration parameters corresponding to the one or more NTN nodes.

8. A base station comprising one or more processors and memory storing instructions that, when executed by the one or more processors, cause the base station at least to perform:
transmitting, to a wireless device, one or more radio resource control (RRC) messages comprising:
one or more non-terrestrial network (NTN) configuration parameters indicating a validity timer, wherein the validity timer indicates a maximum time duration that the one or more NTN configuration parameters are valid, wherein the validity timer is to start in response to reception of the one or more NTN configuration parameters; and
one or more positioning sounding reference signal (SRS) configuration parameters indicating at least one positioning SRS resource for SRS positioning in an RRC inactive state of the wireless device; and
receiving, from the wireless device in the RRC inactive state and based on the validity timer running, a positioning SRS via the at least one positioning SRS resource.

9. The base station of claim 8, wherein the instructions further cause the base station to perform receiving, from the wireless device, a user-equipment (UE) capability message, wherein the UE-capability message indicates at least one of a capability for transmission, via a cell of the NTN, of the positioning SRS during the RRC inactive state.

10. The base station of claim 8, wherein the receiving the positioning SRS is further based on a time alignment timer being running, wherein:
the one or more positioning SRS configuration parameters indicate the time alignment timer; and
the time alignment timer is for positioning SRS transmission in the RRC inactive state.

11. The base station of claim 8, wherein the instructions further cause the base station to perform receiving a use-equipment (UE) capability message indicating a capability for transmitting the positioning SRS in the RRC inactive state via a cell of the NTN.

12. The base station of claim 8, wherein the validity timer corresponds to at least two service links of the NTN.

13. The base station of claim 8, wherein the validity timer corresponds to a first NTN configuration parameters of the one or more NTN configuration parameters, wherein the first NTN configuration parameters of the one or more NTN configuration parameters comprise at least one of:
at least one satellite ephemeris information corresponding to one or more NTN nodes; or
one or more common delay configuration parameters corresponding to the one or more NTN nodes.

14. The base station of claim 13, wherein the one or more NTN nodes correspond to at least two cells of the NTN.

15. A non-transitory computer-readable medium comprising instructions that, when executed by one or more processors of a wireless device, cause the wireless device to perform:
receiving one or more radio resource control (RRC) messages comprising:
one or more non-terrestrial network (NTN) configuration parameters indicating a validity timer, wherein the validity timer indicates a maximum time duration that the one or more NTN configuration parameters are valid; and
one or more positioning sounding reference signal (SRS) configuration parameters indicating at least one positioning SRS resource for SRS positioning in an RRC inactive state of the wireless device;
starting, in response to the receiving the one or more NTN configuration parameters, the validity timer; and
based on the validity timer running in the RRC inactive state, transmitting, in the RRC inactive state, a positioning SRS via the at least one positioning SRS resource.

16. The non-transitory computer-readable medium of claim 15, wherein the transmitting the positioning SRS is further based on a time alignment timer being running, wherein:
the one or more positioning SRS configuration parameters indicate the time alignment timer; and
the time alignment timer is for positioning SRS transmission in the RRC inactive state.

17. The non-transitory computer-readable medium of claim 16, further comprising: based on receiving an RRC release message:
transitioning from RRC connected state to the RRC inactive state; and
starting a time alignment timer.

18. The non-transitory computer-readable medium of claim 17, further comprising in response to the receiving the RRC release message, keep running the validity timer based on the RRC messages comprising the one or more positioning SRS configuration parameters.

19. The non-transitory computer-readable medium of claim 15, further comprising transmitting a use-equipment (UE) capability message indicating a capability for transmitting the positioning SRS in the RRC inactive state via a cell of the NTN.

20. The non-transitory computer-readable medium of claim 15, wherein the validity timer corresponds to at least two service links of the NTN.
